(19) United States
(12) Patent Application Publication
(10) Pub. No.: US 2010/0062229 A1
(43) Pub. Date: Mar. 11, 2010

(54) Aligned single-walled carbon nanotube aggregate, bulk aligned single-walled carbon nanotube aggregate, powdered aligned single-walled carbon nanotube aggregate, and production method thereof

(76) Inventors: Kenji HATA, Ibaraki (JP); Don N. FUTABA, Ibaraki (JP); Motoo YUMURA, Ibaraki (JP)

Correspondence Address: WENDEROTH, LIND & PONACK, L.L.P., 1030 15th Street, N.W.,, Suite 400 East, Washington, DC, 20005-1503, US

(21) Appl. No.: 12/457,637

(22) Filed: Jun. 17, 2009

Related U.S. Application Data
(63) Continuation-in-part of application No. 12/318,443, filed on Dec. 30, 2008.
Application No. 12/318,443 is a continuation-in-part of application No. 11/658,577, filed on Apr. 5, 2007.

(30) Foreign Application Priority Data
Jul. 27, 2004 (JP) 2004-219346
Nov. 17, 2004 (JP) 2004-333683
Mar. 8, 2005 (JP) 2005-063704

(51) Int. Cl. B32B 5/02; B05D 5/00

(52) U.S. Cl. 428/195.1; 427/249.1; 977/750

(57) ABSTRACT

This invention intends to provide an aligned single-walled CNT aggregate and the like which can be produced easily and has a high specific surface area, in which individual CNTs are aligned and which has excellent shape processability due to low bulk density. The aligned single-walled CNT aggregate of this invention comprises a base material, catalyst particles with a density of 1×10¹⁰ to 5×10¹³N/cm² disposed on the base material, and a plurality of single-walled carbon nanotubes (CNTs) grown from the fine particles of the catalyst, in which the plurality of single-walled CNTs have a specific surface area of 600 m²/g to 2600 m²/g, and a weight density from 0.002 g/cm³ to 0.2 g/cm³, and the alignment degree is defined by a specific condition or conditions.

### TECHNICAL FIELD

The present invention relates to an aligned single-walled carbon nanotube aggregate including a bulk aligned single-walled carbon nanotube aggregate and a powdered aligned single-walled carbon nanotube aggregate, and more specifically, it relates to an aligned single-walled carbon nanotube aggregate, a bulk aligned single-walled carbon nanotube aggregate, a powdered aligned single-walled carbon nanotube aggregate having excellent shape processability and realizing high purity, high specific surface area, large scaling and patterning, an aspect of which has not been hitherto been achieved, and a production method thereof.

### BACKGROUND ART

In recent years, development of carbon nanotubes (CNTs) has been expected for new functional materials such as new electronic device materials, optical device materials, conductive materials, and bio-related materials, and studies have been progressed earnestly for application use, quality, mass productivity, etc.

Among CNTs, single-walled CNTs have attracted attention as a material for nano-electronic devices, nano-optical devices, and energy storage devices since they are extremely excellent in electrical property (extremely high current density), thermal property (heat conductivity comparable with diamond), optical property (light emission in an optical communication band wavelength region), hydrogen storing performance, and metal catalyst supporting performance as well as have both properties of semiconductors and metals.

In a case of effectively utilizing the single-walled CNTs for the application uses described above, it is desired that a plurality of single-walled CNTs form a bundle, film, or aggregate gathered in a specified direction and the single-walled CNT aggregate provides anisotropy in electric or electronic function, optical function or the like. Further, it is desired that the length (height) of the single-walled CNT aggregate is larger. It is expected that the application field of CNT is greatly extended when such aligned single-walled CNT aggregate is created.

On the other hand, one of methods for producing CNT, a chemical vapor deposition method (hereinafter also referred to as a CVD method) has been known (refer, for example, to JP-A-2003-171108, WO/2006/011655). The method has a feature of bringing a carbon compound into contact with fine metal particles as a catalyst in an ambient at a high temperature of about 500° C. to 1,000° C. and CNTs can be produced while variously changing the kind and the arrangement of the catalyst, kind of carbon compounds, and reaction conditions, and it has attracted attention as being suitable to mass production of CNTs. Further, the CVD method has an advantage capable of producing both single-walled carbon nanotube (SWCNT) and multi-walled carbon nanotube (MWCNT) and capable of producing a number of CNTs aligned vertically to the surface of a substrate by using a substrate supporting the catalyst.

However, since CNT is an elongate flexible material having an extremely high aspect ratio and also a material having high tendency to stick together by the strong Van der Waals force, it tends to form an aggregate which is not ordered and not aligned and has a small specific surface area. Then, it is extremely difficult to deconstruct the aggregate once it was in a non-ordered and non-aligned state. Accordingly, it is extremely difficult to produce an aligned CNT aggregate having high specific surface area, alignment property, and excellent processability to various forms and shapes by existent techniques.

### DISCLOSURE OF THE INVENTION

In view of the problems in the prior art described above, the present invention mainly intends to provide an aligned single-walled CNT aggregate, a bulk aligned single-walled CNT aggregate, and an powdered aligned single-walled CNT aggregate which can be produced easily and has a high specific surface area, in which individual CNTs are aligned and which has excellent shape processability due to low bulk density (low weight per unit volume), and to provide a production method for the same. “Aligned single-walled CNT aggregate” referred to in the present specification means a aggregate of a plurality of single-walled CNTs grown to a predetermined direction from a substrate used for growth, “bulk aligned single-walled CNT aggregate” means an object obtained by peeling the aligned single-walled CNT aggregates together from a substrate, and “powdered aligned single-walled CNT aggregate” means an object obtained by peeling the aligned single-walled CNT aggregates from the substrate into a powder form.

For solving the problems described above, the present invention provides the following means and ways.

[1] An aligned single-walled CNT aggregate comprising a base material, fine particles of catalyst with a density of 1×10¹⁰ to 5×10¹³N/cm² disposed on the base material, and a plurality of single-walled carbon nanotubes (CNTs) grown from the fine particles of the catalyst, in which the plurality of single-walled CNTs have a specific surface area of 600 m²/g to 2600 m²/g, and a weight density from 0.002 g/cm³ to 0.2 g/cm³, and the alignment degree is defined by at least one of the following conditions:

(1) in a case where X-rays are incident from a first direction parallel to the longitudinal direction of CNT and a second direction perpendicular to the first direction to measure the X-ray diffraction intensity (θ-2θ method), a θ angle and a reflection direction where the reflection intensity from the second direction is larger than the reflection intensity from the first direction are present, and a θ angle and a reflection direction where the reflection intensity from the first direction is larger than the reflection intensity from the second direction are present,

(2) in a case where the X-ray refraction intensity is measured (Laue method) by 2-dimensional diffraction pattern images obtained by incidence of X-rays in the direction perpendicular to the longitudinal direction of CNT, a diffraction peak pattern showing the presence of the anisotropy appears, and

(3) Herman's orientation factor is greater than 0 and smaller than 1.

[2] It is preferred that powdered base material or linear base material is used as the base material in the above [1].

[3] It is preferred that the average diameter of the powdered base material or the linear base material is 10 μm or more and 1 cm or less in the above [2].

[4] An aligned single-walled CNT aggregate having a specific surface area from 600 m²/g to 2600 m²/g and a weight density from 0.002 g/cm³ to 0.2 g/cm³, in which the alignment degree is defined by at least one of the following conditions.

(1) in a case where X-rays are incident from a first direction parallel to the longitudinal direction of CNT and a second direction perpendicular to the first direction to measure the X-ray diffraction intensity (θ-2θ method), a θ angle and a reflection direction where the reflection intensity from the second direction is larger than the reflection intensity from the first direction are present, and a θ angle and a reflection direction where the reflection intensity from the first direction is larger than the reflection intensity from the second direction are present,

(2) in a case where the X-ray refraction intensity is measured (Laue method) by 2-dimensional diffraction pattern images obtained by incidence of X-rays in the direction perpendicular to the longitudinal direction of CNT, a diffraction peak pattern showing the presence of the anisotropy appears,

(3) in a case where the Herman's orientation factor is greater than 0 and smaller than 1.

[5] An aligned single-walled CNT aggregate in the above [1] or [4], in which in a case where X-rays are incident from a first direction parallel to the longitudinal direction of CNT and a second direction perpendicular to the first direction to measure the X-ray diffraction intensity, the diffraction intensities for the (CP) and (002) diffraction peaks attributable to the packing between single-walled CNTs and the diffraction intensities for the (100) and (110) diffraction peaks attributable to the hexagonal carbon ring structure that constitute the single-walled CNT are different from each other for the first parallel and the second perpendicular incident directions.

[6] A powdered aligned single-walled CNT aggregate having a specific surface area from 600 m²/g to 2600 m²/g, and a weight density from 0.0005 g/cm³ to 0.16 g/cm³, in which the alignment degree is defined by a value of Herman's orientation factor that is greater than 0 and smaller than 1 when calculated based on the intensity profile obtained from images obtained by fast fourier transformation of scanning electron microscopic images or atomic force microscopic images.

[7] A method for producing an aligned single-walled carbon nanotube aggregate of growing an aligned single-walled carbon nanotube aggregate on a base material having fine particles of a catalyst on the surface, the method including;

a formation step of bringing a reducing gas into contact with the catalyst particles and heating at least one of the catalyst particles and the reducing gas, and

a growth step of bringing a source gas containing carbon and not containing oxygen and a catalyst activating material containing oxygen into contact with the catalyst particles, and heating at least one of the catalyst particles, the source gas, and the catalyst activating material, thereby growing the aligned single-walled carbon nanotube aggregate.

The present invention can provide an aligned single-walled CNT aggregate, a bulk aligned single-walled CNT aggregate, and a powdered aligned single-walled CNT aggregate having an extremely useful properties such as high specific surface area, high alignment property, and low density. CNT is a material having a one-dimensional structure with an extremely high aspect ratio and the function thereof also shows a anisotropy. Accordingly, when individual CNTs constituting a CNT aggregate are aligned, the properties of each CNTs are directionally anisotropic, as a result, a CNT structure of superior properties can be obtained. That is, the aligned single-walled CNT aggregate of the invention in which each of CNTs is aligned shows higher anisotropy in view of the transmission property in the alignment direction compared with a CNT aggregate in which the directions of individual CNTs are not-ordered, that is, with no alignment. Due to the high anisotropy, the CNT aggregate shows more preferred electric property (for example, higher conductivity), more preferred mechanical property (for example, higher strength), and more preferred thermal property (for example, higher heat conductivity). Further, the property of such CNT aggregate is different between the alignment direction and other directions, that is, it is anisotropic, and thus is effective, for example, to selectively diffuse and discharge heat or the like in a desired direction and this is suitable for applications such as a heat conductive material.

Further, the aligned single-walled CNT aggregate of the invention has a remarkable feature that the specific surface area is extremely high from 600 m²/g to 2600 m²/g. Such a high specific surface area is effective for a catalyst support or an energy or material storage material and is suitable to an application use, for example, a super capacitor or an actuator.

Further, the aligned single-walled CNT aggregate of the invention has a weight density as low as from 0.002 g/cm³ to 0.2 g/cm³. In the aligned single-walled CNT aggregate grown at such a low density on the substrate, interaction between individual single-walled CNTs to each other constituting the aggregate is weak and it is easy to uniformly disperse the aligned single-walled CNT aggregate detached from the substrate, for example, in a solvent. Accordingly, various functional materials can be attained, for example, by preparing a liquid dispersion of single-walled CNTs using the aligned single-walled CNT aggregate as a carbon source material and compositing them with a different material. On the contrary, in the aligned CNT aggregate grown at a high density on a substrate, since interaction between the CNTs increases, preparation of the liquid dispersion is difficult.

In addition, the aligned single-walled CNT aggregate of the invention which is properly aligned and at a low density is easy for the density control by a post treatment process after growth and CNTs can be packed at a high density with no gaps like a flattened field of corn by way of a density-increasing process. In this case, the aligned single-walled CNT aggregate can be molded into various shapes by controlling the density-increasing process.

Further, by using a base material comprising a granular shaped base material or a linear shaped base material having an average diameter of 10 μm or more and 1 cm or less, a number of aligned CNT aggregates can be produced per unit area of the base material occupying the inside of a synthesis furnace (area of a plane defined by longitudinal and lateral directions of a space occupied by the base material) and this is suitable to the production of the aligned CNT aggregates in a great amount.

Further, by using a combination of a source material containing carbon and not-containing oxygen and a catalyst activating material containing oxygen, since the structure and the property such as an average outer diameter, a full-width at half maximum, a specific surface area, a crystallinity and purity of CNT to be produced and a density, a height, and an alignment property of the aligned CNT aggregate are changed, various aligned CNT aggregates can be produced.

### BRIEF DESCRIPTION OF THE DRAWINGS

FIG. 1 shows digital camera images of an aligned single-walled CNT aggregate according to the invention;

FIG. 2 shows enlarged electron microscopic (SEM) images for a portion of an aligned single-walled CNT aggregate shown in FIG. 1;

FIG. 3 shows digital camera images of bulk aligned single-walled CNT aggregate peeled from a substrate and placed in a container;

FIG. 4 shows digital cameral images of a bulk aligned single-walled CNT aggregate peeled from a substrate and enlarged scanning electron microscopic (SEM) images for a portion of the side thereof;

FIG. 5 shows scanning electron microscopic (SEM) images for portions of a powdered aligned single-walled CNT aggregate peeled from a substrate enlarged at magnifying factors different from each other;

FIG. 6 shows a nitrogen adsorption/desorption isotherm curve at 77K for an aligned single-walled CNT aggregate with no opening treatment applied;

FIG. 7 shows an αₛ plot diagram for an aligned single-walled CNT aggregate with no opening treatment applied;

FIG. 8 shows a nitrogen adsorption/desorption isotherm curve at 77K for an aligned single-walled CNT aggregate with opening treatment applied;

FIG. 9 shows an αₛ plot diagram for an aligned single-walled CNT aggregate applied with the opening treatment;

FIG. 10 is a graph showing a relation between the temperature of the opening treatment and the specific surface area of the aligned single-walled CNT aggregate;

FIG. 11 is a schematic view of a bundle structure of CNTs in which FIG. 11(a) shows a structure with a large diameter, a broad size distribution and low linearity and FIG. 11(b) shows a structure with a small diameter, a narrow size distribution and high linearity;

FIG. 12 is a schematic view of a bundle structure of CNTs in the aligned single-walled CNT aggregate of the invention;

FIG. 13 shows electron microscopic (TEM) images of single-walled CNTs in the aligned single-walled CNT aggregate;

FIG. 14 is a graph showing the result of measurement for the size distribution (outer diameter) of CNT in the aligned single-walled CNT aggregate;

FIG. 15 is a graph showing the result of measurement for the size distribution (outer diameter) of CNT in a second aligned single-walled CNT aggregate;

FIG. 16 is a graph showing the result of measurement for the size distribution (outer diameter) of CNT in a third aligned single-walled CNT aggregate;

FIG. 17 is a graph showing the result of measurement for the size distribution (outer diameter) of CNT in a fourth aligned single-walled CNT aggregate;

FIG. 18 is a graph showing the result of measurement for Raman spectroscopy of CNT in an aligned single-walled CNT aggregate;

FIG. 19 is a graph showing the result of measurement for Raman spectroscopy of CNT in a second aligned single-walled CNT aggregate;

FIG. 20 is a graph showing the result of measurement for Raman spectroscopy of CNT in a third aligned single-walled CNT aggregate;

FIG. 21 is a schematic constitutional view showing a measuring apparatus by a θ-2θ method in which FIG. 21(a) is a perspective view thereof and FIG. 21(b) is a plan view thereof;

FIG. 22 is an X-ray diffraction spectral diagram when measuring the aligned single-walled CNT aggregate by a θ-2θ method;

FIG. 23 is an X-ray diffraction spectral diagram of a (CP) diffraction peak when measuring the aligned single-walled CNT aggregate by the θ-2θ method in which FIG. 23(a) shows a case where the X-ray incident direction and the CNT alignment direction are parallel and FIG. 23(b) shows a case where the X-ray incident direction and the CNT alignment direction are perpendicular to each other;

FIG. 24 is an X-ray diffraction spectral diagram for (002), (100), (110) diffraction peaks, when measuring the aligned single-walled CNT aggregate by the θ-2θ method in a case where the X-ray incident direction and the CNT alignment direction are in parallel to each other and in a case where the X-ray incident direction and the CNT alignment direction are perpendicular;

FIG. 25 is a schematic constitutional view showing a measuring apparatus by Laue method;

FIG. 26 shows refraction pattern images of an aligned single-walled CNT aggregate by the Laue method;

FIG. 27 shows fast Fourier transformation images for scanning electron microscopic images in FIG. 5;

FIG. 28 shows an intensity profile determined from the fast Fourier transformation images in FIG. 27;

FIG. 29 shows an example of an X-ray intensity function from diffraction pattern images by the Laue method;

FIG. 30 is an explanatory view showing the method of deriving an X-ray intensity function from diffraction pattern images by the Laue method;

FIG. 31 is a graph showing a relation between the addition amount of fine particles of catalyst and the weight density of an aligned single-walled CNT aggregate;

FIG. 32 is a graph showing a relation for height-weight and height-density of an aligned single-walled CNT aggregate;

FIG. 33 is a graph showing a pore diameter distribution of powdered aligned single-walled CNT aggregates determined by a BJH method;

FIG. 34 is a side elevational view schematically showing a CNT production apparatus of the invention;

FIG. 35 is a flow chart schematically showing a CNT production process of the invention;

FIG. 36 is a view showing the height of an aligned CNT aggregate (growth efficiency) formed by a verification experiment;

FIG. 37 is a flow chart for a production step according to Example 1;

FIG. 38 is a view showing process conditions for the synthesis procedures shown in FIG. 37;

FIG. 39 is an image of fine iron particles observed by a scanning electron microscope;

FIG. 40 is a flow chart of a production step according to Example 2;

FIG. 41 shows process conditions for synthesis procedures shown in FIG. 40;

FIG. 42 shows electron microscopic (SEM) images for an aligned single-walled CNT aggregate patterned into a circular columnar shape;

FIG. 43 shows electron microscopic (SEM) images for the base of the aligned single-walled CNT aggregate in FIG. 42;

FIG. 44 shows enlarged electron microscopic (SEM) images showing the base of the aligned single-walled CNT aggregate in FIG. 42;

FIG. 45 shows electron microscopic (SEM) images showing an example of an aligned single-walled CNT aggregate;

FIG. 46 shows electron microscopic (SEM) images showing a second example of an aligned single-walled CNT aggregate;

FIG. 47 shows electron microscopic (SEM) images showing a third example of an aligned single-walled CNT aggregate;

FIG. 48 shows electron microscopic (SEM) images showing a fourth example of an aligned single-walled CNT aggregate;

FIG. 49 shows electron microscopic (SEM) images showing a fifth example of an aligned single-walled CNT aggregate;

FIG. 50 shows electron microscopic (SEM) image showing the state of observing an example of a bulk aligned single-walled CNT aggregate from the frontal side;

FIG. 51 shows electron microscopic (SEM) image showing the state observing an example of a bulk aligned single-walled CNT aggregate for a corner;

FIG. 52 shows digital camera image of an aligned single-walled CNT aggregate grown to a height of about 1 cm;

FIG. 53 shows electron microscopic (SEM) image of an aligned single-walled CNT aggregate grown to a height of 12 μm just from the side;

FIG. 54 is a growth curve of an aligned single-walled CNT aggregate measured during growth by using a telecentric optical measuring system;

FIG. 55 is a digital photograph of aligned single-walled CNT aggregates grown on alumina particles of an average diameter of 3 mm.

FIG. 56 is a digital photograph of an aligned single-walled CNT aggregate grown on silica particle with an average diameter of 300 μm.

FIG. 57 is an SEM image showing the structure of an aligned single-walled CNT aggregate of Example 3.

FIG. 58 is an SEM image of aligned single-walled CNT aggregates produced by using an SUS 304 wire of an average diameter of 100 μm as a base material.

FIG. 59 is an SEM image of an aligned single-walled CNT aggregates produced by using an SUS 304 wire of an average diameter of 30 μm as a base material.

FIG. 60 is an SEM image of aligned single-walled CNT aggregates produced by using an SUS 304 wire of an average diameter of 16 μm as a base material.

FIG. 61 is a schematic view of a separation device used for separating the bulk aligned single-walled CNT aggregate from a substrate or a catalyst;

FIG. 62 is a schematic explanatory view showing a relation between the incident direction of X-rays and an alignment direction of CNT;

FIG. 63 is a schematic view for a separation device used for separating a powdered aligned single-walled CNT aggregate from a substrate or a catalyst;

FIG. 64 shows digital camera images for a powdered aligned single-walled CNT aggregate peeled from a substrate and placed in a container;

FIG. 65 is a view showing a liquid dispersion in which powdered aligned single-walled CNT aggregates are dispersed in DMF;

FIG. 66 is a view showing a liquid dispersion in which density-increased powdered aligned single-walled CNT aggregates are dispersed in DMF.

FIG. 67 is a graph showing an example of growing curves obtained by measuring the growing speed of CNT on real time by a telecentric measuring system in a case of using carbon dioxide as a catalyst activating substance.

FIG. 68 is a graph showing an example of growing curves obtained by measuring the growing speed of CNT on real time by a telecentric measuring system in a case of using acetone as a catalyst activating substance.

### PREFERRED EMBODIMENTS OF THE INVENTION

The present invention will be described in detail by way of preferred embodiments with reference to the appended drawings.

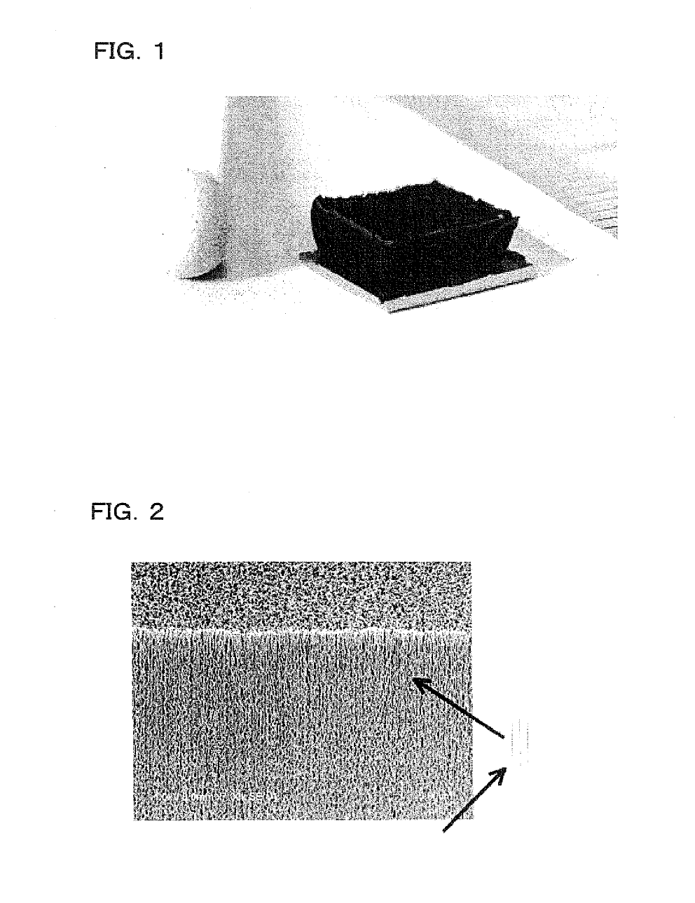

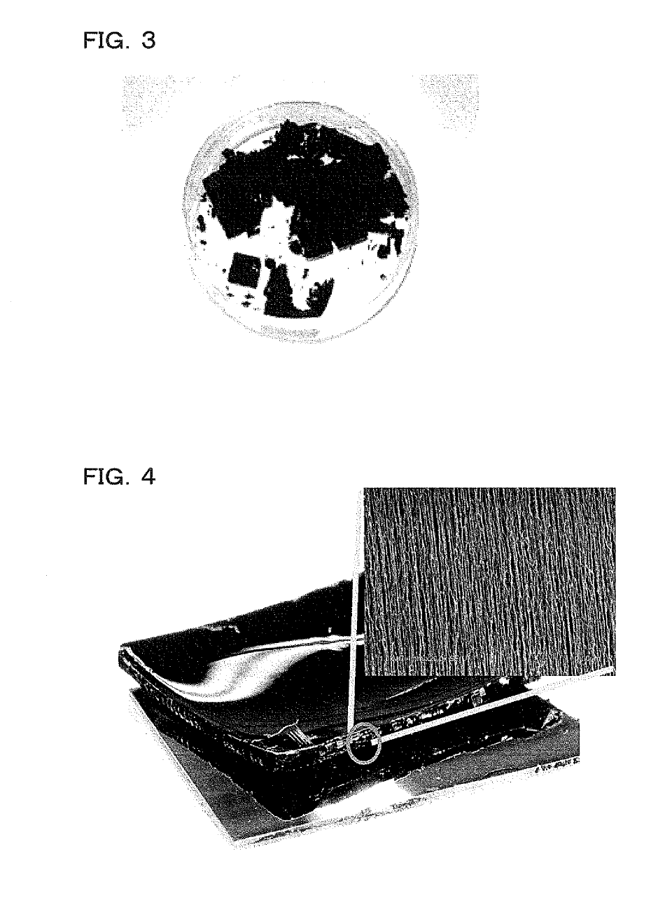

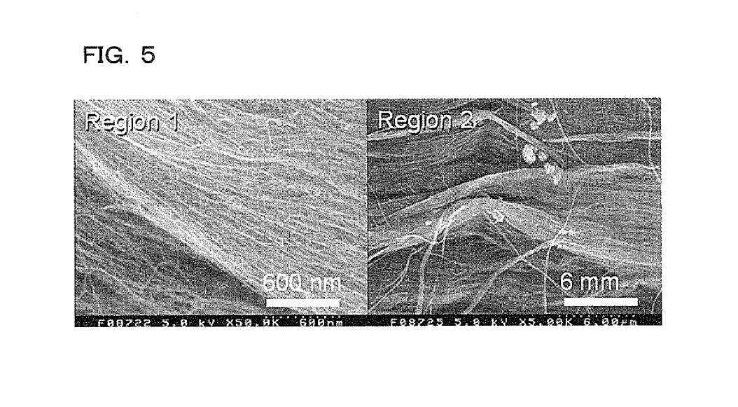

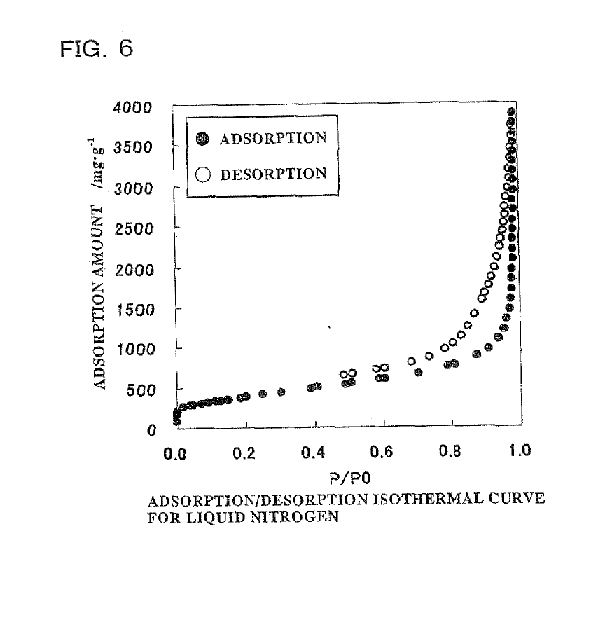

FIG. 1 shows images taken by a digital camera for an entire aligned single-walled CNT aggregate of the invention and FIG. 2 shows scanning electron microscopic (hereinafter also referred to as SEM) images in an enlarged scale for a portion of the same aligned single-walled CNT aggregate of the invention, FIG. 3 shows images taken by a digital camera for bulk aligned single-walled CNT aggregates after peeling them off from a base material, FIG. 4 shows digital cameral images for bulk aligned single-walled CNT aggregates peeled off from the substrate, with enlarged SEM images of the side, and FIG. 5 shows SEM images for powdered aligned single-walled CNT aggregates after peeling off from the base material. Region 1 and Region 2 in FIG. 5 are the images of the different regions of the same sample.

### [Specific Surface Area of CNT]

A preferred specific surface area of the aligned single-walled CNT aggregate including the bulk aligned single-walled CNT aggregate and the powdered aligned single-walled CNT aggregate is 600 m²/g or more in a case where the single-walled CNT is not-opened mostly and 1300 m²/g or more in a case where single-walled CNT is opened mostly.

A not-opened CNT aggregate having the specific surface area of less than 600 m²/g or an opened CNT aggregate having the specific surface area of less than 1300 m²/g contain metal impurities or carbon impurities by several tens percent (about 40%) by weight, and cannot exhibit the inherent properties of CNT and is not suitable to applications such as catalyst support, energy or material storage, super capacitor, and actuator.

Generally, while larger specific surface area of the aligned single-walled CNT aggregate is more preferred, it has a theoretical upper limit, which is about 1300 m²/g for a not-opened aggregate and about 2600 m²/g for an opened aggregate.

The specific surface area of the aligned single-walled CNT aggregate can be determined by measuring a nitrogen adsorption/desorption isothermal curve at 77K. As an example, FIG. 6 shows an adsorption/desorption isothermal curve measured for 30 mg of the bulk aligned single-walled CNT aggregate produced in Example 1 to be described below in detail, by using BELSORP-MINI (produced by BEL Japan Inc.) (adsorption equilibrium time: 600 sec). When the specific surface area was measured from the adsorption/desorption isothermal curve by a method of Brunauer-Emmett-Teller, it was 1100 m²/g. In the graph, P is an adsorption equilibrium pressure and P₀ is a saturation vapor pressure.

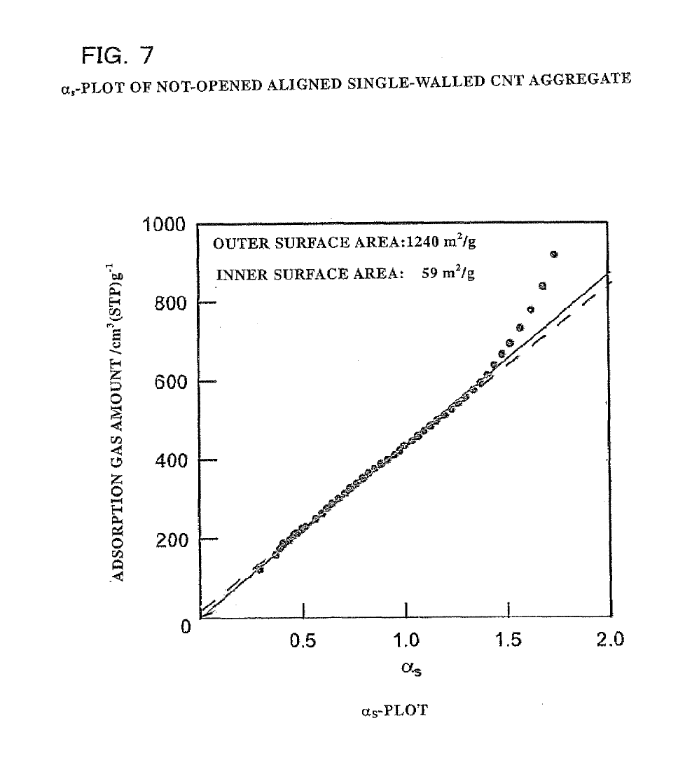

An adsorption/desorption isothermal curve for a not-opened aligned single-walled CNT aggregate shows a high linearity in a region of a relative pressure of 0.5 or lower. Further, as shown in FIG. 7, also an αₛ plot showed a linearity in a region of 1.5 or less. The measuring result shows that this example is not-opened single-walled CNT.

The specific surface area of the aligned single-walled CNT aggregate can be further increased by applying the opening treatment to the single-walled CNT. As the opening treatment, a dry process treatment by oxygen can be used. Further, in a case where a wet process treatment can be used, acid treatment, specifically, a treatment of refluxing hydrogen peroxide, a cutting treatment with hydrochloric acid at high temperature, etc. can be used.

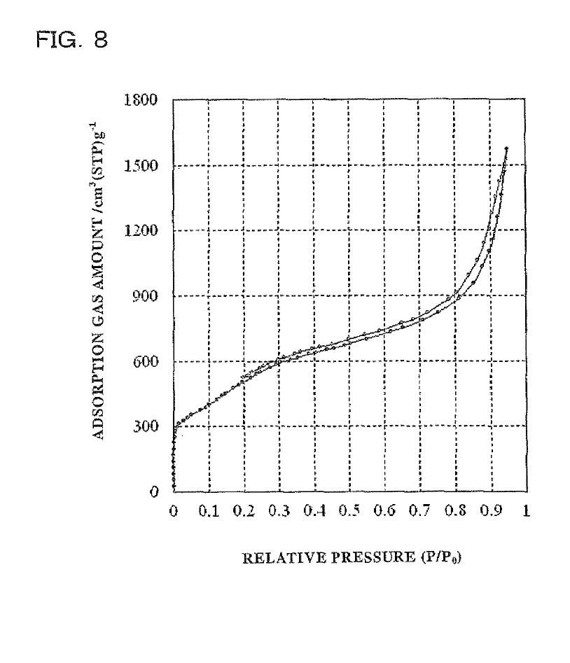

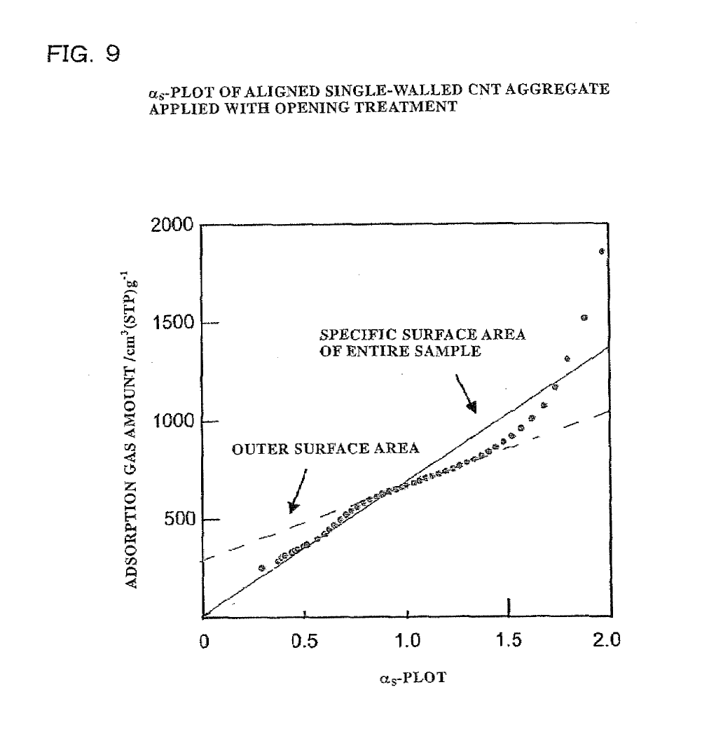

The adsorption/desorption isothermal curve of an aligned single-walled CNT aggregate applied with an opening treatment by the method described in the Journal of Carbon, vol. 45, p 722-726 (2007) (up to 500° C. in dry air at a temperature elevation rate of 1° C./min) is characterized by a large rising in initial adsorption and by showing a convex form in a region of a relative pressure of 0.5 or lower as shown in FIG. 8. Further, as shown in FIG. 9, also the αₛ plot does not show a linearity in which the increment of the adsorption amount is relatively large in a region of 0.7 or lower and relatively small in a region of 0.7 or higher and it shows a convex form in a region of 1.0 or lower.

The specific surface area of the aligned single-walled CNT aggregate can be derived in the αₛ plot from a region of 0.7 or lower where the increment of the adsorption amount is large. In a case of a sample from which the data in FIG. 8 is obtained, it was 2236 m²/g and it was found that the specific surface area increased by the opening treatment.

The adsorption/desorption isothermal curve and the αₛ plot show a convex form because adsorption is generated on the inner surface and the outer surface in the CNT opened. That is, it can be distinguished whether the CNT is not-opened or opened by measuring the adsorption/desorption isothermal curve.

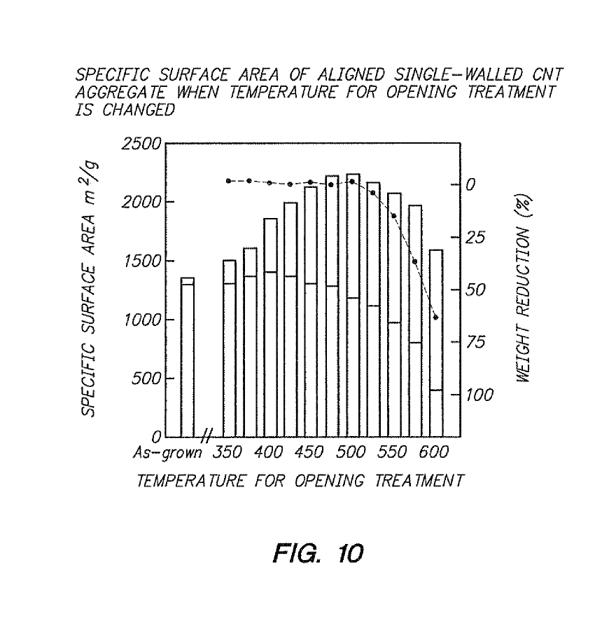

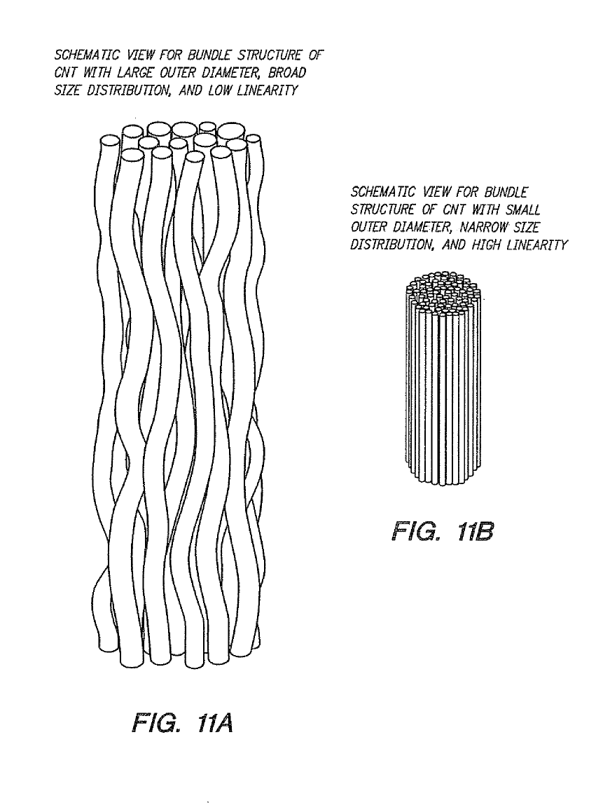

There is a correlation between the opening treatment temperature and the specific surface area and, as shown in FIG. 10, the specific surface area of the aligned single-walled CNT aggregate could be changed within a range from 1,000 m²/g to 2,300 m²/g continuously by changing the opening treatment temperature from 350° C. to 600° C.

Even when the opening treatment is applied, it could be that not all of CNT are opened. In the aligned single-walled CNT aggregate, not-opened CNT and opened CNT may be present in admixture to a degree where the deteriorating of the properties are not serious.

The aligned single-walled CNT aggregate having such an extremely high specific surface area has not been obtained so far and has been obtained for the first time by the invention. The reason why the specific surface area of the aligned single-walled CNT aggregate according to the invention is extremely large is attributable to the provision of the following conditions.

### 1. The Aligned CNT Aggregate Comprises Single-Walled CNTs.

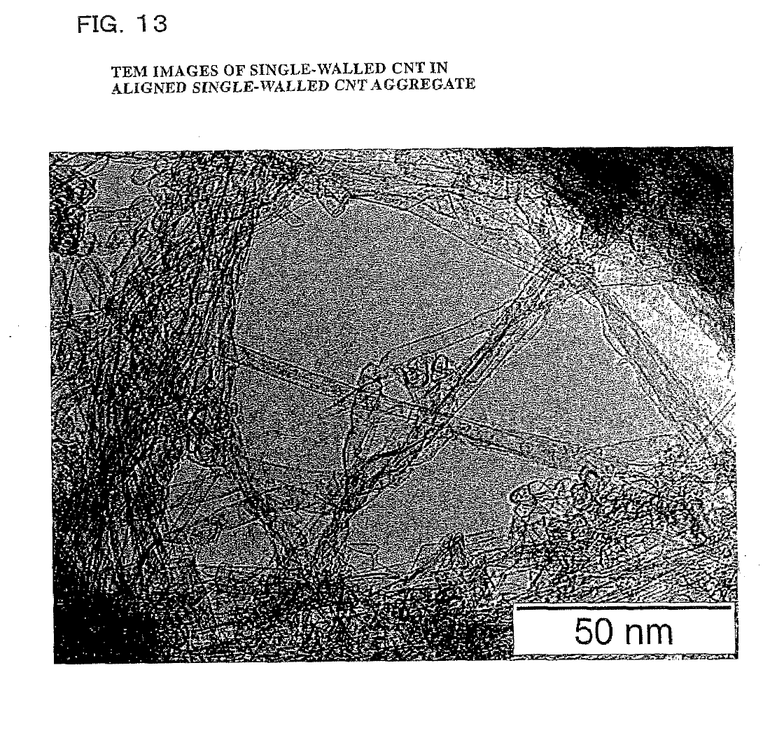

In the aligned CNT aggregate comprising multi-walled CNTs, since nitrogen atoms cannot diffuse between carbon layers of CNTs, the specific surface area is decreased greatly. For example, the specific surface area of an aligned double-walled CNT aggregate is about one-half of that of the aligned single-walled CNT aggregate. The content of the single-walled CNT in the aligned CNT aggregate of the invention was 99.5% or more when determined from transmission electron microscopic (hereinafter also referred to as TEM) images (refer to FIG. 13).

### 2. Single-Walled CNT Constituting Aligned CNT Aggregate is of High Purity.

For obtaining a high specific surface area, it is desired that the purity of the single-walled CNT is as high as possible. The purity referred to herein is a carbon purity, which shows the weight percentage of the carbon constituting the weight of the aligned single-walled CNT aggregate. There is no upper limit of the purity for obtaining a high specific surface area, but it is difficult to obtain an aligned single-walled CNT aggregate at a purity of 99.9999% or higher because of contamination during the production. When the purity is lower than 95%, it is difficult to obtain a specific surface area exceeding 1,000 m²/g in a case of a not-opened single-walled CNT. Further, in a case where metal impurities are contained and the carbon purity is lower than 95%, since metal impurities react with oxygen and prevents controlled opening of the single-walled CNT in the opening treatment process for single-walled CNT and, as a result, increase of the specific surface area becomes difficult. In view of the above, it is preferred that the purity of the single-walled CNT is 95% or higher.

The purity of the aligned single-walled CNT aggregate of the invention is obtained by elemental analysis using fluorescent X-rays. When an aligned single-walled CNT aggregate formed by the method of Example 1 to be described below was put to elemental analysis by fluorescent X-rays, carbon was 99.98%, iron was 0.013%, and other elements were not measured. Further, when the aligned single-walled CNT aggregate formed on a substrate supporting the catalyst, made of nickel-iron alloy was characterized by elemental analysis by fluorescent X-rays, carbon was 99.9%, and nickel was 198 ppm and iron was 100 ppm as impurities.

### 3. The Average Outer Diameter of the Single-Walled CNTs Constituting the Aligned CNT Aggregate is Large, and the Full-Width at Half Maximum Representing the Range for the Outer Diameter Distribution is Large.

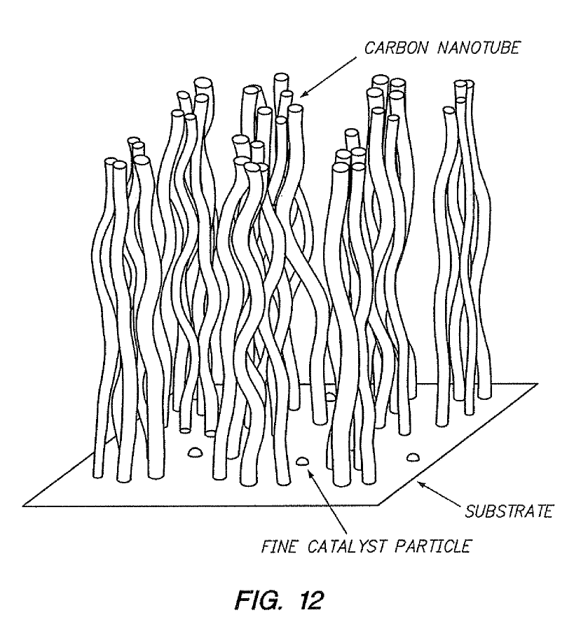

The single-walled CNTs constituting an aligned single-walled CNT aggregate are not independent and isolated from each other but form a bundle in which a number of single-walled CNTs are touching each other as shown in FIG. 11.

The bundle of the single-walled CNTs constituting the aligned single-walled CNT aggregate of the invention comprises single-walled CNTs having a large average outer diameter (2 nm or more) a broad outer diameter distribution range (full-width at half maximum of 1 nm or more) and, in addition, low linearity (G/D ratio of 50 or less) as shown in FIG. 11(a). Then, in the aligned single-walled CNT aggregate of the invention, single-walled CNTs grown from fine particles of catalyst on the substrate are grown in the direction normal to the surface of a substrate while forming a plurality of bundles where several to several tens of CNTs are touching to each other each as shown in FIG. 12. Accordingly, a gap through which nitrogen atoms can diffuse is formed between CNTs resulting in a high specific surface area. That is, large average outer diameter and a broad outer diameter distribution range of the single-walled CNT are suitable for obtaining a high specific surface area.

For the range of the average outer diameter and the full-width at half maximum of the single-walled CNTs desired for obtaining an aligned single-walled CNT aggregate of high specific surface area, the average outer diameter is 1.5 nm or more and 4 nm or less, and the full-width at half maximum is 1 nm or more.

In a case where the average outer diameter of the CNT exceeds 4 nm, since the amount of the multi-walled CNT increases, the specific surface area decreases. Further, in a case where the average outer diameter of the CNT exceeds 4 nm, since the single-walled CNT tends to be deformed into a flattened shape, the specific surface area when opened is decreased. In a case where the average outer diameter of the CNT is less than 1.5 nm, since many CNTs are touching each other with no gaps tending to form a large bundle, the specific surface area decreases. Further, in a case where the full-width at half maximum is less than 1 nm, that is, the outer diameter of CNT constituting the aligned single-walled CNT aggregate becomes uniform, since a number of CNTs are also adhered to each other with no gaps tending to form a large bundle, this causes decrease of the specific surface area. The full-width at half maximum has no particular upper limit.

On the contrary, as shown in FIG. 11(b), in an existent aligned single-walled CNT aggregate having a small average outer diameter (less than 1.5 nm), a narrow outer diameter distribution range (full-width at half maximum: less than 0.5 nm), and a high linearity (G/D ratio of 50 or more), it usually tends to form a bundle where the single-walled CNTs are closely packed by the number of several hundreds to several tens thousand. In this case, nitrogen atoms cannot diffuse through the gap between each of the CNTs in the bundle to decrease the specific surface area. For example, according to the description of The Journal of Carbon, vol. 41, pp 1273-1280 (2003), the HiPco single-walled CNT produced by Carbon Nanotechnologies Co. has an average outer diameter of about 0.75 nm, a full-width at half maximum of less than 0.5 nm and a high linearity. According to the description of The Journal of Nano Letters, vol. 2, pp 385 to 388 (2002), the specific surface area of such HiPco single-walled CNT is 861 m²/g even when the opening treatment is applied, which is extremely smaller compared with the specific surface area of the aligned single-walled CNT aggregate of the invention.

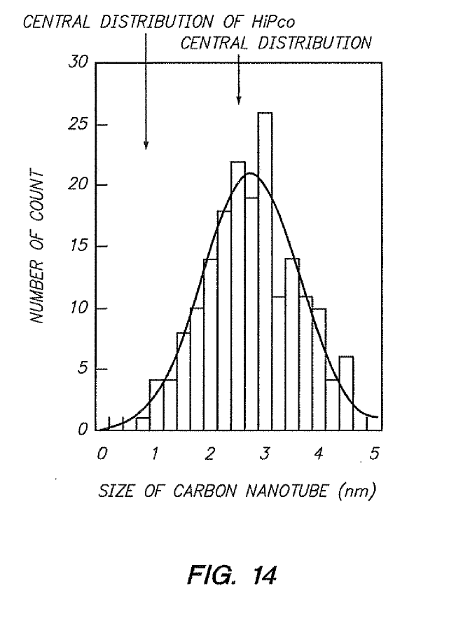

The average outer diameter and the full-width at half maximum of CNTs constituting the aligned single-walled CNT aggregate of the invention can be determined based on a histogram which is prepared by measuring the outer diameter for individual CNTs from TEM images for an aligned single-walled CNT aggregate as shown in FIG. 13. FIG. 14 shows an example for the average outer diameter and the full-width at half maximum of the single-walled CNT in the aligned single-walled CNT aggregate produced according to Example 1 of the invention obtained as described above. In the case of this example, the outer diameter distributes over a range of 0.8 to 4.5 nm, the average outer diameter is 2.8 nm, and the full-width at half maximum is 2 nm. The average outer diameter and the full-width at half maximum can be controlled by the preparation of fine particles of catalyst.

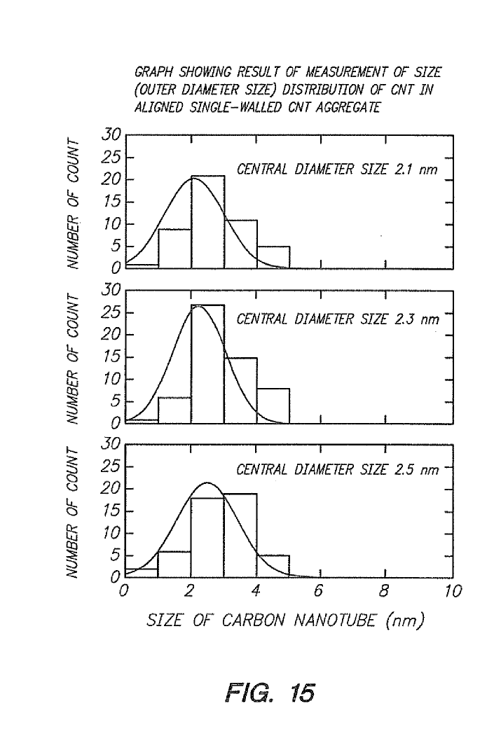

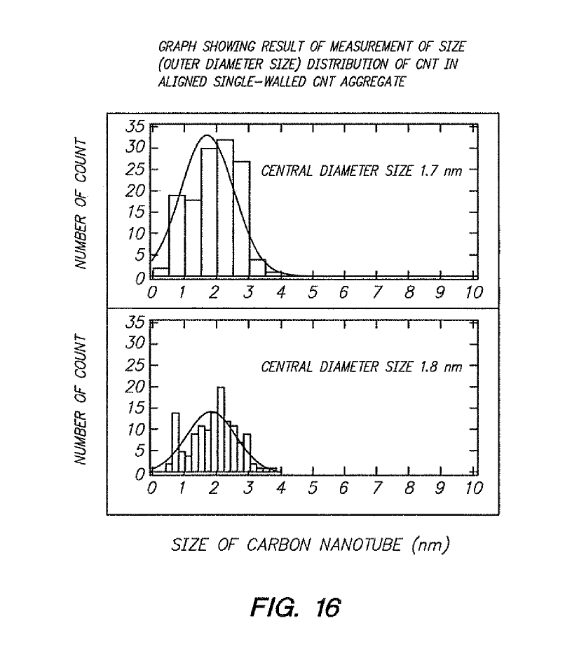

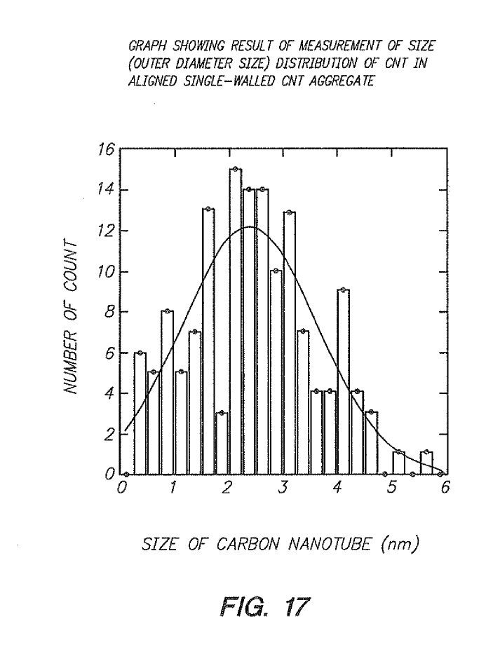

FIG. 15 shows the result of measurement for the average outer diameter and the full-width at half maximum of the single-walled CNT in the aligned single-walled CNT aggregate formed by placing substrates each having a catalyst thickness of 1.3 nm at three places different from each other in a synthesis furnace (near the center, 4 cm to the downstream, 8 cm to the downstream) for a growth time of 5 min in the method of Example 2 to be described later (average outer diameter: 2.1 nm, 2.3 nm, 2.5 nm, full-width at half maximum: 2 nm) and FIG. 16 shows the result of measurement for the average outer diameter and the full-width at half maximum of the single-walled CNT in the aligned single-walled CNT aggregate in a case of defining the catalyst thickness to 0.8 nm also in the method of the same Example 2 (average outer diameter: 1.7 nm, full-width at half maximum: 1.6 nm, average outer diameter: 1.8 nm, full-width at half maximum: 1.8 nm). Further, FIG. 17 shows the result of measurement for the average outer diameter and the full-width at half maximum of the single-walled CNT in the aligned single-walled CNT aggregate in a case of defining the thickness of the catalyst to 1.3 nm in the method of Example 1 to be described later (average outer diameter: 2.5 nm, full-width at half maximum: 3 nm).

From the result of the measurement, it was found that the aligned single-walled CNT aggregate of the invention can be formed within a range of the average outer diameter of from 1.7 to 2.8 nm and within a range of the full-width at half maximum of from 1.6 to 3 nm.

### 4. Linearity (Crystallinity) of Single-Walled CNT is Low.

The linearity (crystallinity) of a single-walled CNT can be evaluated by the G/D ratio for Raman spectrum to be described later specifically, and a preferred range for the linearity (crystallinity) of the single-walled CNT of the G/D ratio for obtaining an aligned single-walled CNT aggregate of a high specific surface area is 1 or more and 50 or less. G/D is defined as the intensity ratio between the G-band and D-band of the Raman spectrum. The G-band originates from the C—C stretching mode at around 1590 cm⁻¹, and the D-band associated with defects and amorphous carbon is observed at around 1340 cm⁻¹.

A CNT with the G/D ratio of less than 1 has low crystallinity of the single-walled CNT and suffers from high level of amorphous carbon and, in addition, it is considered that the content of multi-walled CNTs is large. On the contrary, a CNT with the G/D ratio exceeding 50 has a high linearity and tends to form a large bundle with less gap for the single-walled CNT and the specific surface area may possibly be decreased.

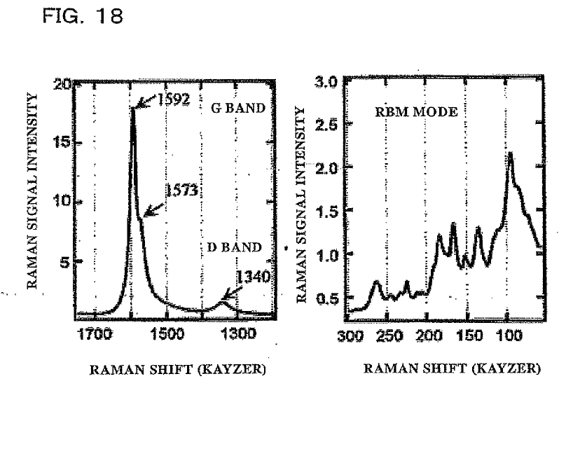

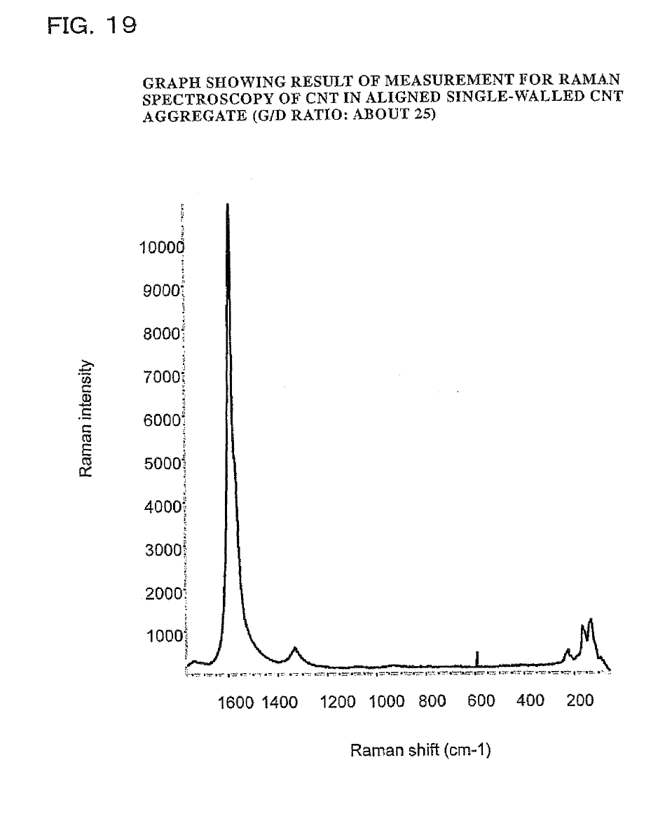

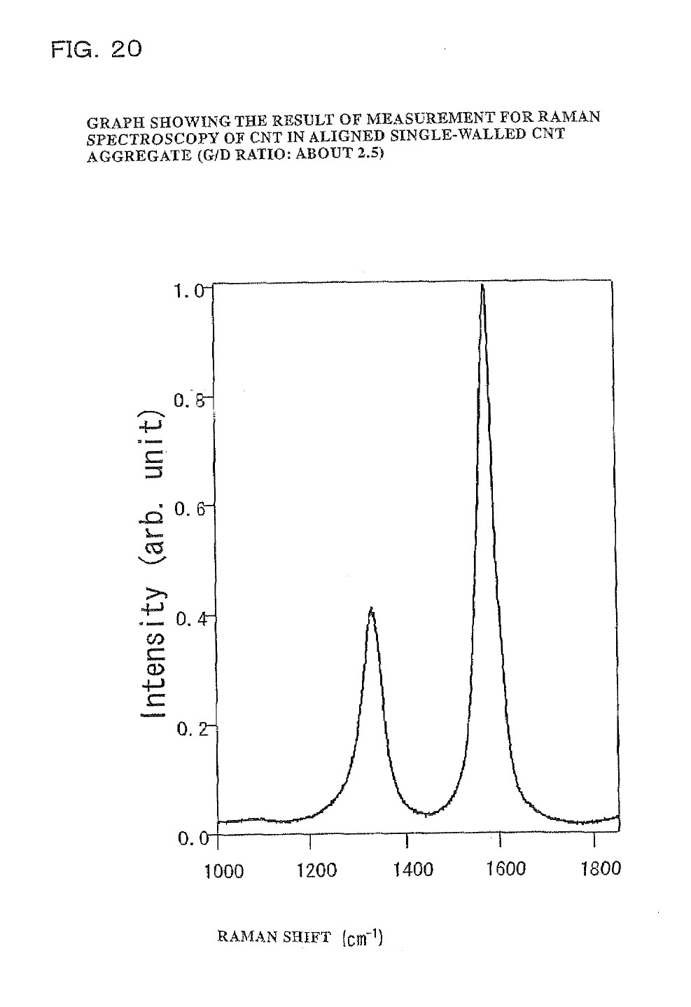

FIG. 18 to FIG. 20 show examples of Raman spectral data for aligned single-walled CNT aggregates of the invention. FIG. 18 shows the result of measurement of Raman spectroscopy for the aligned single-walled CNT aggregate formed by the method of Example 1 to be described later for a growth time of 10 min, FIG. 19 shows that for the aligned single-walled CNT aggregate by the method of Example 2 to be described below formed for the growth time of 1 min. FIG. 20 shows the result of measurement of Raman spectroscopy for the aligned single-walled CNT aggregate produced with the addition amount of water as the catalyst activating material being decreased to one-half in the method of Example 2.

In FIG. 18, a sharp G band peak is observed near 1590 Kaiser which means that a graphitic hexagonal carbon ring structure is present in the CNTs constituting the aligned single-walled CNT aggregate of the invention. Further, a D band peak attributable, for example, to defect structure is observed near 1340 Kaiser. Further, since an RBM mode attributable to a plurality of single-walled CNTs is observed on the side of low wavenumber (100 to 300 Kaiser), it can be seen that the graphite layer is a single-walled CNT.

The intensity ratio between the G band and the D band (G/D ratio) is 15 for those shown in FIG. 18, 25 for those shown in FIG. 19, and 2.5 for those shown in FIG. 20. When TEM images (FIG. 13) were observed, it can be seen that the single-walled CNT of the invention is bent or deformed or buckled, and thus have low linearity.

On the contrary, according to the description in the Journal of J. Phys. Chem. B, vol. 110, p 5849-5853 (2006), the G/D ratio of a high quality single-walled CNT with high linearity and not containing defect structure is generally 50 or more and sometimes 200 or more.

From the abovementioned discussion, it is considered that the G/D ratio can be defined as an evaluation index for the linearity of CNT.

It is preferred that the aligned single-walled CNT aggregate of the invention satisfies all of the four conditions described above, but it is not always necessary to satisfy all of the four conditions for obtaining a high specific surface area and it may suffice to satisfy only a few of the conditions properly.

### [Alignment Property of CNT]

The evaluation the alignment of the single-walled CNT aggregate is made on the basis of Herman's orientation (alignment). Its specific method will be described. Herman's orientation factor calculated by using the X-ray diffraction intensity obtained by the θ-2θ method or the Laue method, or the intensity profile obtained from images obtained by fast fourier transformation of SEM images or atomic force microscopic (hereinafter referred to also as AFM) images is more than 0 and, less than 1 and, more preferably, 0.25 or more and 1 or less in the aligned single-walled CNT aggregate of the invention. The aligned single-walled CNT aggregate within a range of such alignment shows good electric property, good mechanical property, and good thermal property, also has a high specific surface area, and is highly integrated, easy to handle with, and also satisfactory in view of the shape processability. In addition, it shows sufficient thermal conductivity, electric, or mechanical anisotropy and is suitable to various application uses.

On the contrary, an aligned single-walled CNT aggregate with the Herman's orientation factor of less than 0 shows no alignment property. Further, in the aggregate with the Herman's orientation factor of less than 0.25, CNTs within the aggregate are offset by an average of 45° from the alignment direction and the effect of alignment would be decreased roughly to the half. Further, in the aggregate with the Herman's orientation factor of less than 0.62, CNTs within the aggregate are offset by an average of 30° from the alignment direction and the effect of alignment would be decreased considerably from a perfect alignment. Further, the aligned single-walled CNT aggregate with the Herman's orientation factor of 1 is perfectly aligned.

For the aligned single-walled CNT aggregate to show a good degree of alignment and high specific surface area, it is preferred that the aligned single-walled CNT aggregate has a height (length) within a range of 10 μm or more and 10 cm or less. The aligned single-walled CNT aggregate within the range of the height has a good degree of alignment and a high specific surface area. In a case where the height is less than 10 μm, the degree of alignment decreases. Further, in the aggregate with the height exceeding 10 cm, since it takes a long time to grow, carbonaceous impurities tend to deposit resulting in a decrease of the specific surface area. Further, the aligned single-walled CNT aggregate within the range of the height works as a single cohesive unit, is easy to handle with, and can be formed into various shapes.

The alignment property of the aligned single-walled CNT aggregate, the bulk single-walled CNT aggregate and the powdered aligned single-walled CNT aggregate can be evaluated by the following methods.

### (1) Evaluation for Alignment Property by an X-Ray Diffraction (θ-2θ Method)

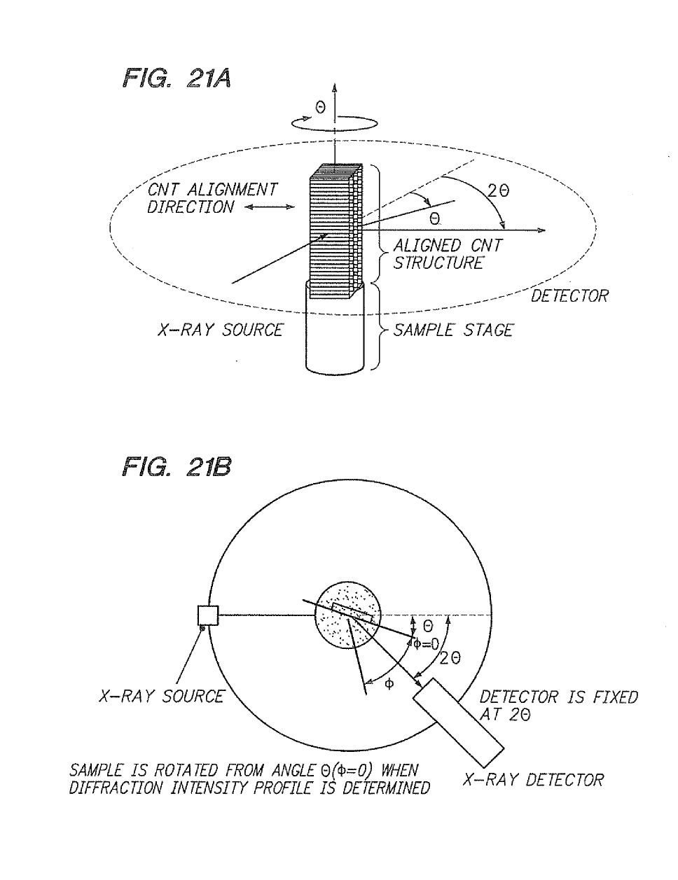

FIG. 21 shows a set up state of an X-ray diffraction apparatus by a θ-2θ method. In the constitution described above, when X-ray diffraction spectrum is measured for an object having the alignment property both for the case where X-rays are incident from the first direction parallel with the alignment direction (hereinafter referred to as parallel incidence) and for the case where X-rays are incident from the second direction perpendicular to the alignment direction (hereinafter referred to as perpendicular incidence), an angle θ and a reflection direction where the reflection intensity of the perpendicularly incidence is larger than the reflection intensity of the parallel incidence are present, and an angle θ and a reflection direction where the reflection intensity of the parallel incidence is larger than the reflection intensity of the perpendicular incidence are present.

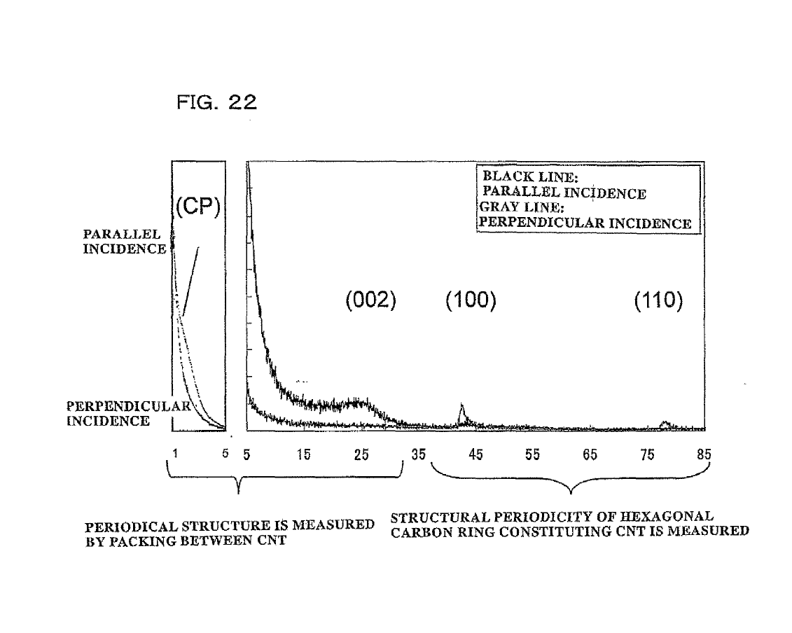

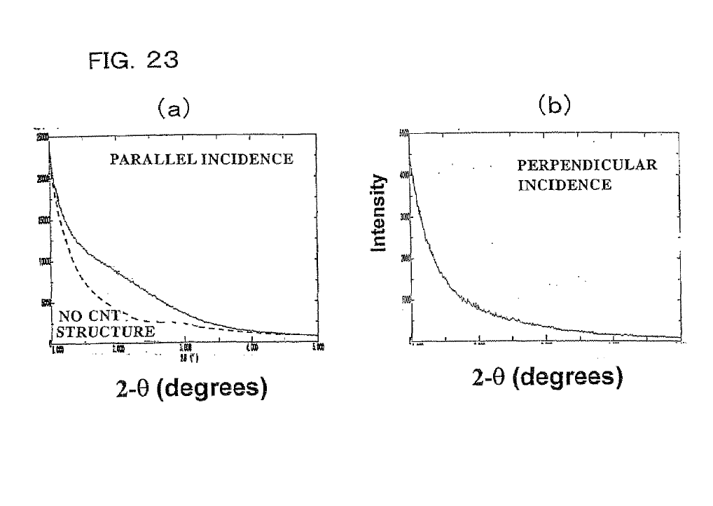

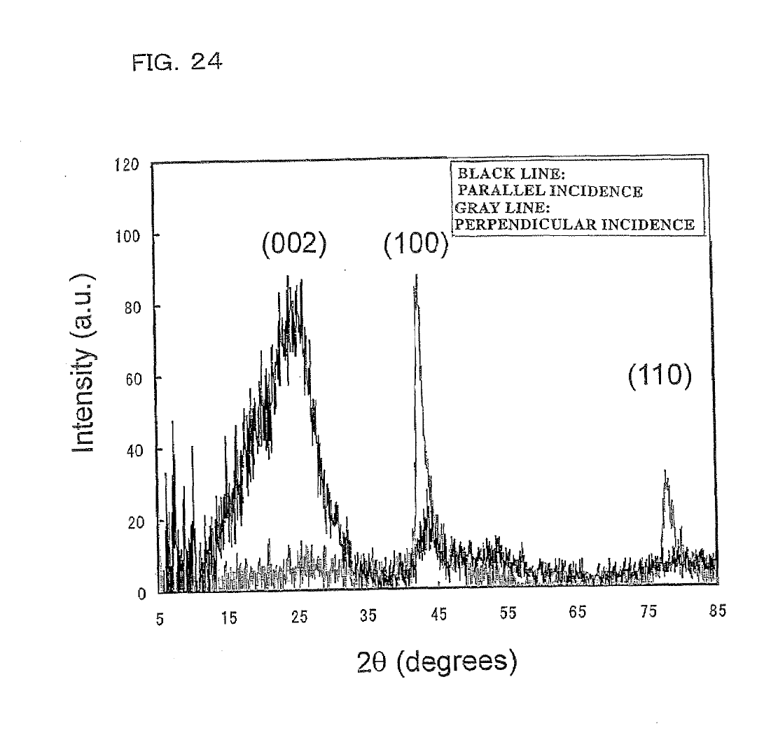

In the aligned single-walled CNT aggregate of the invention, as shown in FIG. 22 to FIG. 24, for the peak diffraction intensity of X-ray diffraction spectrum of parallel incidence, (CP=close-packing) and (002) attributable to the packing between the single-walled CNTs are higher than the perpendicular incidence, and (100) and (110) attributable to the hexagonal carbon ring structure that constitute the single-walled CNT are lower than the perpendicular incidence. Further, for the peak diffraction intensity of the X-ray diffraction spectrum of perpendicularly incidence, (CP) and (002) are lower than the parallel incidence and (100) and (110) are higher than the parallel incidence.

As described above, in the aligned single-walled CNT aggregate of the invention, the peak diffraction intensity at (CP) and (002) and the peak diffraction intensity at (100) and (110) change greatly when the incidence direction of X-rays changes. Since the diffraction intensity does not change depending on the incident direction of X-rays in a case of a completely isotropic (non-alignment) object, this shows that the aligned single-walled CNT aggregate of the invention has anisotropy, in other words, has a high alignment property.

Table 1 shows the result of comparing the intensity ratio for each of diffraction peaks depending on the incident direction of X-rays between the aligned single-walled CNT structure (aggregate) of the invention and the not-aligned CNT structure (aggregate).

TABLE 1

| | ALIGNED CNT | NOT-ALIGNED CNT |
|---|---|---|
| DIFFRACTION PEAK | STRUCTURE (Ip:In) | STRUCTURE (Ip:In) |
| (CP) | —2:1 | 1:1 |
| (002) | 9:1 | 1:1 |
| (100) | 1:4.5 | 1:1 |
| (110) | 1:3 | 1:1 |

Ip = diffraction peak intensity in the direction of parallel incidence
In = diffraction peak intensity in the direction of perpendicular incidence

### (2) Evaluation for Alignment Property by X-Ray Diffraction (Laue Method)

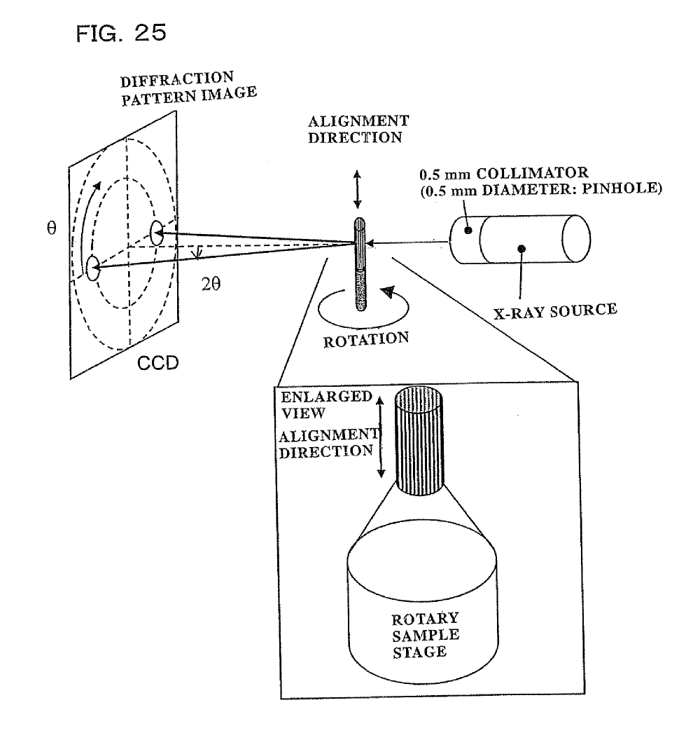

FIG. 25 shows a set up state of an X-ray diffraction apparatus by the Laue method. In the Laue method, a circular columnar sample of an aligned single-walled CNT aggregate is rotated on an axis parallel to the alignment direction, and X-rays passing through a pinhole collimator of 0.5 mm diameter are irradiated to the sample in the direction perpendicular to the alignment direction and refraction pattern images were focused on a CCD panel.

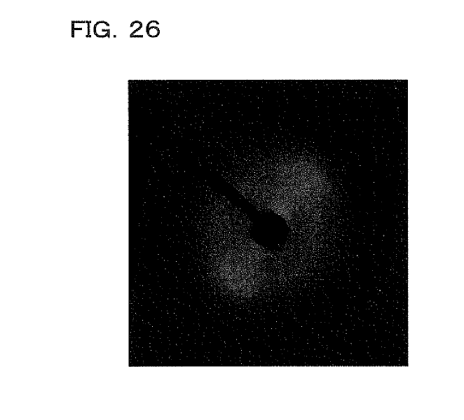

As a result, as shown in FIG. 26, pattern images for refraction peaks such as (CP), (002), (100) of a powdered aligned single-walled CNT aggregate according to the invention formed an elliptic shape. Since Laue diffraction pattern images of a completely isometric object form a perfect circular shape, this shows that the aligned single-walled CNT aggregate according to the invention has an anisotropy, that is, the aggregate is aligned.

### (3) Evaluation for Alignment Property by Fast Fourier Transformation Images.

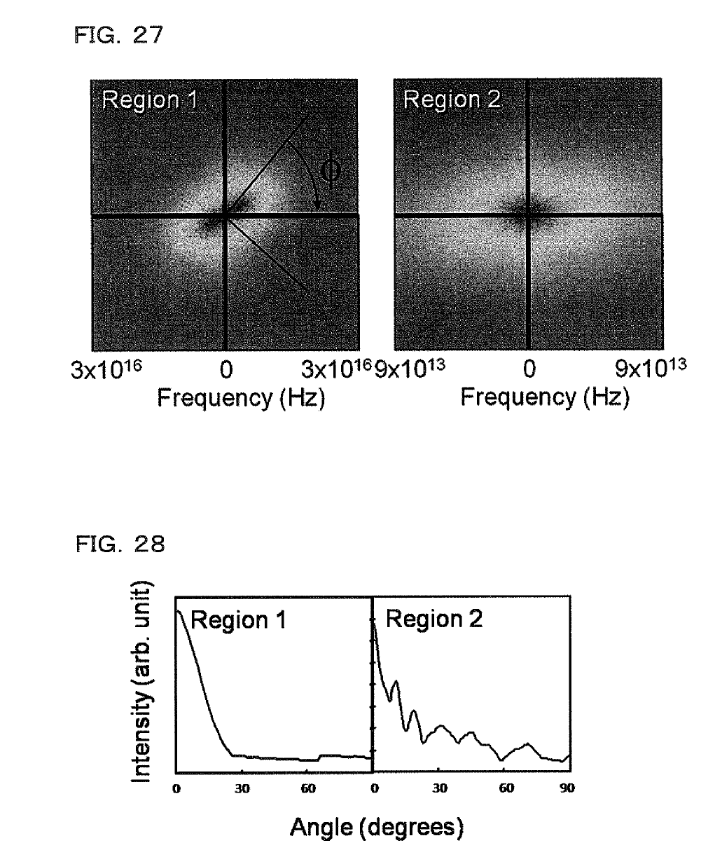

FIG. 27 shows fast fourier transformation (hereinafter also referred to as FFT) images of the scanning electron microscopic images in FIG. 5 of a powdered aligned single-walled CNT aggregate. In FIG. 27, the intensity of the FFT images is in flattened ellipsoidal shape having its longitudinal axis as abscissa axis. This shows that the alignment property is higher as the elongated shape is flattened more. FIG. 28 shows the diffraction intensity profile (φ) when varying from φ=0 (reference direction) to φ=π/2 by keeping the distance from the origin of the FFT images constant.

### (4) Evaluation for Alignment Property by Herman's Orientation Factor

The orientation factor of a single-walled CNT aggregate can be evaluated quantitatively calculating the Herman's orientation factor.

Herman's orientation factor F is defined by the following equation.

$$F ≡ \frac{1}{2} ( 3 〈 {cos}^{2} φ 〉 - 1 ) \\ 〈 {cos}^{2} φ 〉 = \frac{{\int }_{0}^{π / 2} I ( φ ) {cos}^{2} φ sin φ d φ}{{\int }_{0}^{π / 2} I ( φ ) sin φ d φ} \qquad [ Equation 1 ]$$

where φ is an azimuthal angle with φ=0 as a reference (standard) azimuth and I(φ) is a diffraction intensity profile. It is preferred that the reference direction is set as the alignment direction so that Herrman's orientation factor has a maximum value.

In the Herman's orientation factor, F=1 for complete alignment and F=0 for non-alignment in the direction: φ=0.

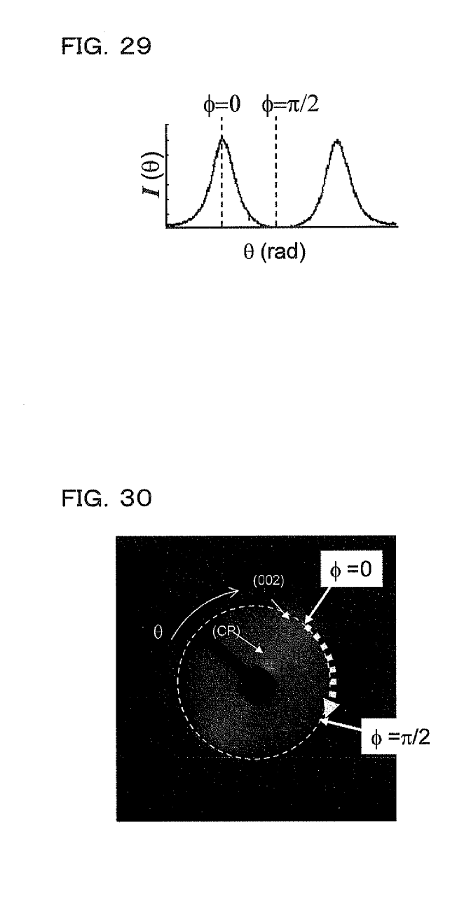

At first, the diffraction intensity profile I(φ) is determined. For this purpose, in a θ-2θ normal X-ray diffraction apparatus, the X-ray detector is fixed at an angle 2θ corresponding to a specific diffraction intensity, then the sample is rotated from angle θ (corresponding to an diffraction peak, defining φ=0) by an angle φ (refer to FIG. 21(b)). Thus, an X-ray diffraction intensity profile I(φ) as a function of φ is obtained (refer to FIG. 29).

The Herman's orientation factor F is determined by calculating equation described above using as a variable the X-ray diffraction intensity profile I(φ) from φ=0 to φ=π/2 excluding the background (zero base line). Thus, the alignment degree for the direction: φ=0 can be evaluated quantitatively.

In a case of determining the diffraction intensity profile I(φ) by the Laue method, the Herman's orientation factor F is determined by determining a diffraction intensity profile from the reference direction (φ=0) to φ=π/2 in the radial direction while keeping an equal distance from the original point in 2-dimensional diffraction pattern images (refer to FIG. 30), and calculating the equation described above. Thus, the alignment degree for the direction: φ=0 can be evaluated quantitatively.

The alignment property can be evaluated quantitatively also by calculating the Herman's orientation factor using the intensity profiles taken from the FFT images (FIG. 27) based on SEM images, etc. of an aligned single-walled CNT aggregate. In this case, the intensity profile is determined from the reference direction (φ=0) to φ=πE/2 in the radiation direction while keeping an equal distance from the center of FFT images, and this is defined as a diffraction intensity profile (FIG. 28). The reference direction is defined as the outermost peak of the elongation in the FFT image. The diffraction intensity profile shows the profile of the periodicity along the azimuthally path beginning from the outermost peak on the FFT image. The radial distance from the center corresponds to different length scales in real space. For example, the distance in real space corresponding to the distance of 30×10¹³ Hz from the center of FFT images is 100 nm. By calculating the equation described above using the diffraction intensity profile, the alignment degree in the reference direction can be evaluated quantitatively.

### [Weight Density]

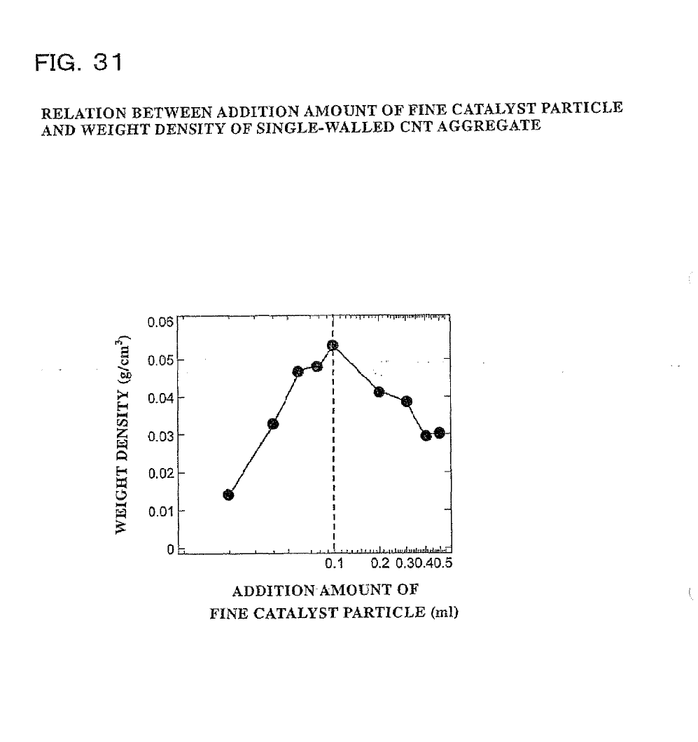

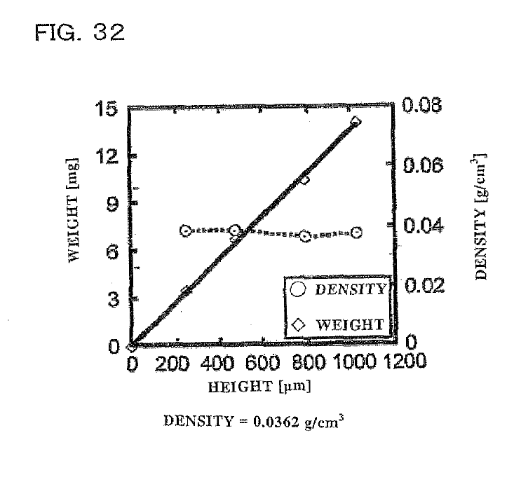

The weight density of the aligned single-walled CNT aggregate of the invention is from 0.002 to 0.2 g/cm³. The aligned single-walled CNT aggregate within such a range of the weight density is extremely excellent in the shape processability and can be processed into various shapes (this is to be described later specifically). The weight density can be controlled by conditioning the density and the kind of fine catalyst particles. By the way, FIG. 31 shows a relation between the addition amount of the fine catalyst particle in the aligned single-walled CNT aggregate produced under the conditions of Example 1 to be described later by using a fine iron nano-particle synthesized as a catalyst by the method described in the Journal of Chem. Mater., Vol. 13 (2001) p 1008 and the weight density of the aligned single-walled CNT aggregate. It can be seen that the weight density of the aligned single-walled CNT aggregate can be controlled by changing the addition amount of the fine catalyst particle.

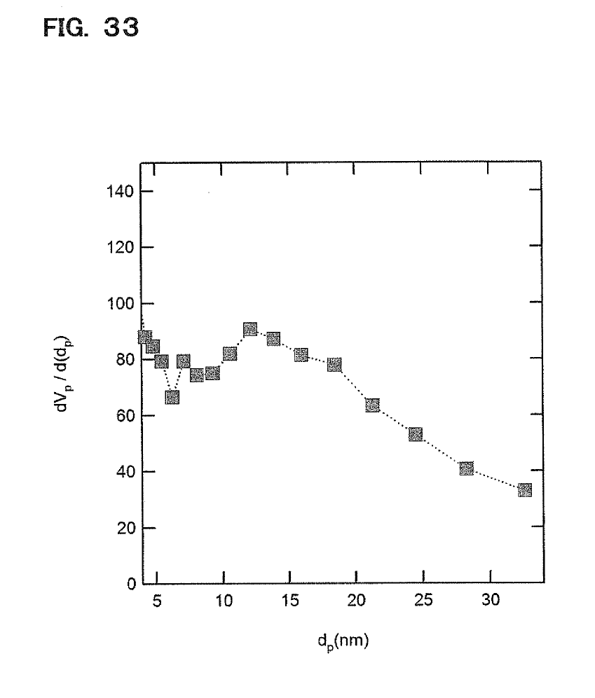

FIG. 32 shows an example of a relation between the growing height, and the weight and the density of the aligned single-walled CNT aggregate of the invention. It can be seen from the graph that the weight is increased in proportion to the growing height and the structure of the aligned single-walled CNT aggregate is homogeneous irrespective of the growing height. Then, assuming the weight density as the volume of the aligned single-walled CNT aggregate divided by the weight thereof, it can be seen that the weight density is substantially constant (0.036 g/cm³) irrespective of the growing height.

In a case where the weight density of the single-walled CNT aggregate is within a range from 0.002 g/cm³ to 0.2 g/cm³, adjacent CNTs can be filled with no gaps to each other at a high density as if in a case of a straw bag formed by bundling straws, by applying a density-increasing treatment after the formation. In this case, by controlling the density-increasing treatment step by utilizing a method, for example, described in the Nature Material, Vol. 5 (2006), p 987 to 994, the aligned single-walled CNT aggregate can be formed into various forms, for example, a film shape with high density.

Further, when the weight density is within the range described above, since bonding between CNTs to each other constituting the aligned single-walled CNT aggregate is not strengthened excessively, the aligned single-walled CNT aggregates can be easily dispersed homogeneously when they are stirred in a solvent or the like. In a case where the weight density exceeds 0.2 g/cm³, not only a homogeneous liquid dispersion is difficult to obtain but also the rigidity and the integrity of the aligned single-walled CNT aggregate become excessive making it difficult to form the same into various shapes by applying the density-increasing treatment after the formation. Further, in a case where the weight density is less than 0.002 g/cm³, since the aligned single-walled CNT aggregate loses the integrity and tends to be disintegrated, the shape processing becomes almost impossible.

A further reason that the aligned single-walled CNT aggregate of the invention has excellent shape processability is that the single-walled CNTs in the aligned single-walled CNT aggregate of the invention do not form an excessively large bundle and, as shown in FIG. 12, several to several tens of single-walled CNTs stand vertically closing to each other, adjacent single-walled CNTs are bonded extremely moderately to each other, and a nano-size gap (fine pore) is present between each of the single-walled CNTs. Since the nano-size gap (fine pore) is present between each of the single-walled CNTs, the weight density of the aligned single-walled CNT aggregate of the invention is lowered. Then, the fine pore between each of the single-walled CNTs not only facilitates the homogeneous dispersion described above but also enables the density-increasing treatment by the reduction of the fine pore size.

The nano-sized fine pore diameter between each of the single-walled CNTs can be determined based on the adsorption/desorption isothermal curve for liquid nitrogen at 77K. As the theoretical formula for determining the fine pore diameter distribution, a BJH method (refer to Journal of J. Amer. Chem. Soc. Vol. 73 (1951), p 373) assuming the fine pore as a cylindrical shape is used preferably. The fine pore diameter distribution defined in the present specification is determined according to the BJH method based on the adsorption/desorption isothermal curve for liquid nitrogen at 77K.

In order that the aligned single-walled CNT aggregate has excellent shape processability, it is preferred that the fine pore diameter determined according to the BJH method is mainly within a range of 5 nm or more and 100 nm or less. This shows that a population of gaps (fine pores) of 3 nm or more and 100 nm or less are present between single-walled CNTs adjacent to each other. In a case where the population of the gaps with the fine pore diameter of 5 nm or more is small, the bonding force between each of the single-walled CNTs is excessive not showing favorable dispersibility and, in addition, processing to various shapes by applying the density-increasing treatment becomes difficult. On the contrary, in a case where the population of gaps having the fine pore diameter of 100 nm or more is large, since the bonding force between each of the single walled CNTs is weak and the aligned single-walled CNT aggregate loses the integrity and tends to be disintegrated, the shape processing becomes almost impossible.

FIG. 33 shows the fine pore diameter distribution of the powdered aligned single-walled CNT aggregate obtained by peeling the aligned single-walled CNT aggregate produced by the method of Example 1 from a substrate. It can be seen from the view that the distribution maximum of the fine pore diameters is present at 13 nm and the fine pore diameters are distributed mainly within a range of 5 nm or more and 30 nm or less. The aligned single-walled CNT aggregate having such a fine pore diameter distribution has extremely excellent shape processability.

### [Production Apparatus for Aligned Single-Walled CNT Aggregate]

Known CVD method can be applied to the production of the aligned single-walled CNT aggregate according to the invention. A catalyst film is deposited on a base material, and a plurality of CNTs are grown by chemically vapor deposited (CVD) from the catalyst. The surface for forming the catalyst film is a surface or a space containing the catalyst on the substrate and this is generally a substrate surface in a case of a flat substrate.

The CNT production apparatus used for practicing the invention essentially has a synthesis furnace for accommodating a base material that supports the catalyst (reaction chamber) and heating means but the structure and the constitution for each of the portions are not particularly restricted and known CNT production apparatuses can be used. They include, for example, thermal CVD furnace, thermal heating furnace, electric furnace, drying furnace, thermostable bath, atmospheric furnace, gas substituted furnace, muffle furnace, oven, vacuum heating furnace, plasma reaction furnace, micro-plasma reaction furnace, RF plasma reaction furnace, electromagnetic wave heating reaction furnace, microwave irradiation reaction furnace, IR irradiation heating furnace, UV heating reaction furnace, MBE reaction furnace, MOCVD reaction furnace, and laser heating apparatus.

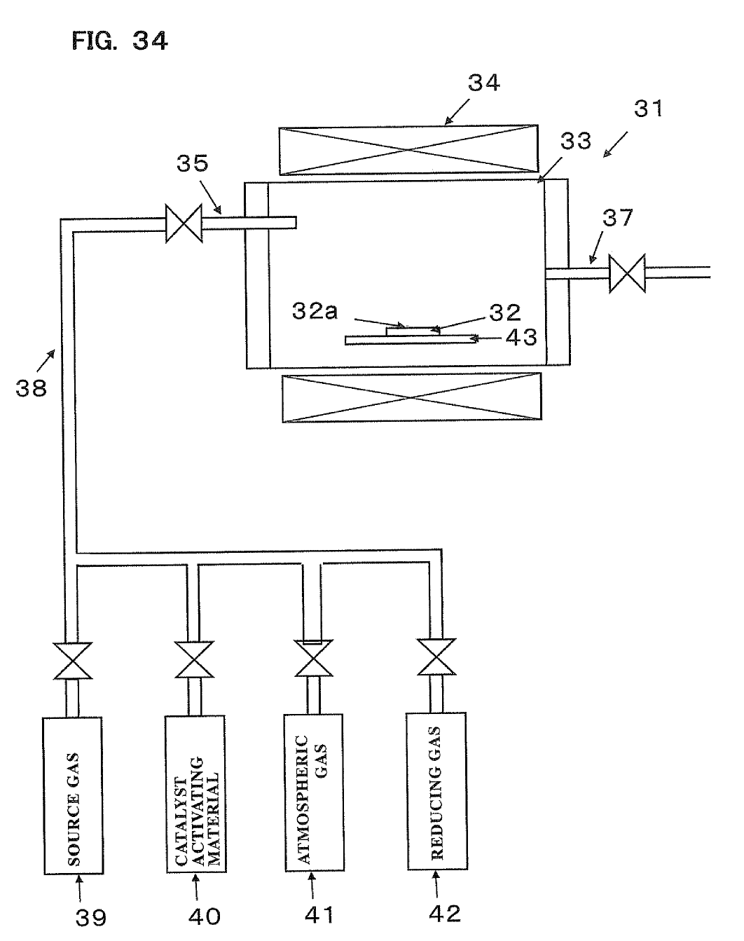

FIG. 34 shows an example of a CVD apparatus applied to the invention. A CVD apparatus 31 has a tubular synthesis furnace 33 made, for example, of quartz glass or heat resistant metal for accommodating a base material (substrate) 32 that supports the catalyst and appropriate heating means 34 comprising, for example, ohmic heat generation coils disposed so as to externally surround the synthesis furnace 33.

A gas supply pipe 35 opened to the inside of the synthesis furnace 33 is connected to one end wall of the synthesis furnace 33, and a gas exhaust pipe 37 opened to the inside of the synthesis furnace 33 is connected to the other end wall of the synthesis furnace 33. Then, a source gas (carbon source gas) supply portion 39, a catalyst activating material supply portion 40, an atmospheric gas supply portion 41, and a reducing gas supply portion 42 are connected by way of a joining-branching pipeline 38 to the gas supply pipe 35.

A substrate holder 43 for holding the substrate 32 having a catalyst film surface 32a is disposed at a lower position in the synthesis furnace 33.

Check valves, flow control valves, and flow sensors are disposed at appropriate positions to the gas supply pipe 35, the gas exhaust pipe 37, and each of the supply portions 39 to 42, and a source gas (carbon source gas), a catalyst activating material, an atmospheric gas, and a reducing gas are supplied each at a predetermined flow rate continuously or intermittently according to the reaction process from the gas supply pipe 35 to the inside of the synthesis furnace 33 by appropriate on-off control to each of the flow control valves by control signals from a not illustrated control device.

Another carrier gas supply portion (not illustrated in the drawing) is attached to the catalyst activating material supply portion 40, and the catalyst activating material is supplied together with a carrier gas, for example, helium. The constitution of the catalyst activating material supply portion 40 is not particularly restricted and it includes supply by using a carrier gas by way of a bubbler, supply by gasifying a solution containing the catalyst activating material, supply of a gas as it is, and supply by liquefying and gasifying a solid catalyst activating material. A supply system can be constructed by using various equipments such as a carburetor, a mixer, a stirrer, a dilution device, a spray device, a pump or a compressor.

For stably supplying a small amount of the catalyst activating substance at a high accuracy, a purifying device may be preferably attached for removing the ingredient of the catalyst activating substance from the source gas and the atmospheric gas. In this case, it may be desirable to provide the purifying device to the uppermost stream in a supply channel of the source gas and the atmospheric gas to the synthesis furnace 33 thereby removing the ingredient of the catalyst activating material, and adding a controlled amount of the catalyst activating material at the downstream of the purifying device to the source gas and the atmospheric gas. This method is effective in a case where a small amount of the ingredient of the catalyst activating material is contained in the source gas or the atmospheric gas.

Further, the catalyst activating material can be supplied stably with less change with time by providing a measuring device for the concentration of the catalyst activating material to the supply pipeline and the exhaust pipe of the source gas and the atmospheric gas and subjecting the flow control means of the catalyst activating material to feedback control by using the output value thereof.

The measuring device may be a device of measuring not only the concentration of the catalyst activating material but, for example, also the synthesis amount of CNT, or it may be a device of measuring by-products other than CNT such as amorphous carbon or graphite generated by the catalyst activating material.

According to the CVD apparatus 31 constructed as described above, each of the gases supplied by way of the joining-branching pipeline 38 can be sent from the opening of the gas supply pipe 35 to the inside of the synthesis furnace 33 and a plurality of CNTs can be grown substantially in one identical direction on the catalyst film surface 32a of the substrate 32.

### [Production Process of Aligned Single-Walled CNT Aggregate]

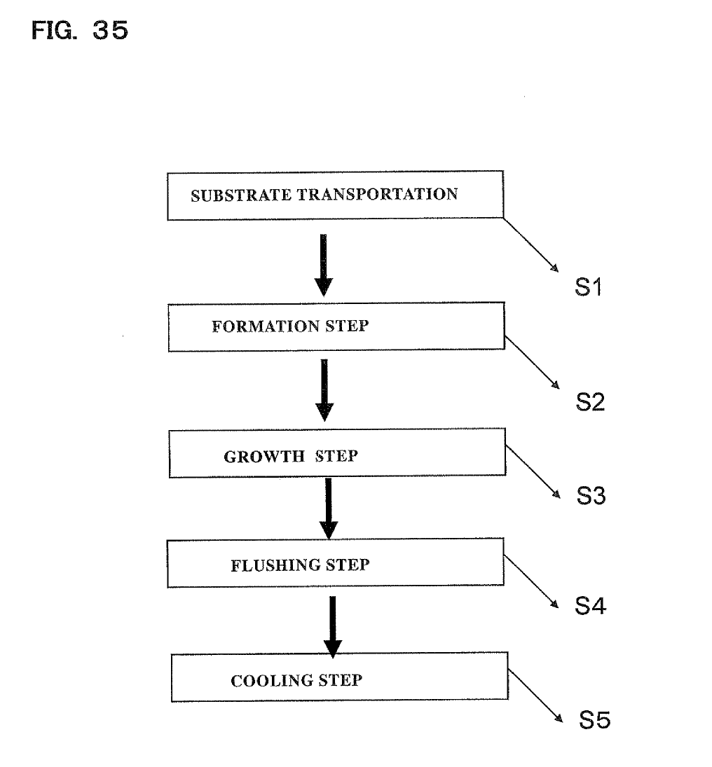

The method of producing an aligned CNT according to the invention is to be described specifically with reference to FIG. 35 as below. As shown in FIG. 35, a substrate 32 (for example, silicon wafer) which is previously deposited with a catalyst film (for example, thin aluminum-iron film) in a separate step and placed on a substrate holder 43 is transported into a synthetic furnace 33 which is filled with an atmospheric gas (for example, helium), a reducing gas (for example, hydrogen), etc. supplied from the gas supply pipe 35 (substrate transportation step S1), heated to a predetermined temperature (for example, 750° C.), and kept at that temperature.

Then, a reducing gas (for example, hydrogen) is supplied from the gas supply pipe 35 to the inside of the synthetic furnace 33 for a desired time (formation step S2). The fine catalyst particles on the catalyst film surface 32a are prepared to a state suitable to the growing of CNT by the reducing gas. By selecting an appropriate thickness for the metal catalyst film and reducing reaction conditions, fine catalyst particles of several nm diameter can be prepared to a density of 1.0×10¹⁰ (N/cm²) to 5.0×10¹³ (N/cm²). The density is suitable to the growing of a plurality of CNTs aligned in a direction perpendicular to the catalyst film surface 32a and production of aligned single-walled CNT aggregates at a weight density of 0.002 g/cm³ to 0.2 g/cm³. In the formation step S2, the catalyst activating material may be added optionally.

Then, supply of the reducing gas and the atmospheric gas from the gas supply pipe 35 is optionally stopped or decreased (according to reaction conditions), and a catalyst activating material (for example, steams) mixed in the atmospheric gas is supplied together with the source gas (for example, ethylene) from the gas supply pipe 35 on one side and brought into contact with the catalyst film surface 32a of the substrate 32 (growth step S3). Thus, CNT is grown from the fine catalyst particles on the substrate 32.

The plurality of CNTs grown simultaneously from the catalyst film surface 32a of the substrate 32 as described above are grown in the direction perpendicular to the catalyst film surface 32a to form aligned CNT aggregates substantially aligned with a fairly constant height.

After the end of the growth step, only the atmospheric gas is supplied into the synthesis furnace 33 thereby exhausting the remaining source gas or the catalyst activating material (flushing step S4) and then the substrate 32 is recovered from the inside of the synthesis furnace 33 (substrate taking out step S5), thereby completing a series of CNT production steps.

By separating the thus obtained aligned single-walled CNT aggregate from the substrate as a unit, a bulk aligned single-walled CNT aggregate is obtained. Further, separating the thus obtained aligned single-walled CNT aggregate as a powder, a powdered aligned single-walled CNT aggregate is obtained.

Since the structure and the property such as the average diameter, the full-width at half maximum, the height, crystallinity, and the purity of the CNT and the specific surface area, the weight density, and the alignment degree of the aligned CNT aggregate to be produced, and the growth efficiency such as the growth lifetime and the growth rate greatly depend on the base material, the catalyst, the CVD apparatus used for the production of CNT and the process conditions such as the temperature, the time, and the reducing gas in the formation step, and process conditions such as the temperature, the time, the source gas, the catalyst activating material, the atmospheric pressure, the atmospheric gas, and the carbon concentration in the growth step, for attaining desired growth of CNT and producing CNT of a desired structure and the property, it is necessary to appropriately select and set each of the production conditions.

Various conditions described above are to be detailed as below.

[Base Material (substrate)]

The base material (substrate) is a material capable of supporting a catalyst for growing CNT on the surface thereof and any appropriate material capable of maintaining a shape at a high temperature at least of 400° C. or higher can be used. Existent materials having performance in the production of CNT include metals such as iron, nickel, chromium, molybdenum, tungsten, titanium, aluminum, manganese, cobalt, copper, silver, gold, platinum, niobium, tantalum, lead, zinc, gallium, indium, germanium, arsenic, phosphorus, and antimony, as well as alloys and oxides containing such metals, or non-metals and ceramics such as silicon, quartz, magnesia, spinel, calcia, dolomite, chromia, zirconia, titania, mullite, glass, mica, graphite, alumina, magnesium oxide, potassium titanate, zirconium oxide, zeolite, silica, titanium oxide, and diamond and mixtures thereof. Compared with silicon or ceramics, metals are preferred since they are less expensive and, particularly, iron-chromium (Fe—Cr) alloy, iron-nickel (Fe—Ni) alloy, and iron-chromium-nickel (Fe—Cr—Ni) alloy, etc. are suitable to the practice of the invention.

For the shape of the base material, a plate shape is general and, in addition, thin film shape, block shape, powdery (granular) or linear (wire/rod/line) shape may also be used and, particularly, those shape capable of having large surface area with respect to the volume are advantageous in mass production. This invention is applicable also to flat particles (flaky or disc shape) or elongate particles (cylindrical, bar, or ribbon shape) in view of macro shape. Specifically, they include, for example, plate alumina, quartz flake, quartz fiber, ceramic fiber and fibrous titanium oxide. Particularly, granular shaped (powder/bead) base material or linear shaped (wire) base material is suitable as the base material since the catalyst can uniformly be coated easily and handled with ease and a large surface area can be available with respect to the volume. Further, aggregates, for example, of granular shaped base material (beads) or linear base materials, for example a mesh, having a thickness or size to some extent can take a large area for the catalyst film surface per planar area (area of surface defined by longitudinal and lateral directions of a space occupied by the base material) and can easily produce a great amount of aligned CNT aggregates compared with the flat plate-like base material. Further, the granular shaped base material can be applied to a fluidizing bed.

There is no particular restriction on the size of the base material in a case of using the granular shaped base material or the linear shaped base material as the substrate. However, since it is not easy to produce an aligned CNT aggregate of a height remarkably exceeding the average diameter of the base material, the average diameter of the substrate, that is, the granular shaped base material or the linear shaped base material is preferably 10 μm or more and 1 cm or less. In a case of using the granular shaped base material or the linear shaped base material having an average diameter within the range described above, an aligned CNT aggregate having a height of several tens μm or more can be produced. On the contrary, it is difficult to produce an aligned CNT aggregate having a height of several hundreds μm or more and diffusion of the source gas and the catalyst activating material between the base materials is inhibited in a case where the average diameter of the base material is less than 10 μm, and it is difficult to uniformly supply the source gas and the catalyst activating material over the entire surface of the base material in a case of supplying the source gas and the catalyst activating substance by using, for example, a shower head in a case where the average diameter of the base material exceeds 1 cm. Accordingly, it is difficult to produce the aligned CNT aggregate at a high efficiency in both of the cases.

### [Anti-Carburization Layer]

In the CNT growth step, an anti-carburizing layer is preferably formed on at least one of the surface and the rear face (preferably on both surfaces) of the base material as a protective layer for preventing deformation of the base material by carburization. The anti-carburization layer is preferably formed of a metal material or a ceramic material. The metal material includes, for example, copper and aluminum. The ceramic material includes oxides such as aluminum oxide, silicon oxide, zirconium oxide, magnesium oxide, titanium oxide, silica-alumina, chromium oxide, boron oxide, calcium oxide and zinc oxide, and nitrides such as aluminum nitride and silicon nitride. Among them, aluminum oxide and silicon oxide are particularly preferred because of high anti-carburization effect thereof.

### [Catalyst]

As the catalyst supported on the base material in the practice of the invention, any of existent materials having performance in the production of the CNT can be used and, specifically, they may be iron, nickel, cobalt, molybdenum, and chlorides and alloys thereof. Such materials may be further composited or stacked with aluminum, alumina, titania, titanium nitride or silicon oxide. Particularly preferred catalyst includes, for example, a thin iron-molybdenum film, a thin alumina-iron film, a thin alumina-cobalt film, a thin alumina-iron-molybdenum film, a thin aluminum-iron film, and a thin aluminum-iron-molybdenum film.

Since the element and the constitution of the catalyst give a significant effect on the density, the specific surface area, the average outer diameter, and the production yield of the CNT to be produced, appropriate selection of the catalyst is extremely important for producing a desired CNT. Particularly, iron or nickel-containing metal catalysts supported on alumina are suitable to the production of an aligned single-walled CNT aggregate having a specific surface area of 600 m²/g to 2600 m²/g, a weight density of from 0.002 g/cm³ to 0.2 g/cm³ and a Hermann's orientation factor of larger than 0 and smaller than 1.

The existent amount of the catalyst in the practice of the invention may be within a range having performance for the existent production of CNT. For example, in a case of using a thin metal film of iron or nickel, the thickness is preferably 0.1 nm or more and 100 nm or less, more preferably, 0.5 nm or more and 5 nm or less and, particularly preferably, 0.8 nm or more and 2 nm or less. Particularly, in a case where the thickness is 0.8 nm or more and 2 nm or less, an aligned single-walled CNT can be selectively synthesized, this is suitable to the production of an aligned CNT aggregate having a specific surface area of 600 m²/g to 2600 m²/g, a weight density of from 0.002 g/cm³ to 0.2 g/cm³ and a Hermann's orientation factor of greater than 0 and smaller than 1.

### [Catalyst Forming Method]

For the formation of the catalyst film surface to the surface of the base material, either a wet process or a dry process can be applied. Specifically, a sputtering vapor deposition method or a method of coating and baking a liquid in which fine metal particles are disposed in an appropriate solvent is applicable. Further, the catalyst layer can be formed into an optional shape by using, patterning that applies well-known photolithography or nano-imprinting in combination. The shape of the aligned single-walled CNT aggregate can be optionally controlled relatively easily, for example, as a film shape, a circular cylindrical shape, a square cylindrical shape and other complicate shapes depending on the patterning of the catalyst deposited on the base material and the growth time of CNT.

Particularly, in a thin film aligned single-walled CNT aggregate, while the lateral size (thickness) is small relative to the length and the height thereof, the longitudinal and the lateral sizes can be optionally controlled by the patterning of the catalyst and the size for the height can be optionally controlled depending on the growing time of each single-walled CNT that constitutes the aligned single-walled CNT aggregate. Such a thin film aligned single-walled CNT aggregate can be disposed on an optional substrate and this is suitable as a material for producing various kinds of devices.

### [Formation Step]

The formation step is a step of using a reducing gas for the surrounding circumstance of the catalyst supported on the base material and heating at least one of the catalyst or the reducing gas. The step provides at least one of the effects of reducing the catalyst, promoting fine particulation of the catalyst to a state suitable for the growth of CNT and improving the activity of the catalyst. For example, in a case where the catalyst is a thin alumina-iron film, the iron catalyst layer is reduced and finely particulated on an alumina layer to form a number of fine iron particles of nanometer size. The density of the fine iron particles in this step is conditioned to 1×10¹⁰ to 5×10¹³ N/cm². Single walled CNT can be grown from the thus conditioned catalyst at a probability of 80% or more. It is of course possible to reduce the probability to 80% or less, for example, by conditioning the amount of the water content. In a case where the catalyst density is 1×10¹⁰ N/cm² or less, the density of the grown single-walled CNT is low making it difficult to form the aligned single-walled CNT aggregate. On the contrary, in a case where the catalyst density is 5×10¹³ N/cm³ or more, the distance between the catalysts is excessively decreased tending to fuse the catalyst to each other and, in addition, the density of the grown single-walled CNT becomes excessive making it difficult to diffuse the gas between each of the single-walled CNTs.

By way of the formation step, the catalyst is prepared to a state suitable to the production of the aligned CNT aggregate, which provides a remarkable effect for selectively producing a single-walled CNT, as well as in view for producing an aligned CNT aggregate having a specific surface area of from 600 m²/g to 2600 m²/g, a weight density of from 0.002 g/cm³ to 0.2 g/cm³ and a Hermann's orientation factor of larger than 0 and smaller than 1.

### [Growth Step]

The growth step is a step of growing CNT on the surface of the catalyst by providing a source gas to the surrounding circumstance of the catalyst and heating at least one of the catalyst and the source gas. The growth step applied after the formation step is suitable to the production of the aligned CNT aggregate.

### [Cooling Step]

The cooling step is a step of cooling the aligned CNT aggregate, the catalyst, and the base material after the growth step. Since the aligned CNT aggregate, the catalyst, and the base material after the growth step are in a high temperature state, they may possibly be oxidized when placed under the circumstance where oxygen is present. For preventing oxidation, the aligned CNT aggregate, the catalyst, and the base material are cooled to 400° C. or lower and, more preferably, 200° C. or lower in a cooling gas circumstance. As the cooling gas, an inert gas is preferred and nitrogen is particularly preferred with a view point of safety, economicity, and purging performance.

### [Reducing Gas]

The reducing gas used in the formation step is a gas having at least one of the effects of reducing the catalyst, promoting fine particulation of the catalyst to a state suitable to the growing of the CNT, and improving the catalytic activity. For the reducing gas used in the practice of the invention, any reducing gas may be used so long as it is a reducing gas having performance in the existent production of CNT and, for example, hydrogen, ammonia, steams, and a gas mixture thereof may be applied. Further, a gas mixture of hydrogen mixed with an inert gas such as helium, argon or nitrogen may also be used. Further, the reducing gas may be used not only in the formation step but also properly in the growth step.

### [Atmospheric Gas]

As the atmospheric gas (carrier gas) in CVD, any gas may be used which is inert at a growing temperature of CNT and not reactive with a growing CNT and any atmospheric gas can be used properly as long as it has performance in the existent production of CNT. Generally, an inert gas is preferred and includes, for example, helium, argon, hydrogen, nitrogen, neon, krypton, carbon dioxide, or chlorine, or a gas mixture thereof. Nitrogen, helium, argon, hydrogen, and a gas mixture thereof are particularly preferred.

### [Source Gas]

The source gas (carbon source gas) used for the production of CNT in the practice of the invention may be any material so long as it has performance in the existent production of CNT and appropriate gaseous material containing carbon at a growing temperature can be used.

The source gas can include, for example, gaseous carbon compounds such as aromatic compounds, saturated hydrocarbons, unsaturated hydrocarbon, unsaturated linear hydrocarbons, saturated linear hydrocarbons, unsaturated cyclic hydrocarbons, and saturated cyclic hydrocarbons. Among them, hydrocarbons such as methane, ethane, propane, butane, pentane, hexane, heptane, propylene, ethylene, butadiene, polyacetylene, and acetylene are suitable. In addition, oxygen-containing compounds with less numbers of carbon atoms, for example, lower alcohols such as methanol and ethanol, acetone, or carbon monoxide may also be used. Further, a mixture of them may also be used. The source gas may be diluted with an inert gas. CNT is formed on the catalyst surface when the source gas is brought into contact with the catalyst in the growth step.

### [Atmospheric Pressure]

The pressure of the atmosphere for growing CNT is preferably 10⁴ Pa or higher and 10⁵ Pa or lower (100 atm), more preferably, 5×10⁴ Pa or higher and 2×10⁵ Pa or lower (2 atm) and, particularly preferably, 9×10⁴ Pa or higher and 1.1×10⁵ Pa or lower. The CNT production efficiency is extremely favorable at an atmospheric pressure or a pressure close to the atmospheric pressure between 9×10⁴ Pa or higher and 1.1×10⁵ Pa, without using vacuum or high pressure. Further, since the open system production apparatus not using a shutter or a valve can be used, this is preferred also with a view point of mass production.

### [Addition of Catalyst Activating Material]

In the CNT growth step, the catalyst activating material is added preferably. Addition of the catalyst activating material can extend the life and improve the activity of the catalyst and, as a result, can promote improvement of the production efficiency and of the purity of CNT. Due to the effect of improving the activity of the catalyst and extending the catalyst life (catalyst activation effect) by the addition of the catalyst activating material, growing of CNT, which was completed only in about 2 min can be continued for several tens minutes and, in addition, the growth rate is increased to 100 times or more and, further, 1000 times or more compared with the existent case. As a result, an aligned CNT aggregate remarkably increased in height can be obtained. This is one of the technical features of the invention to produce CNT with high efficiency by using the catalyst activating material.

The catalyst activating material used herein may be any material so long as it is a material containing oxygen or sulfur or both and not giving remarkable damage on CNT at a growing temperature and effective material include, steams, oxygen, ozone, acidic gas, oxygen-containing compounds with less number of carbon atoms such as nitrogen oxides, carbon monoxide, and carbon dioxide, or alcohols such as ethanol, methanol, and isopropanol, ethers such as tetrahydrofuran, ketones such as acetone, aldehydes, acids, salts, amides, esters, as well as mixtures thereof. Among them, steams, oxygen, carbon dioxide, carbon monoxide, ethers, and alcohols are preferred. Particularly, easily available steams are suitable.

### [Mechanism of the Effect of Catalyst Activating Material]

At present, the mechanism of the effect of the catalyst activating material is considered as below. In the CNT growing process, amorphous carbon, graphite, etc. are formed additionally and, when they are deposited to the catalyst, the catalyst is deactivated to hinder the growing of CNT. However, when the catalyst activating material is present, since the by-products such as amorphous carbon or graphite that may deactivate the catalyst are oxidized by the catalyst activating material and gasified into carbon monoxide or carbon dioxide, the catalyst is cleaned. It is considered that the catalyst activity is enhanced and the catalyst life is extended as a result. That is, the catalyst activating material may be any material having the function described above and includes, those oxidative materials, for example, containing the group VI element such as sulfur in addition to the oxygen-containing materials.

### [Amount of the Supplying Catalyst Activating Material]

There is an optimum value for the addition amount of the catalyst activating material. That is, in a case where the addition amount of the catalyst activating material is excessive, the excess catalyst activating material lowers the growth efficiency. On the contrary, in a case where the addition amount is insufficient, the effect of the catalyst activating material cannot be provided sufficiently. For improving the production efficiency of CNT, the ratio between the number concentration of carbon atoms contained in the source material and the number concentration of oxygen contained in the catalyst activating material is one of the most important factors. The optimum ratio between the number concentration of the carbon atoms and the number concentration of the oxygen atoms is different depending on the temperature in the growth step, the catalyst activating material and the source material to be used, and the catalyst to be used and, generally, it is preferably 0.5 or more and 2000 or less in terms of the ratio between the number concentration of the carbon atoms contained in the source gas and the number concentration of the oxygen atoms contained in the catalyst activating substance which are introduced into the synthesis furnace.

Further, the ratio between the number concentration of the carbon atoms contained in the source gas and the number concentration of the oxygen atoms contained in the catalyst activating material can be calculated as: {(concentration of source gas introduced)×(number of carbon atoms contained in the source gas)} divided by {(concentration of introduced catalyst activating substance)×(number of oxygen contained in the catalyst activating material)}. The concentration of the source gas and the catalyst activating material to be introduced means a ratio of the flow rate of the source gas and the catalyst activating material relative to the total flow rate of the gases supplied to the inside of the synthetic furnace by way of a supply pipe and that contact with the catalyst.

In the case where the ratio between the number concentration of the carbon atoms and the number concentration of the oxygen atoms is less than 0.5, the catalyst activity is lowered due to excess oxygen to inhibit production of CNT. On the contrary, in a case where the ratio between the number concentration of the carbon atoms and the number concentration of the oxygen atoms is 2000 or more, the effect of the catalyst activating material cannot be provided sufficiently due to insufficiency of oxygen. In a case where the ratio between the number concentration of the carbon atoms and the number concentration of the oxygen atoms is within a range from 0.5 to 2000, CNT can be produced at high efficiency and an aligned CNT aggregate having both large size and high specific surface area can be produced efficiently.

Further, in a case where the ratio between the number concentration of the carbon atoms and the number concentration of the oxygen atoms is within a range from 0.5 to 100, even when the catalyst activating material is in contact with the carbon impurities, the base material or the like and consumed somewhat, since a sufficient amount of the catalyst activating material remains and can be supplied at an amount close to the optimal amount stably and uniformly to the catalyst, this is suitable to the stable and uniform growing of the aligned single-walled CNT aggregate.

Summarizing the above, it is suitable, in order to attain the stable and uniform growing of an aligned single-walled CNT aggregate, to select the combination of the source gas and the catalyst activating material such that the ratio between the number concentration of the carbon atoms and the number concentration of the oxygen atoms is within a range from 0.5 to 100 upon adding an optimal catalyst activating material into the synthesis furnace.

In order that the ratio between the number concentration of the carbon atoms and the number concentration of the oxygen atoms is kept within the range from 0.5 to 100, it is preferred to use an efficient source gas thereby decreasing the amount of the source gas necessary for producing a desired amount of CNT, as well as it is preferred to use a catalyst activating material of poor efficiency to increase the optimal amount of the catalyst activating material.

The catalyst activating material of poor efficiency referred to herein means a catalyst activating material having a poor efficiency for increasing the catalyst activity and extending the life described above.

That is, since the effect of improving the catalyst activity and extending the life of the catalyst activating material of poor efficiency cannot be developed sufficiently unless it is added in a greater amount compared with the catalyst activating material of good efficiency, it is necessary to increase the number concentration of the oxygen atoms in the synthetic furnace for supplying an optimal catalyst activating material.

Further, for the catalyst activating material of poor efficiency, more stable materials are preferred and they include, for example, carbon dioxide, acetone, tetrahydrofuran, and ethanol. Further, the catalyst activating materials of high efficiency include, for example, water content.

### [Means to Keep the Catalyst Activation by the Catalyst Activating Material]

Means to keep the catalyst activation by the catalyst activating material that activates the catalyst and enables stable and uniform growing of an aligned single-walled CNT aggregate includes, for example, use of an efficient source gas thereby decreasing the amount of the source gas necessary for producing the desired amount of CNT, use of a catalyst activation material of poor efficiency thereby increasing the optimal amount of the catalyst activating material to condition the ratio between the number concentration of the carbon atoms and the number concentration of the oxygen atoms within a range from 0.5 to 100.

With a such a constitution, even when the catalyst activating material is in contact with carbon impurity, base material or the like and consumed somewhat, since a sufficient amount of the catalyst activating material remains and can be supplied stably and uniformly by an amount close to the optimal amount to the catalyst, this is suitable to the uniform and stable growing of the aligned single-walled CNT aggregate.

### [Effect of Catalyst Activating Material]

The structures and the property, for example, the average outer diameter, the full-width at half maximum, the specific surface area, the crystallinity, and the purity of the CNT, and the density, the height, and the alignment property of the aligned CNT aggregate to be produced are changed, as well as the growth efficiency such as the growth lifetime and the growth rate are changed depending on the combination of the source material and the catalyst activating material. Accordingly, an aligned CNT aggregate having a desired structure and a property can be produced by selecting and setting an appropriate combination for the source material and the catalyst activating material. This can provide a remarkable effect for producing an aligned CNT aggregate having a specific surface area of 600 m²/g to 2600 m²/g, a weight density of 0.002 g/cm³ to 0.2 g/cm³, and a Hermann's orientation factor of larger than 0 and smaller than 1.

### [Condition for Catalyst Activating Material and Source Material]

In the production of a CNT by using the catalyst activating material and the source material in the growth step, it is important to satisfy the following two conditions for producing the CNT at a high efficiency. That is, (1) the source material contains no oxygen and (2) the catalyst activating material contains oxygen.

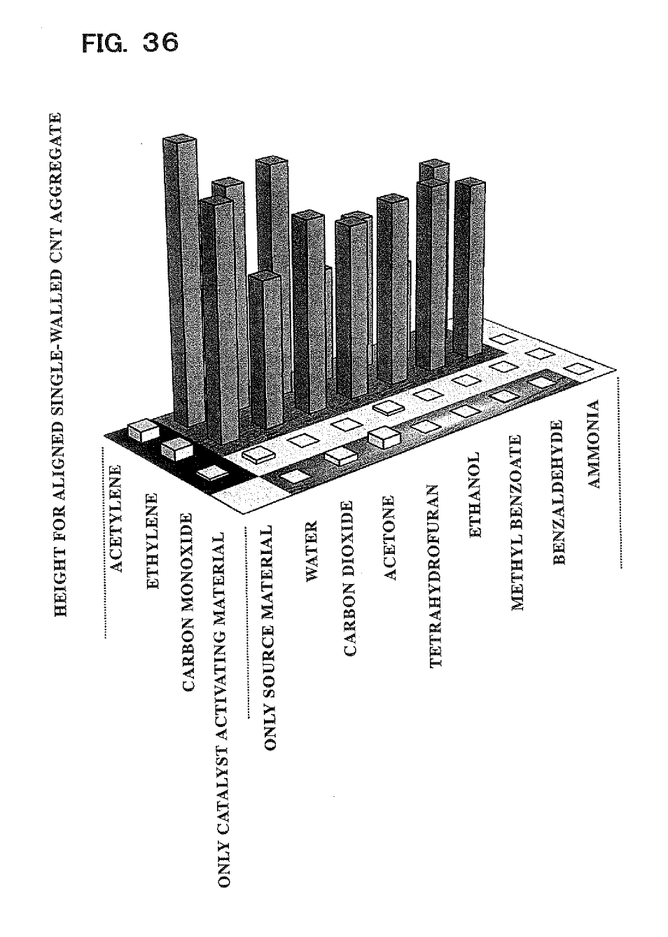

FIG. 36 shows the height of formed aligned CNT aggregates (growth efficiency) for verifying the two conditions described above in a case of producing CNTs in 24 types of combinations, including three kinds of source materials, that is, two kinds of source materials not containing oxygen (acetylene and ethylene) and one kind of source material containing oxygen (carbon monoxide), and eight kinds of catalyst activating materials in total, that is, seven kinds of catalyst activating materials containing oxygen (water, carbon dioxide, acetone as ketons, tetrahydrofuran as ethers, ethanol as alcohols, methyl benzoate as esters, and benzaldehyde as aldehydes), and one kind of material not containing oxygen (ammonia) being assumed as the catalyst activating material, as well as in three types of combinations by only using the source material. Production conditions for the aligned CNT aggregate upon carrying out the verification is to be detailed later.

According to this, it can be seen that while CNT can be produced in a case of using only the source material but not using the catalyst activating material, the height of the aligned CNT aggregate is small and CNT cannot be produced at a high efficiency. This shows that the catalyst activating material is extremely important for efficient production of CNT.

Further, CNT cannot be produced at a high efficiency in a case of adding ammonia not containing oxygen, whereas CNT can be produced at a high efficiency in a case of adding 7 kinds of materials containing oxygen. This shows that it is necessary for the catalyst activating material to contain oxygen.

In the case of using the source material containing both carbon and oxygen (carbon monoxide), while the CNT can be produced irrespective of the kind of the catalyst activating material, aligned CNT aggregate having a large height cannot be produced.

On the contrary, it has been found that aligned single-walled CNT aggregates having large height can be produced in any of 14 types of combinations using the source materials containing carbon and not containing oxygen (acetylene, ethylene) and the catalyst activating materials containing oxygen (water, carbon dioxide, acetone, tetrahydrofuran, ethanol, methyl benzoate, benzaldehyde). That is, it has been shown that CNT can be produced at a high efficiency by the combination of the source materials and the catalyst activating materials capable of satisfying the two conditions. Further, in a case of satisfying the two conditions, it has been shown that the supply amount for oxygen and carbon can be optimized individually showing that CNT can be produced at high efficiency.

### [Reaction Temperature]

The reaction temperature for growing a CNT is determined properly while considering the metal catalyst, the starting carbon source, the reaction pressure, etc. In a case of including the step of adding the catalyst activating material for eliminating by-products which may deactivate the catalyst, the temperature is preferably set to such a range as capable of sufficiently developing the effect thereof. That is, a most preferred temperature range is determined by defining a temperature at which the catalyst activating material can remove the by-products such as amorphous carbon or graphite as a lower limit and defining a temperature at which the main product CNT is not oxidized by the catalyst activating material as an upper limit. Specifically, in a case of using water as the catalyst activating material, it is defined preferably as from 400° C. to 1000° C. At a temperature of 400° C. or lower, the effect of the catalyst activating material is not developed. At a temperature of 1000° C. or higher, the catalyst activating material reacts with CNT. Further, in a case of using carbon dioxide as the catalyst activating material, the temperature is more preferably from 400° C. to 1100° C. or lower. At a temperature of 400° C. or lower, the effect of the catalyst activating material is not developed. At a temperature of 1100° C. or higher, the catalyst activating material reacts with CNT.

### [High Carbon Concentration Circumstance]

The growth rate of a CNT is in proportion to the number of carbon atoms contained in the source gas in contact with the catalyst. That is, since the growth rate is higher as the ratio of the source gas to the entire flow rate (source material concentration) is higher, it can be said that the production efficiency of the CNT is improved. On the contrary, in the production process for a CNT by the existent CVD method by only using the source gas but not using the catalyst activating material, carbonaceous impurities generated in the CNT growth step are increased with increase of the carbon concentration (source material concentration). Since they cover the fine catalyst particles to deactivate the catalyst, CNTs have been produced in such a growth atmosphere that the ratio of the source material to the entire flow rate is about 0.1 to 1% (low carbon concentration circumstance). Consequently, production efficiency of CNT cannot be improved as expected.

According to the production method of the invention of adding the catalyst activating material, since the catalyst activity is improved remarkably under the presence of the catalyst activating material, the catalyst activity is not lost and the CNT can be grown for a long time even at a source material concentration of about 2 to 20% where the ratio of the source gas to the entire flow rate exceeds 1% (high carbon concentration circumstance). Under the high carbon concentration circumstance, the growth rate of the CNT is improved remarkably and this is suitable to the production of an aligned CNT aggregate having a specific surface area of 600 m²/g to 2,600 m²/g, a weight density of 0.002 g/cm³ to 0.2 g/cm³, and a Hermann's orientation factor of larger than 0 and smaller than 1.

That is, production of a CNT, particularly, a single-walled CNT, and an aligned CNT aggregate having a high specific surface area under a high carbon concentration circumstance has been enabled, for the first time, by the present invention of adding the catalyst activating material.

### Example 1

### Production by Substrate 1

An aligned single-walled CNT aggregate according to the invention will be described in details with reference to specific examples. The property of the aligned single-walled CNT aggregate produced by this example depends on production conditions. In the production conditions of Example 1 to be described below, typical values are 0.03 g/cm³ for the density, 1200 m²/g for the BET-specific surface area, 10 for G/D, 2.5 nm for the average outer diameter, 2 nm for the full-width at half maximum, 99.9% for the carbon purity, and 0.8 for the Hermann's orientation factor.

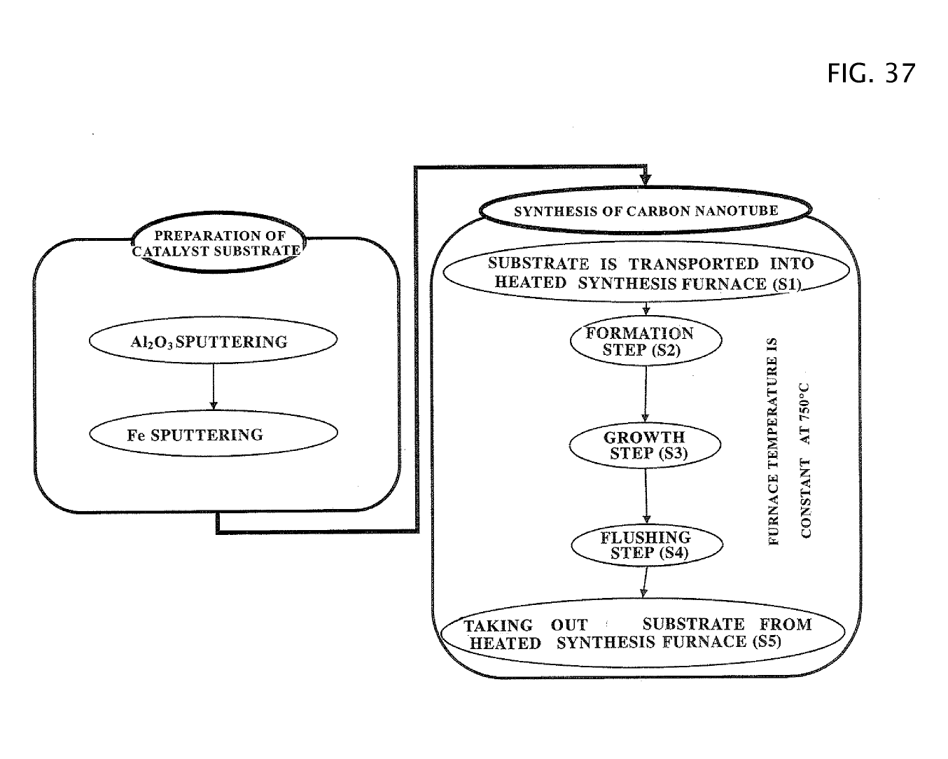

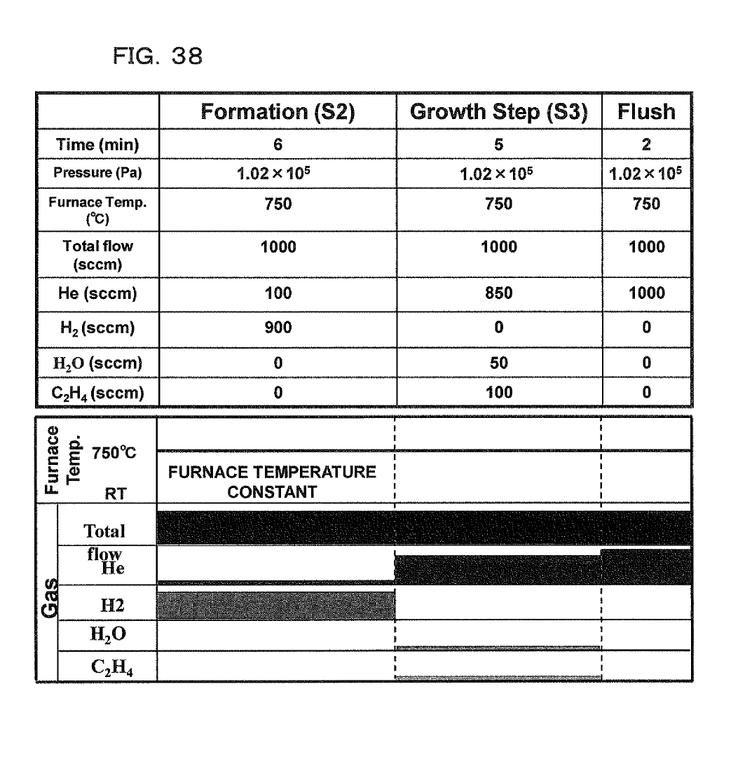

The production step according to this example includes, as shown in the flow chart of FIG. 37, a preparation step for a catalyst substrate and a synthesis step for a single-walled CNT. The preparation step for the catalyst substrate includes a step of forming a co-catalyst layer of 40 nm thickness comprising alumina (Al₂O₃) on a silicon substrate by RF sputtering and forming a catalyst layer of 1 nm thickness comprising iron (Fe) on the alumina layer by sputtering. Detailed process conditions are shown in FIG. 38.

In a case of producing a patterned aligned single-walled CNT aggregate, a resist for electron beam exposure (ZEP-520A/produced by Zeon Corporation) is thinly coated first by using a spin coater on a silicon substrate formed previously with a co-catalyst layer (4700 rpm/60 sec) and baked (200° C./3 min). Then, for example, circular patterns each of 150 μm diameter are drawn each at an interval of 250 μm on the substrate coated with the resist by using an electron beam exposure apparatus.

Then, alumina and iron are vapor deposited by using a sputtering vapor deposition apparatus and, finally, the resist is peeled from the substrate by using a peeling liquid (ZD-MAC/produced by Zeon Corporation). By way of the steps, a silicon substrate formed with a catalyst metal layer patterned in an optional shape, for example, a circular shape can be obtained. In a case of not applying the patterning, alumina and iron are vapor deposited directly on the substrate by using of a sputtering vapor deposition apparatus.

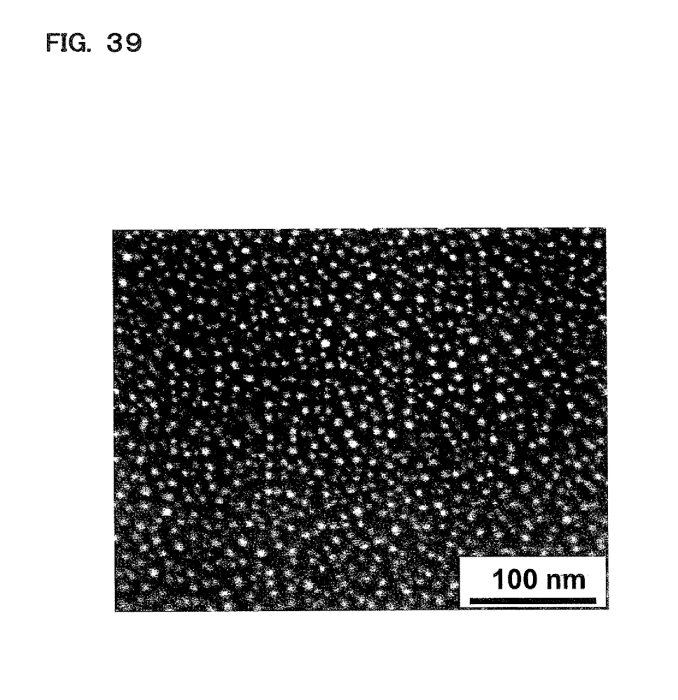

The substrate 32 is transported and installed in a synthetic furnace 33 of the CVD apparatus 31 (FIG. 34) kept at a furnace temperature of 750° C. and at a furnace pressure of 1.02×10⁵ Pa (substrate transporting step S1), and 100 sccm of He (atmospheric gas) and 900 sccm of H₂ (reducing gas) are introduced from the gas supply pipe 35 into the furnace for 6 min. Thus, the iron catalyst layer is reduced, to promote fine particulation in a state suitable to the growing of the single-walled CNT, and a plurality of fine iron particles of nanometer size are formed on the alumina layer (formation step S2). The density of the fine iron particles in this step is 1×10¹⁰ to 5×10^{—}N/cm³. The density of the fine iron particles can be controlled, for example, by the time in the formation step, etc. The density of the fine iron particles can be estimated by measuring the number of fine particles observed for the image of a scanning electron microscope at a magnification factor of 100,000× or more as shown in FIG. 39. The density of the catalyst measured by using the image of FIG. 39, etc. is 6.2×10¹¹ N/cm².

Then, 850 sccm of He (atmospheric gas), 100 sccm of C₂H₄ (source gas), and 50 sccm of H₂O-containing He (relative humidity: 23%) (catalyst activating material mixed in the carrier gas) are supplied for 5 min from the gas supply pipe 35 into the synthesis furnace 33 in a state kept at a furnace temperature at 750° C. and at a furnace pressure of 1.02×10⁵ Pa (atmospheric pressure). Thus, a single-walled CNT is grown from each of the fine iron catalyst particles under the high carbon concentration circumstance (growth step S3 under high carbon circumstance) to obtain an aligned single-walled CNT aggregate.

Under the conditions in this example, single-walled CNTs are grown at a probability of 80% or more from the fine catalyst particles prepared to the state described above. The growing probability of the single-walled CNT can of course be decreased to 80% or lower, for example, by conditioning the amount of the water content. As described above, single-walled CNTs can be formed selectively to suitably produce an aligned CNT aggregate having a specific surface area of from 600 m²/g to 2,600 m²/g, a weight density of from 0.002 g/cm³ to 0.2 g/cm³, and a Hermann's orientation factor of greater than 0 and smaller than 1.

After the completion of the growth step, only He is supplied by 1000 sccm into the synthesis furnace 33 and the remaining source gas and the catalyst activating agent are removed (flushing step S4) and, subsequently, the substrate is cooled to 400° C. or lower and then the substrate is taken out from the synthesis furnace 33 (substrate taking out step S5), thereby completing a series of production steps for the aligned single-walled CNT aggregate.

In a case where the pressure in the growth step is 5×10⁴ Pa or lower and 2×10⁵ Pa or higher (2 atm), the production efficiency for the aligned CNT aggregate is lowered and the aligned CNT aggregate can not be produced efficiently.

### Example 2

### Production by Substrate 2

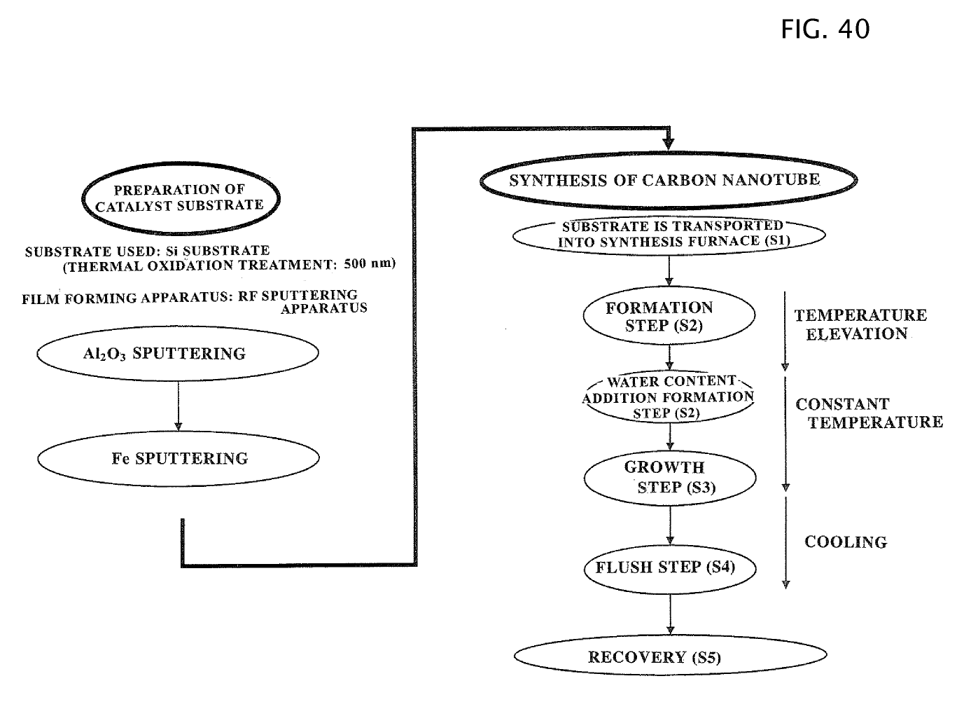

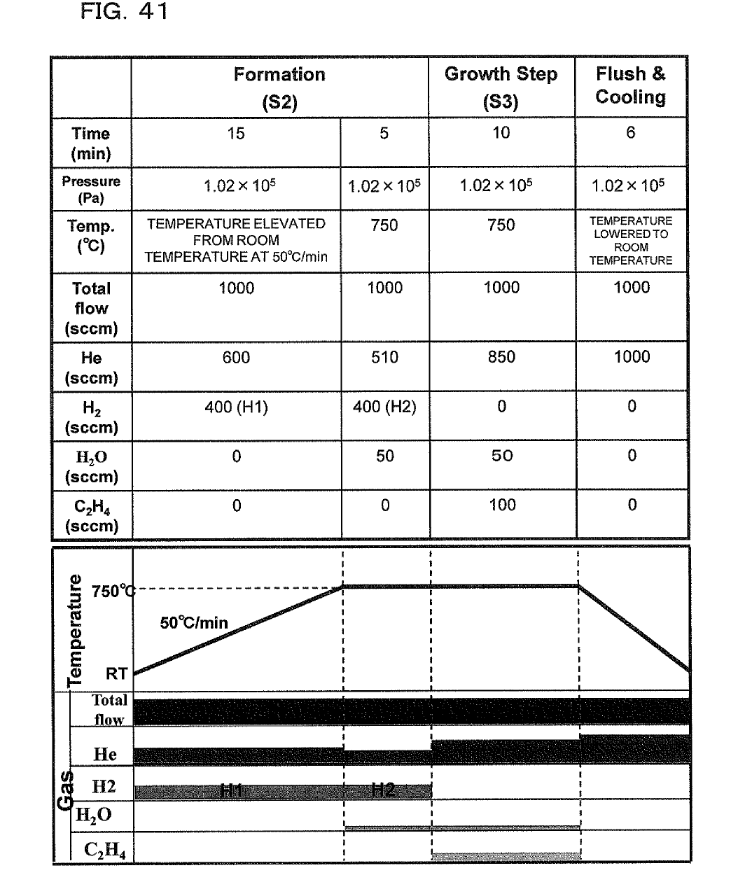

Another method of producing an aligned single-walled CNT aggregate according to the invention (Example 2) is to be described below. FIG. 40 shows a flow chart for the production step according to this example and detailed process conditions are shown in FIG. 41.

A silicon substrate 32 vapor deposited with the same catalyst metal (Al₂O₃+Fe) as in Example 1 is provided and the substrate 32 is transported and installed in the synthesis furnace 33 of the CVD apparatus 31 kept at a room temperature for the furnace room temperature and at of 1.02×10⁵ Pa for the furnace pressure (substrate transporting step S21), at 600 sccm of He (atmospheric gas) and 400 sccm of H₂ (reducing gas) are introduced into the furnace and the furnace temperature is elevated at a temperature elevation rate of 50° C./min for 15 min (formation step S2). That is, a significant difference between this example and Example 1 described above is elevation of temperature in the furnace after installing the substrate.

Then, 510 sccm of He (atmospheric gas), 400 sccm of H₂ (reducing gas) and, further, 90 sccm of H₂O-containing He (relative humidity: 23%) (catalyst activating material mixed in carrier gas) are supplied to the synthesis furnace 33 in a state kept at a furnace temperature of 750° C. and at a furnace pressure of 1.02×10⁵ Pa (water content addition formation step S2). The treating time is 5 min. Thus, the iron catalyst layer is reduced in the same manner as in Example 1 and a number of fine particles of nanometer size are formed on the alumina layer. The density of the catalyst is 9×10¹¹ N/cm².

Then, 850 sccm of He (atmospheric gas), 100 sccm of C₂H₄ (source gas), and 50 sccm of H₂O-containing He (relative humidity: 23%) (catalyst activating material mixed in carrier gas) are supplied to the synthesis furnace 33 in a state kept at a furnace temperature of 750° C. and at a furnace pressure of 1.02×10⁵ Pa (growth step under high carbon concentration circumstance S3). The treating time is 10 min. Thus, a single-walled CNT is grown from each of the fine iron catalyst particles.

After the completion of the growth step, only He is supplied by 1000 sccm into the reaction furnace and the remaining source gas and the catalyst activating agent are removed (flushing step S4) and then the substrate 32 is taken out from the synthesis furnace 33 (substrate taking out step S5), thereby completing a series of production steps for the aligned single-walled CNT aggregate.

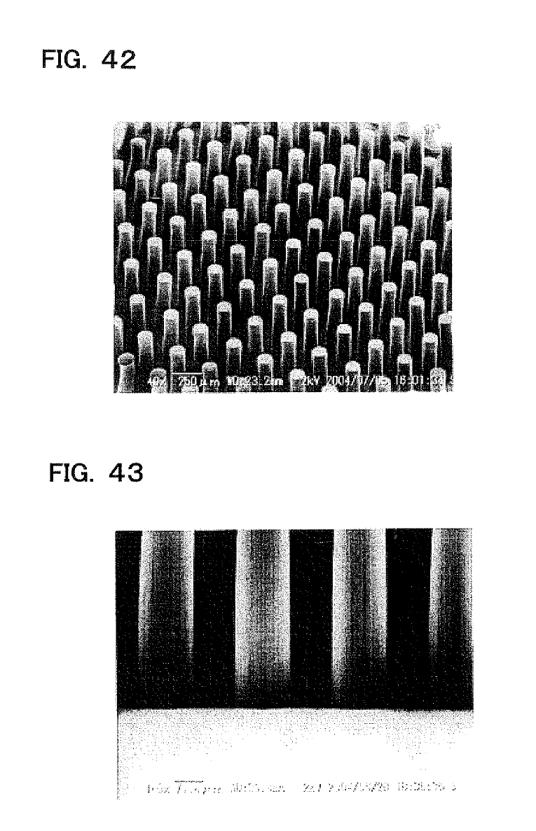

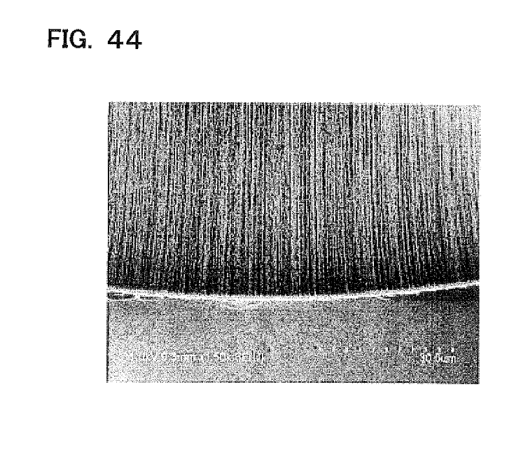

By the method described above, a circular columnar aligned single-walled CNT aggregate is obtained. FIG. 42 shows an SEM image for a portion thereof and FIG. 43 and FIG. 44 show SEM images for the base thereof at different magnification factors. It can be seen from FIG. 44 that the single-walled CNT of this example is aligned in a direction perpendicular to the substrate.

Further, in the aligned single-walled CNT aggregate produced by Example 2, typical property values are 0.03 g/cm³ for the density, 7 for the G/D ratio, 1100 m²/g for the BET-specific surface area, 2.8 nm for the average outer diameter, 2 nm for the full-width at half maximum, 99.9% for the carbon purity, and 0.7 for the Hermann's orientation factor.

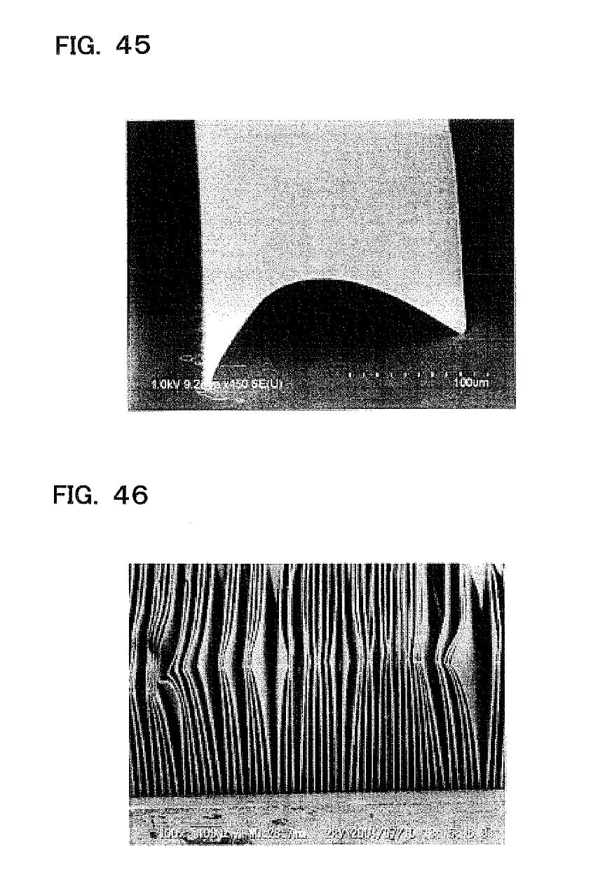

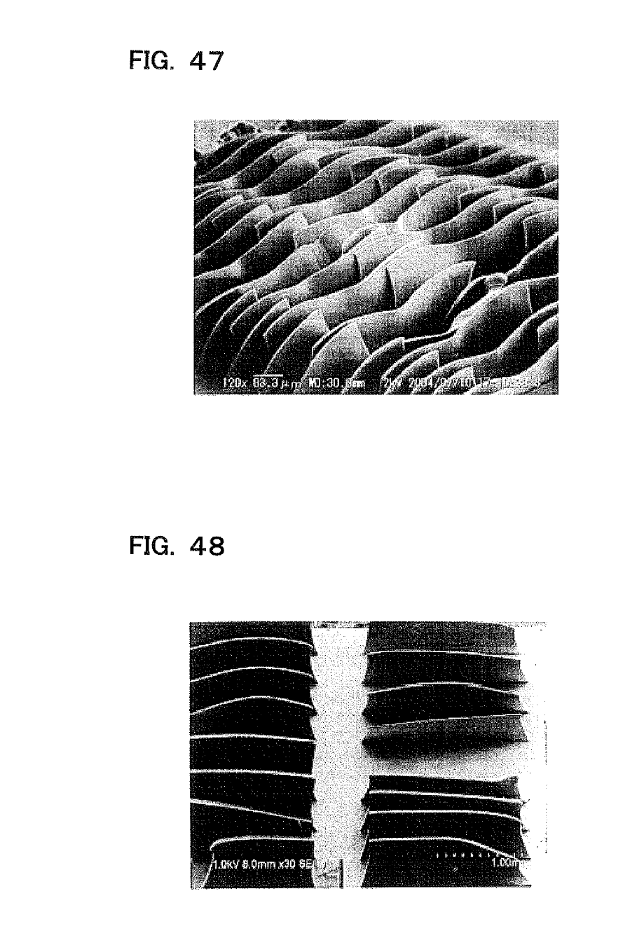

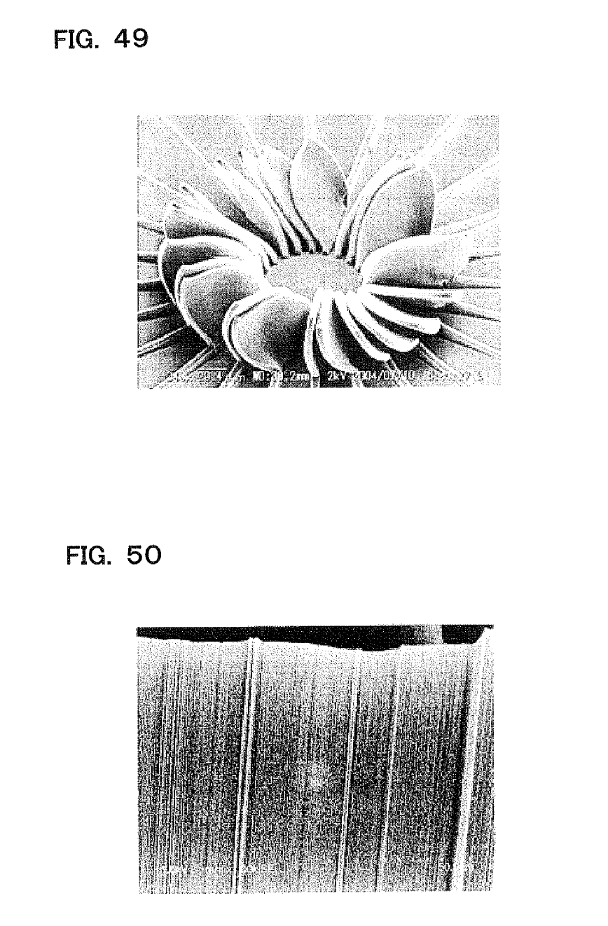

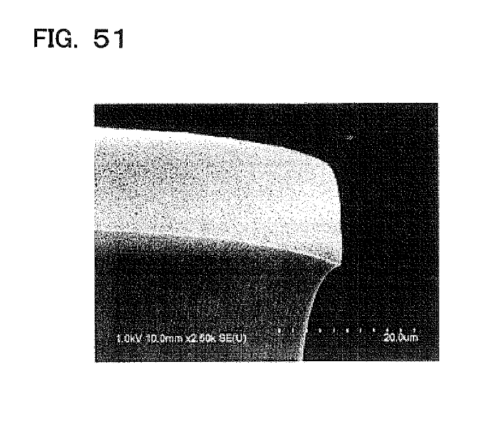

FIG. 45 to FIG. 51 show five examples of aligned single-walled CNT aggregates produced by changing the patterning of the catalyst and the reaction time in SEM images. It can be seen that the aligned single-walled CNT aggregate in FIG. 45 is in a thin film structure of 5 μm thickness and has flexibility. FIG. 46 is an image in which a plurality of thin film structures are viewed from the side and it can be seen that they also have flexibility. FIG. 47 shows a plurality of thin film structures arranged in a complicate manner, and FIG. 48 shows thin film structures of different thicknesses. The minimum value for the thickness obtainable at present is 1 μm which can be controlled optionally by the catalyst patterning if it is greater than the value. FIG. 49 shows structures of complicate shape. Further, FIG. 50 shows an SEM image in which an example of the aggregates is viewed from the upper surface and FIG. 51 shows an SEM image for the corner of one example of aggregates. In each of the figures, it can be observed that the single-walled CNT is aligned.

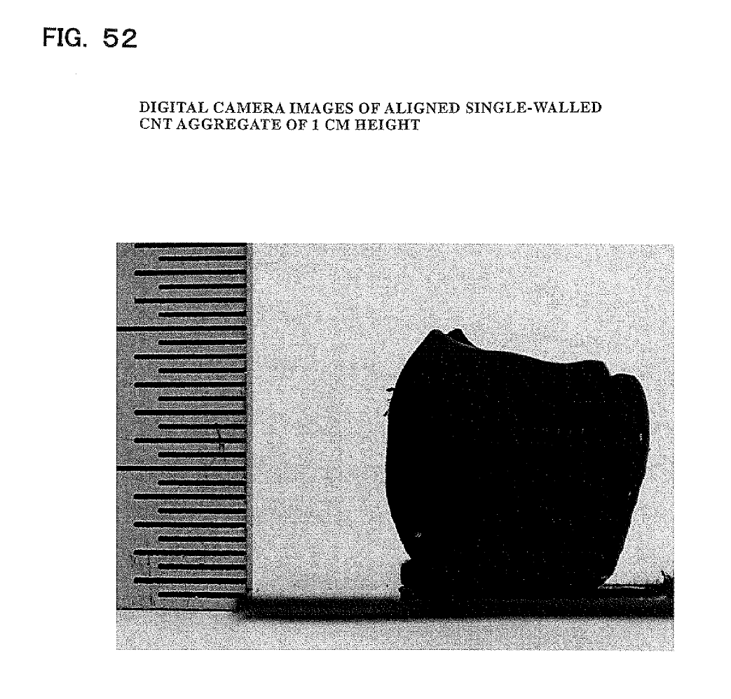

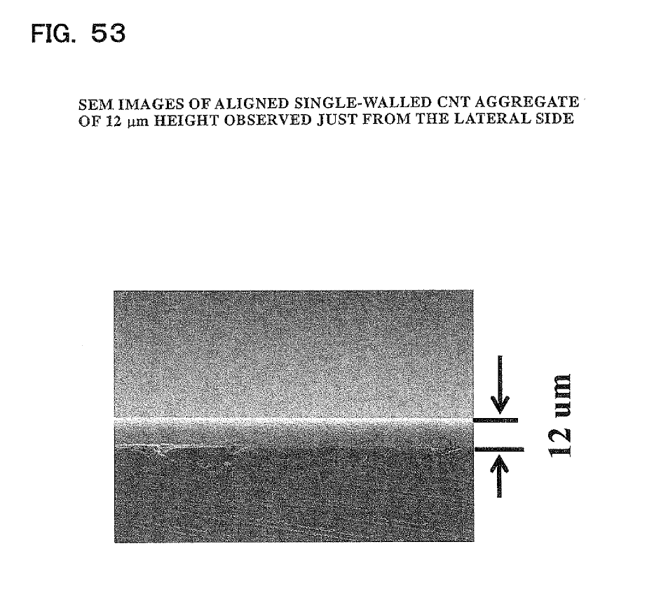

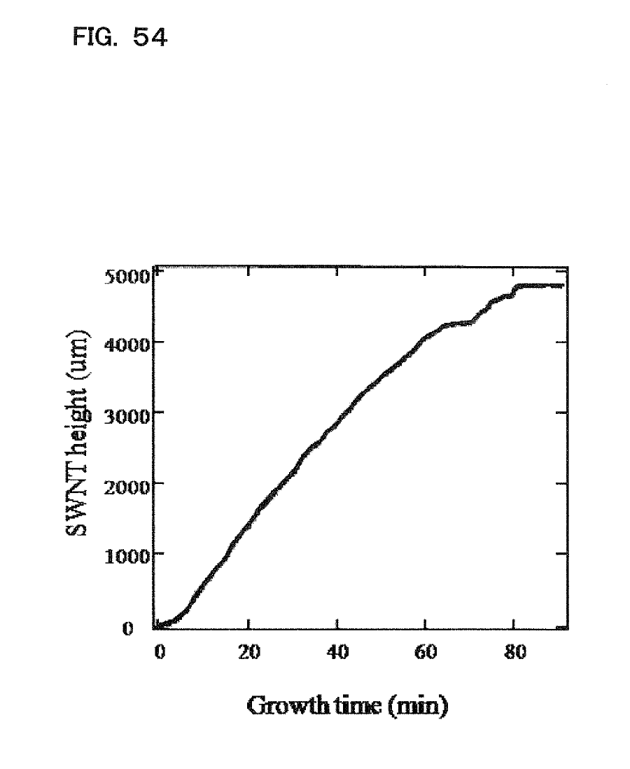

FIG. 52 shows a digital camera image for an aligned single-walled CNT aggregate of 1 cm height formed according to the method of Example 1 for a growing time of 120 min, and FIG. 53 shows an SEM image as viewed from the side of the aligned single-walled CNT aggregate obtained by growing CNTs while measuring the growing height by using the method of Example 1 as a well as a telecentric measuring system as described in the specification of Japanese Patent Application No. 2008-051321 and stopping the supply of the source gas at 10 μm height. Further, FIG. 54 shows an example of growing curves obtained by measuring the height during growing on real time by the telecentric measuring system in the same manner. By growing CNTs while measuring the growing height on real time and controlling the supply of the source gas in accordance with the measured value for the growing height, an aligned single-walled CNT aggregate of a desired height can be obtained by automatic control. In the example shown in FIG. 53, a time lug is present between the stopping of the source gas and the stopping of CNT growing and it is actually grown to 12 μm.

### Example 3

### Production by Granular or Linear Base Material

The aligned single-walled CNT aggregate according to the invention is to be described by way of a production process in a case of using a granular shaped base material or a linear shaped base material as a base material.

While the production method according to this example is identical with that in Example 1, a spherical granular shaped base material or a linear shaped base material of SUS 304 in a metal mesh form is used as the base material instead of the silicon substrate in Example 1.

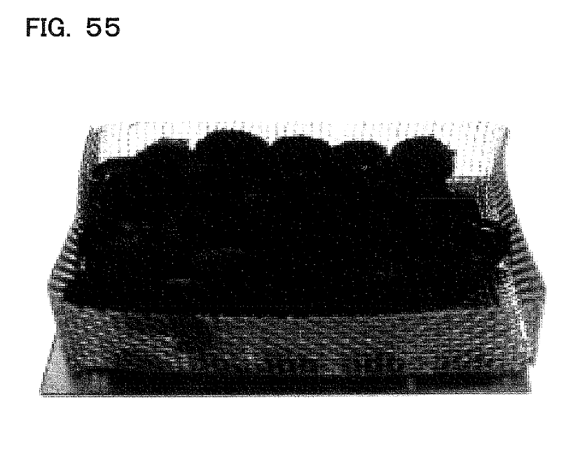

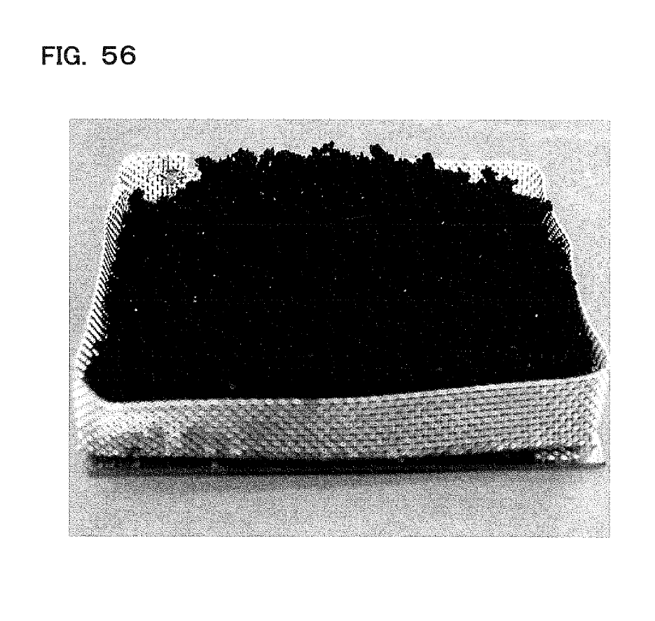

FIG. 55 shows a digital photograph of aligned single-walled CNT aggregates grown on alumina particles having an average diameter of 3 mm. It can be seen that the aligned single-walled CNT aggregate having a height of several hundred μm can be produced on the alumina particle. Further, FIG. 56 shows a digital photograph of aligned single-walled CNT aggregate grown on silica particles having an average diameter of 300 μm.

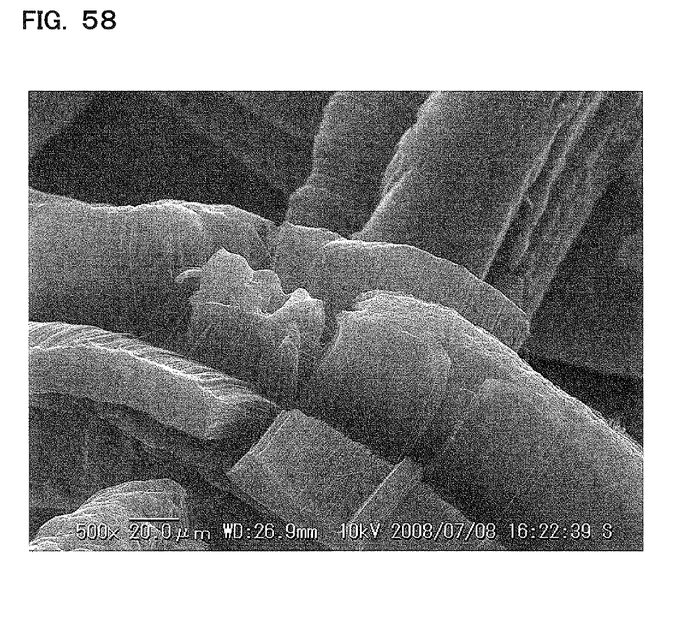

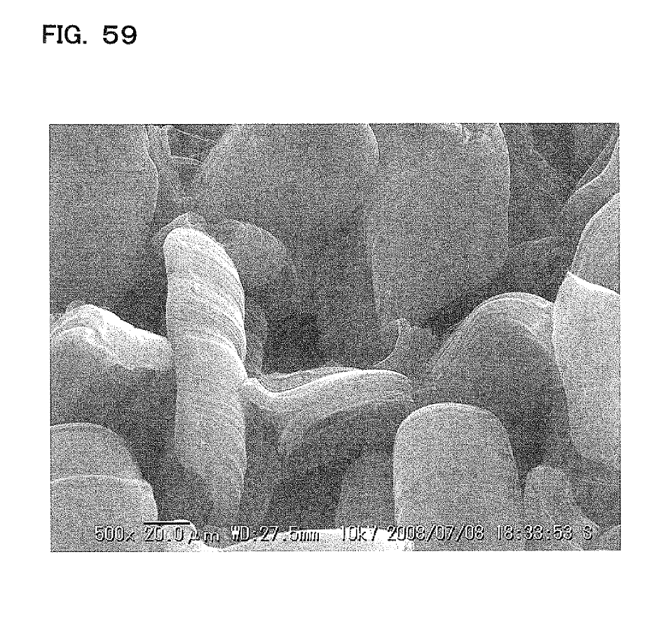

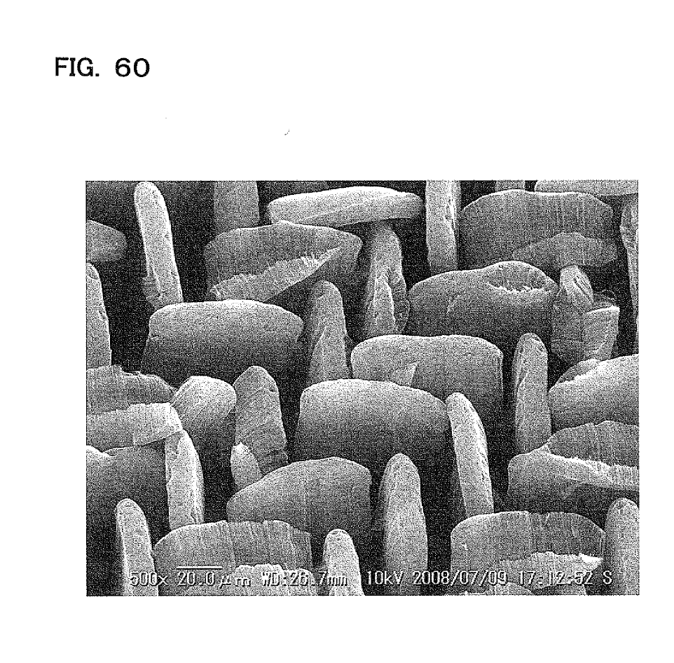

Then, FIG. 58 to FIG. 60 show SEM images for aligned single-walled CNT aggregates produced by using wires of SUS 304 having an average diameter of 100 μm, 30 μm, and 16 μm as the base material. It can be seen that the aligned single-walled CNT aggregates can be produced by using a linear shaped base material having an average diameter from 100 μm to 16 μm as the base material.

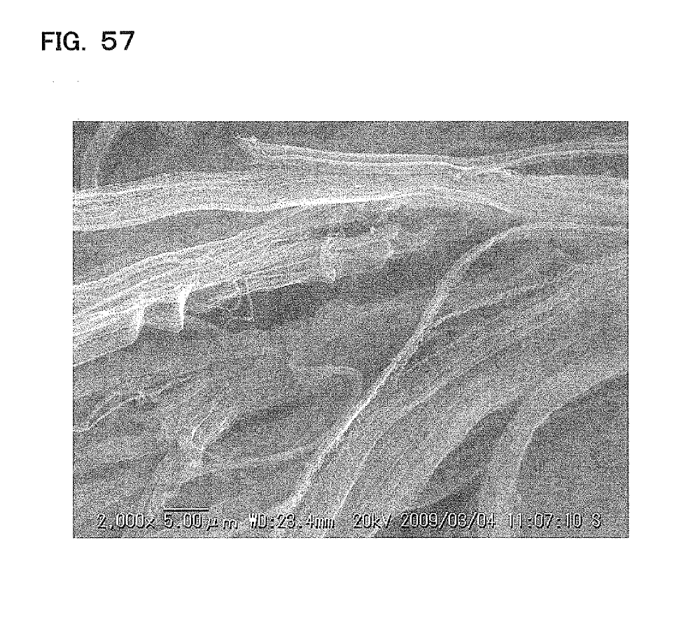

The structure of the aligned single-walled CNT aggregates has alignment property as shown in the SEM image shown in FIG. 57.

Table 2 shows the result of producing the aligned single-walled CNT aggregate by using granular bodies and linear bodies of various materials and average diameters.

TABLE 2

| | AVERAGE | |
|---|---|---|
| KIND | DIAMETER (μm) | GROWING |
| GRANULAR ALUMINA | 2000 | ◯ |
| BODY | 3000 | ◯ |
| GRANULAR HIGH | 300 | ◯ |
| PURITY BODY | 2000 | ◯ |
| GRANULAR SILICA | 300 | ◯ |
| BODY | 100 | ◯ |
| | 50 | ◯ |
| GRANULAR ZIRCONIA | 500 | ◯ |
| BODY | 2000 | ◯ |
| SUS304 WIRE | 16 | ◯ |
| | 30 | ◯ |
| | 100 | ◯ |

The open circle in Table 2 shows a case capable of producing aligned single-walled CNT aggregates having a specific surface area of 600 m²/g to 2600 m²/g, a weight density of from 0.002 g/cm³ to 0.2 g/cm³, and a Hermann's orientation factor of larger than 0 and smaller than 1 by using a granular shaped base material and a linear shaped base material as the base material, and capable of producing more number of aligned single-walled CNT aggregates per unit area in the synthesis furnace occupied by the base material (area of a plane defined with longitudinal and lateral directions of a space occupied by the base material) than that in the case of a planar base material.

Typical values for the property of the aligned single-walled CNT aggregate obtained under the production conditions of this example are 0.03 g/cm³ for the density, 1000 m²/g for the BET-specific surface area, 3 nm for the average outer diameter, 5 for the G/D ratio, 2 nm for the full-width at half maximum, 99.9% for the carbon purity, and 0.6 for the Hermann's orientation.

It can be seen that a linear shaped base material and a granular shaped base material having an average diameter of 16 μm to 3 mm are suitable for producing a great amount of aligned CNT aggregates having a specific surface area of 600 m²/g to 2600 m²/g, a weight density of from 0.002 g/cm³ to 0.2 g/cm³, and a Hermann's orientation factor of larger than 0 and smaller than 1.

### Example 4

### Bulk Aligned Single-Walled CNT Aggregate

A bulk aligned single-walled CNT aggregate is obtained by peeling the aligned single-walled CNT aggregate obtained in Example 1 or 2 from the substrate 32. While the property of the bulk aligned single-walled CNT aggregate depends on the production conditions for the aligned single-walled CNT aggregate, in a case of using the aligned single-walled CNT aggregate produced under the production conditions of Example 1, typical values are 0.03 g/cm³ for the density, 1200 m²/g for the BET-specific surface area, 2.5 nm for the average outer diameter, 2 nm for the full-width at half maximum, 99.9% for the carbon purity, and 0.8 for the Hermann's orientation factor. Further, in the case of using the aligned single-walled CNT aggregate produced under the production conditions of Example 2, typical values are 0.03 g/cm³ for the density, 1100 m²/g for the BET-specific surface area, 2.8 nm for the average outer diameter, 2 nm for the full-width at half maximum, 99.9% for the carbon purity, and 0.7 for the Hermann's orientation.

As the method of peeling the aligned single-walled CNT aggregate from the substrate 32, a physical, chemical, or a mechanical peeling method can be shown as an example. For example, a method of peeling by using, for example, electric field, magnetic field, centrifugal force, or surface tension, a method of peeling mechanically from the substrate 32 directly, or a method of peeling from the substrate 32 by using a pressure or heat is applicable. While a simple peeling method includes a method of peeling an aligned single-walled CNT aggregate from the substrate 32 by directly pinching it by tweezers, peeling the aggregate from the substrate 32 by using a thin blade such as a cutter blade is more suitable. Further, it is also possible to suck an aligned single-walled CNT aggregate by using a vacuum pump and peeling the same from the substrate 32.

After peeling, a vertically aligned single-walled CNT can be newly grown by utilizing the catalyst remaining on the substrate.

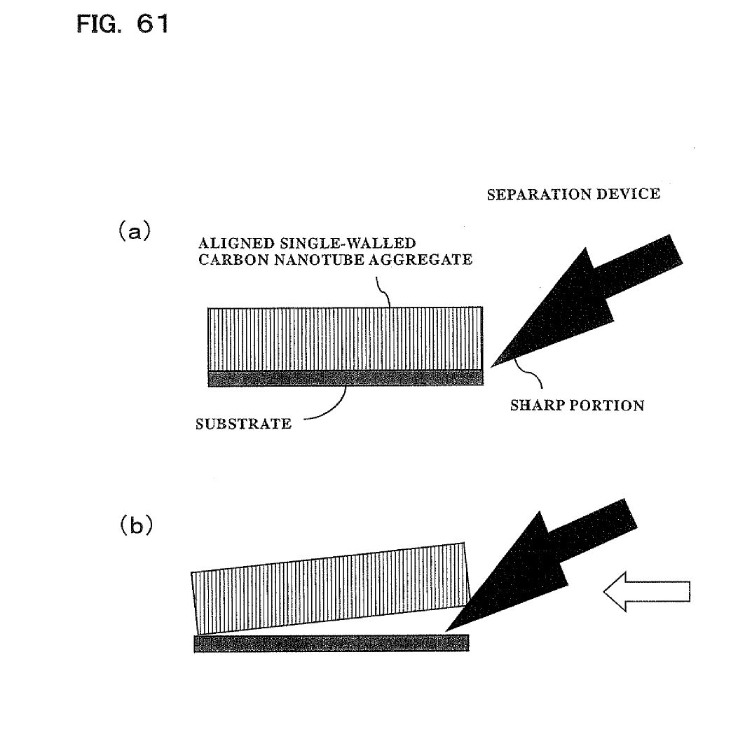

FIG. 61 shows an example of a separation device for peeling an aligned single-walled CNT aggregate from the substrate 32. The separation device has a sharp portion such as a cutter or a spatula. By abutting the sharp portion against the boundary between an aligned single-walled CNT aggregate and a substrate (FIG. 61-a) and moving the sharp portion along the surface of the substrate so as to scrape off the aligned single-walled CNT aggregate from the substrate (FIG. 61-b), the aligned single-walled CNT aggregate is peeled from the substrate. In this case, when the aligned single-walled CNT aggregate has a sufficient height of millimeter size, the aligned single-walled CNT aggregate can be easily peeled from the substrate.

A 50 mg of lump is taken out of the bulk aligned single-walled CNT aggregate thus peeled from the substrate, and adsorption/desorption isothermal curve for liquid nitrogen is measured at 77K using BELSORP-MINI (produced by Bell Japan Inc.) (adsorption equilibrium time is 600 sec.). Then, when the specific surface area is measured based on the adsorption/desorption isothermal curve by a method of Brunauer, Emmett, Teller, it is 1100 m²/g. Further, a 50 mg of lump is taken out from the same bulk aligned single-walled CNT aggregate, arranged evenly on a tray made of alumina, and placed in a muffle furnace. Then, when the temperature is elevated to 550° C. at 1° C./min and a heat treatment is conducted in an oxygen atmosphere (20% concentration) for 1 min, the weight of the sample is reduced to 43 mg and 7 mg thereof is burnt. When the specific surface area is measured in the same manner as described above for the sample after the heat treatment, the specific surface area is about 2000 m²/g. The specific surface area of the sample after the heat treatment is increased compared with that of the sample and it suggests that a tip of the CNT is opened by the heat treatment.

### [Evaluation for Alignment Property by θ-2θ Method]

The alignment property of the obtained bulk aligned single-walled CNT aggregate is evaluated by an X-ray diffraction measuring method according to the θ-2θ method. The main factors of the bulk aligned single-walled CNT aggregate used as the sample are square columnar shape of 1 m×1 m×10 mm configurational size, 0.037 g/cm³ for the density, 1200 m²/g for the BET-specific surface area, 2.8 nm for the average outer diameter, 2 nm for the full-width at half maximum, and 99.9% for the carbon purity.

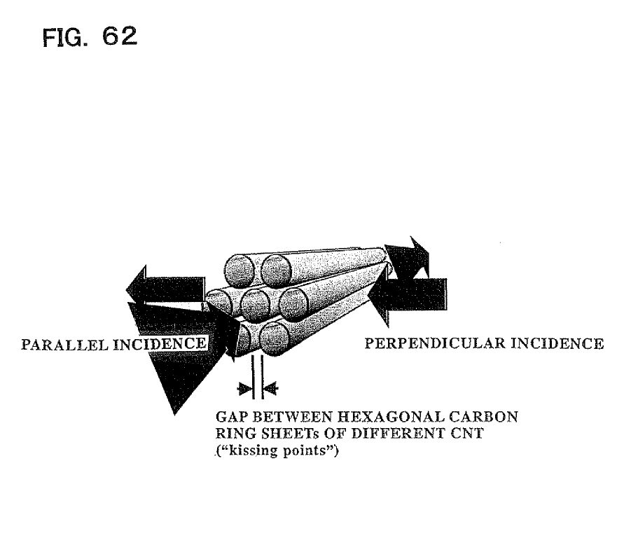

The X-ray diffraction spectra for the sample are as shown in FIG. 22 to FIG. 24. The observed diffraction peaks reflect the periodicity for the constitution of a hexagonal carbon ring that constitutes the single-walled CNT and the periodicity of packing between the single-walled CNTs. (CP) diffraction peaks observed at low angle (0 to 15 degrees) reflect the distance between each of the single-walled CNTs. Moderate diffraction peaks observed near 25 degrees reflect the gap of the hexagonal carbon ring sheets of different single-walled CNTs (refer to FIG. 62). The diffraction peak near 42 degrees reflect the (100) face of the hexagonal carbon ring of the single-walled CNT, and diffraction peaks near 77 to 78 degrees reflect the (110) face. Since the hexagonal carbon ring structure of the single-walled CNT is rounded and curved, the diffraction peaks are not closely identical with the diffraction peak of the graphite structure. Further, while the peak positions change somewhat slightly both for the size and the alignment degree of the single-walled CNT, the diffraction peaks can be identified.

When the Hermann's orientation factor F is calculated based on the result, it is 0.4 to 0.62 for the (CP) diffraction peak and 0.75 for the (002) diffraction peak.

### [Evaluation for Alignment Property by Laue Method]

The alignment degree of the obtained bulk aligned single-walled CNT aggregate is evaluated by an X-ray diffraction measuring method according to the Laue method.

Main factors of the bulk aligned single-walled CNT aggregate used as the sample are circular columnar shape of 1 mm diameter×0.5 mm height for the configurational size, 0.037 g/cm³ for the density, 1200 m²/g for the BET-specific surface area, 2.8 nm for the average outer diameter, 2 nm for the full-width at half maximum, and 99.9% for the carbon purity.

As a result, the diffraction peaks for (CP), (002), (100), etc. observed for the bulk aligned single-walled CNT aggregate are in an elliptic shape and show anisotropy. The anisotropy shows that the single-walled CNT is aligned.

When the Hermann's orientation factor F is calculated based on the result, it is 0.38 for the (CP) diffraction peak and 0.61 for the (002) diffraction peak.

### Example 5

### Powdered Aligned Single-Walled CNT Aggregate

A aligned single-walled CNT aggregate is peeled from a substrate to obtain a powdered aligned single-walled CNT aggregate. While the property of the powdered aligned single-walled CNT aggregate depends on the production conditions of the aligned single-walled CNT aggregate used, in a case of using the aligned single-walled CNT aggregate produced under the production conditions of Example 1, the typical values are 0.0005 g/cm³ to 0.16 g/cm³ for the density, 1200 m²/g for the BET-specific surface area, 2.5 nm for the average outer diameter, 2 nm for the full-width at half maximum, 99.9% for the carbon purity, and 0.8 for the Hermann's orientation factor. Further in a case of using the aligned single-walled CNT aggregate produced under the production conditions of Example 2, the typical values are 0.0005 g/cm³ to 0.16 g/cm³ for the density, 1100 m²/g for the BET-specific surface area, 2.8 nm for the average outer diameter, 2 nm for the full-width at half maximum, 99.9% for the carbon purity, and 0.7 for the Hermann's orientation factor.

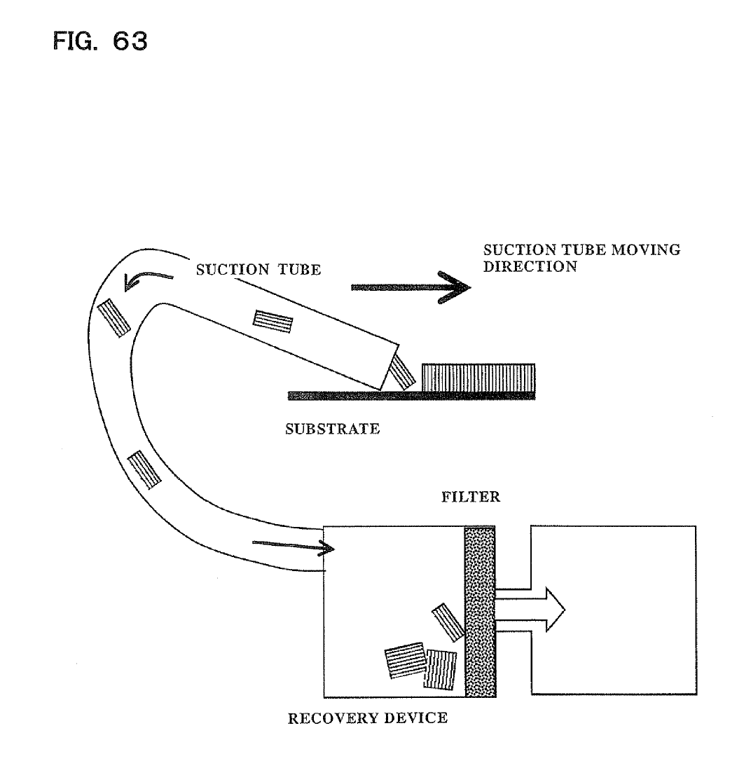

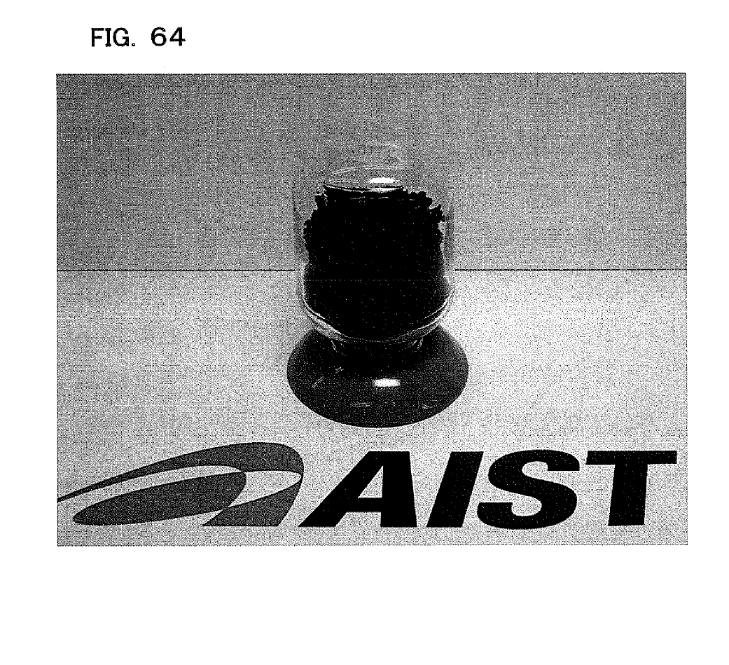

As shown in FIG. 63, a suction tube connected to a vacuum apparatus which may be, for example, a commercially available vacuum cleaner is placed on a sample of an aligned single-walled CNT aggregate, and the aligned single-walled CNT aggregate is separated from the substrate by utilizing the suction force thereof and sucked into a suction tube. In this case, the aligned single-walled CNT aggregate is formed into a powdery shape (refer to FIG. 64), which is caught by a filter in a collecting device.

As seen in SEM images in FIG. 5, the structure of the powdered aligned single-walled CNT aggregate has an alignment property to some extent in most cases. For evaluating the alignment degree of the powdered aligned single-walled CNT aggregate by SEM (or AFM) images, observation at an adequate place and under an adequate magnification factor is necessary.

Further, the powdered aligned single-walled CNT aggregate may also contain a partially isotropic structure to a degree that does not deteriorate the functions used in the application.

### [Alignment Property of Powdered Aligned Single-Walled CNT Aggregate]

FIG. 27 shows FFT images based on SEM images shown in FIG. 5. FFT images show anisotropy respectively while the degree is different depending on the magnification ratio of SEM images and places. This shows that CNT in the structure is aligned.

An intensity profile shown in FIG. 28 is obtained by determining the transformation intensity from the reference direction (φ=0) to φ=π/2 in the radial direction while keeping an equal distance from the original point of FFT images (FIG. 27). When the Hermann's orientation factor F is calculated by using the intensity profile, it is 0.6 for Region 1 and 0.3 for Region 2, and it is found that the powdered aligned single-walled CNT aggregate is aligned.

### [Density of Powdered Aligned Single-Walled CNT Aggregate]

The density of the powdered aligned single-walled CNT aggregate is determined as follows. The density measurement for the powdered aligned single-walled CNT aggregate can be evaluated by two methods, that is, loose density and tap density.

The loose density is a weight density after the powdered aligned single-walled CNT aggregate is placed in a container and shaken violently. In the case of this sample, the loose density is 0.019 g/cm³. Further, the loose density of another sample is 0.009 g/cm³.

The tap density is a weight density after placing the powdered aligned single-walled CNT aggregate in a container and dropping the same from the height of 25 mm to a hard surface repetitively 20 times. In the case of this sample, the tap density is 0.024 g/cm³. Further, the tap density of another sample is 0.014 g/cm³. Since the density of the aligned single-walled CNT aggregate before forming the sample into a powdered state is about 0.03 to 0.04 g/cm³, it can be seen that the weight density decreased from ⅘ to ¼ by powdering the same.

### [Verification of Dispersibility]

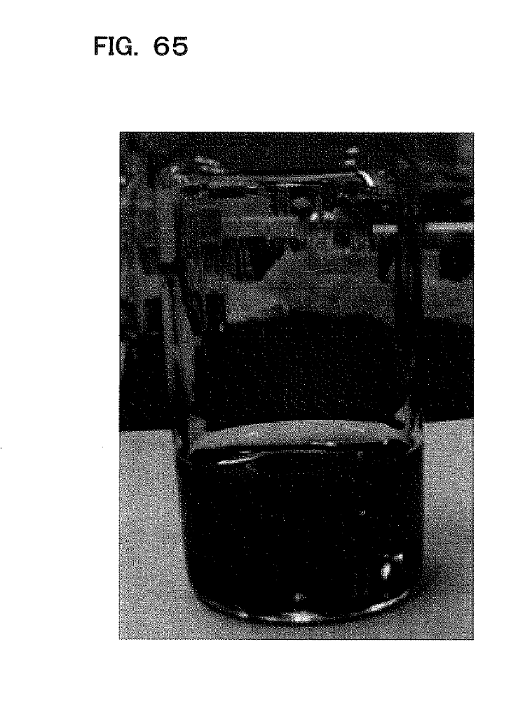

For verifying the shape processability (dispersibility) of the powdered aligned single-walled CNT aggregate produced in Example 5 (density: 0.024 g/cm³), 1 mg of the powdered aligned single-walled CNT aggregate is poured into 5 mL of DMF which is often used as the dispersion solvent for CNT, and dispersed for 10 minutes by using a homogenizer. Further, 5 mL of the solvent is added and dispersed for 10 minutes by the homogenizer. FIG. 65 shows the obtained liquid dispersion. It can be seen that the powdered aligned single-walled CNT aggregate of the invention is easily dispersed uniformly in the solvent, that is, the powdered aligned single-walled CNT aggregate at low density is excellent in the shape processability.

### [Verification of Non-Dispersibility]

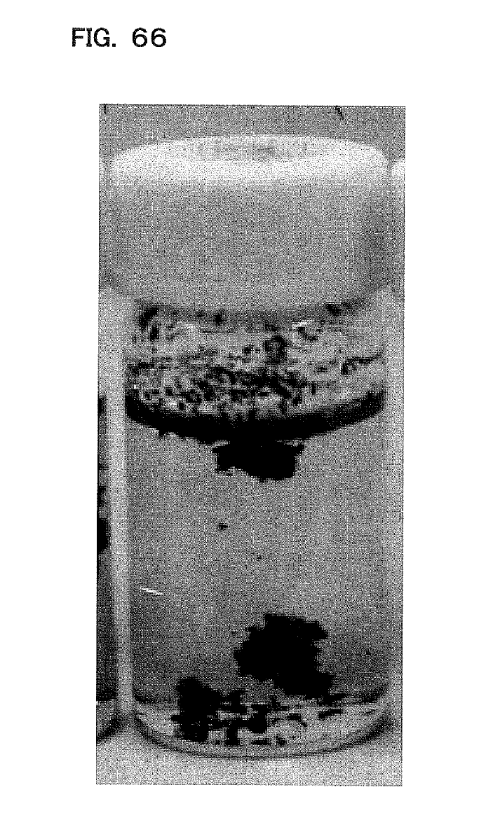

The powdered aligned single-walled CNT aggregate produced in Example 5 is subjected to a density-increasing treatment by utilizing, for example, a method as described in Journal of Nature Material, Vol. 5 (2006), p 987-994. Specifically, 1 mg of a powdered aligned single-walled CNT aggregate is poured in 10 mL of an isopropanol solution, which is dried to increase the density. The tap density of the obtained powdered aligned single-walled CNT aggregate at high density is 0.22 g/cm³. 1 mg of the powdered aligned single-walled CNT aggregate at high density is poured in 5 mL of DMF which is often used as the dispersion solvent for CNT and dispersed for 10 minutes by a homogenizer. Further, 5 mL of the solvent is added and dispersed for 10 minutes by the homogenizer. FIG. 66 shows the obtained liquid dispersion. It can be seen that the powdered aligned single-walled CNT aggregate at high density is less dispersed in the solvent, that is, the powdered aligned single-walled CNT aggregate at high density is poor in the shape processability.

### [Effect by the Combination of Source Material and Catalyst Activating Material]

The result of producing the aligned single-walled CNT aggregate according to the invention by changing the combination of the source material and the catalyst activating material is to be described below specifically. The production steps according to this example is identical with those of the flow chart in Example 1 shown in FIG. 37 and the process conditions are identical with those for Example 1 shown in FIG. 38. However, the source material is not restricted to ethylene, but two kinds of materials not containing oxygen (acetylene, ethylene) and one kind of material containing oxygen (carbon monoxide), that is, materials of three kinds in total are used. Further, the catalyst activating material is not restricted to the water but seven kinds of oxygen containing materials (water, carbon dioxide, acetone, tetrahydrofuran, ethanol, methyl benzoate, and benzaldehyde) and one kind of material not containing oxygen (ammonia), that is, materials of eight kinds in total are used.

A silicon substrate vapor deposited with the same catalyst metal (Al₂O₃+Fe) as in Example 1 is provided, which is transported and installed in a synthesis furnace heated previously in the same manner as in Example 1 and, by way of the same formation step as in Example 1, a CNT growth step is carried out with the same conditions as those in Example 1 by the combination of three kinds of the source materials and 8 kinds of the catalyst activating materials, that is, in 24 types of the combination, and the CNT growth step is carried out with only three kinds of source materials. Subsequently, after the same flushing step as in Example 1, the substrate is taken out from the inside of the furnace.

The growing height of the aligned CNT aggregate produced in 27 types of combinations of the source materials and the catalyst activating materials as described above is as shown in FIG. 36. It has been found from the result that while the CNT can be produced by using only the source material without using the catalyst activating material, the growing height of the aligned CNT aggregate is small and the CNT cannot be produced at high efficiency. This shows that the catalyst activating material is extremely important for producing the CNT at good efficiency.

On the contrary, in any one of 14 types of combinations using source materials containing carbon and not containing oxygen (acetylene, ethylene) and oxygen-containing catalyst activating materials (water, carbon dioxide, acetone, tetrahydrofuran, ethanol, methyl benzoate, benzaldehyde), an aligned CNT aggregate of large height can be produced. This shows that CNT can be produced at high efficiency by the combination of the source material and the catalyst activating material that satisfies the required conditions.

Further, in a case of adding ammonia not containing oxygen, a CNT of large height cannot be produced and, in a case of adding seven kinds of oxygen-containing materials, a CNT of large height can be produced. This shows that the material not containing oxygen is not suitable as the catalyst activating material and it is necessary to contain oxygen for the catalyst activating material.

### [Relation Between Addition Amount of Catalyst Activating Material and Growth Efficiency]

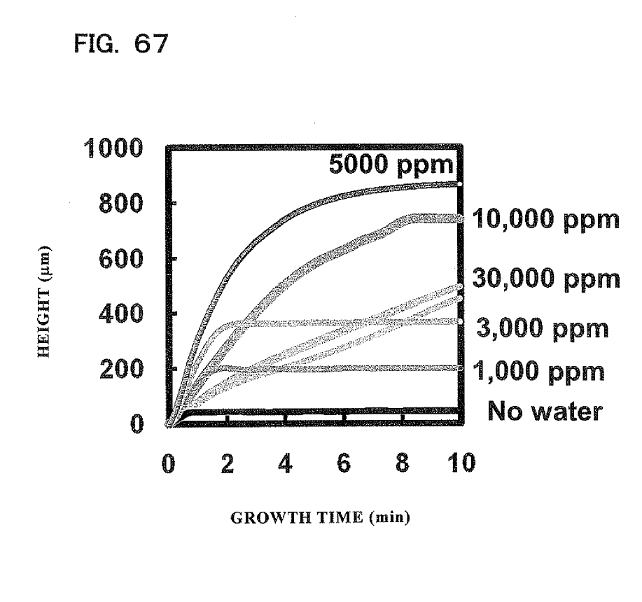

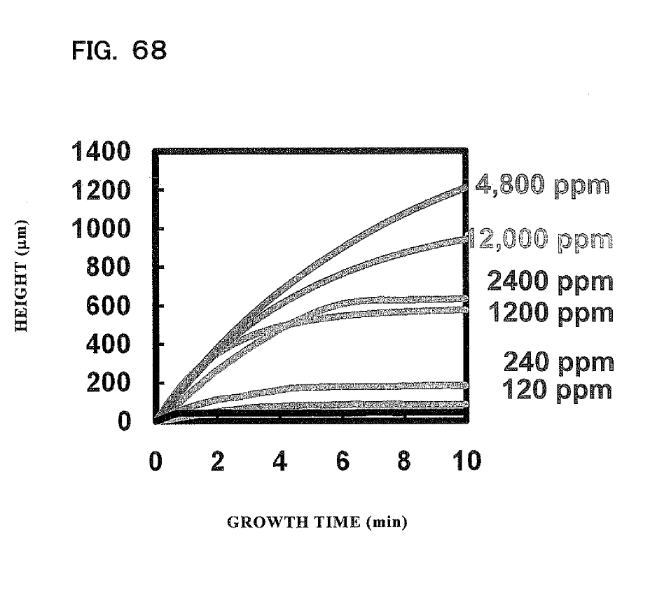

The relation between the addition amount of the catalyst activating material and the growth efficiency is described. FIG. 67 and FIG. 68 show examples of growing curves obtained by measuring the growth rate of CNT in real time by a telecentric measuring system (refer to the specification of JP-A No. 2008-051321) in a case of using ethylene (75 sccm) as the source material and using carbon dioxide or acetone as the catalyst activating material. According to the result, the aligned CNT aggregate grows scarcely in a case of not adding either of the catalyst activating materials, whereas the growth rate of CNT increases and the growing lifetime is extended with increase of the addition amount of either of the catalyst activating materials. That is, as a result of adding the catalyst activating material, the height of the aligned CNT aggregate increases remarkably and the growth efficiency improved.

The growth rate and the growing height of a CNT reach the maximum where the addition amount of the catalyst activating material is at an optimal value. The optimal addition amount is 5000 ppm in a case of carbon dioxide (refer to FIG. 67) and the optimal addition amount is 4800 ppm in a case of acetone (refer to FIG. 68). Further, in a case of adding a amount of the catalyst activating material exceeding the optimal value, the growth rate is lowered and the growing life time is shortened. That is, when the catalyst activating material is added excessively, the growth height of the aligned CNT aggregate decreased and the growth efficiency lowered. Further, the ratio between carbon contained in the source material and oxygen contained in the catalyst activating material in the optimized growth step is 15 in a case of carbon dioxide and 31 in the case of acetone.

Similar addition effect and the presence of the optimal addition amount of the catalyst activating material are observed in any one of the combinations capable of producing the aligned CNT aggregates at high efficiency, that is, 14 types of combinations using the source materials containing carbon and not containing oxygen (acetylene, ethylene) and the oxygen-containing catalyst activating material (water, carbon dioxide, acetone, tetrahydrofuran, ethanol, methyl benzoate, benzaldehyde).

In 14 types of combinations of the source materials and the catalyst activating materials, Table 3 (source material: ethylene) and Table 4 (source material: diluted acetylene: contained by 10% in helium) show the ratio of carbon contained in the carbon source material and oxygen contained in the catalyst activating material under the optimal growing condition.

TABLE 3

| | | CATALYST | |
|---|---|---|---|
| | SOURCE | ACTIVATING | |
| | MATERIAL | MATERIAL | CARBON |
| CATALYST | ADDITIONAL | ADDITIONAL | AND |
| ACTIVATING | AMOUNT | AMOUNT | OXYGEN |
| MATERIAL | (sccm) | (ppm) | RATIO |
| WATER | 75 | 100 | 1500 |
| CARBON DIOXIDE | 75 | 5000 | 15 |
| ACETONE | 75 | 4800 | 31 |
| TETAHYDROFURAN | 75 | 2000 | 75 |
| ETHANOL | 75 | 1400 | 107 |
| BENZALDEHYDE | 75 | 100 | 1500 |
| METHYL BENZOATE | 75 | 100 | 750 |

TABLE 4

| | | CATALYST | |
|---|---|---|---|
| | SOURCE | ACTIVATING | |
| | MATERIAL | MATERIAL | CARBON |
| CATALYST | ADDITIONAL | ADDITIONAL | AND |
| ACTIVATING | AMOUNT | AMOUNT | OXYGEN |
| MATERIAL | (sccm) | (ppm) | RATIO |
| WATER | 75 | 225 | 67 |
| CARBON DIOXIDE | 75 | 5000 | 2 |
| ACETONE | 75 | 5000 | 3 |
| TETAHYDROFURAN | 75 | 1000 | 15 |
| ETHANOL | 75 | 1500 | 10 |
| BENZALDEHYDE | 75 | 150 | 100 |
| METHYL BENZOATE | 75 | 150 | 50 |

According to the result, while the optimal ratio between carbon contained in the source material and oxygen contained in the catalyst activating material is different depending on the source material and the catalyst activating material but it is within a range of 1 or more and 2000 or less. It can be seen that the ratio between carbon contained in the source material and oxygen contained in the catalyst activating material has to be within a range from 1 or more and 2000 or less for producing an aligned CNT aggregate having a large height and a large specific surface area efficiently.

Depending on the combination of the source material and the catalyst activating material, the structure and the property such as the average outer diameter, the full-width at half maximum, the specific surface area, the crystallinity, and the purity of the produced CNT, and the density, the height, and the alignment property of the aligned CNT aggregate to be produced are changed and, further, the growth efficiency such as the growing duration time and the growth rate are changed. Accordingly, use of such actions provides a remarkable effect for producing various aligned CNT aggregates having a specific surface area from 600 m²/g to 2600 m²/g, a weight density from 0.002 g/cm³ to 0.2 g/cm³, and a Hermann's orientation factor of larger than 0 and smaller than 1.

When the purity of the aligned CNT aggregates produced under the optimal growing conditions in the 14 types of combinations of the source materials and the catalyst activating materials described above is determined by elemental analysis according to fluorescence X-rays, the carbon purity is 99.9% or higher in each of the cases.

Table 5 shows a G/D ratio of Raman spectra for evaluating the linearity (crystallinity) of aligned CNT aggregates produced under the optimal growing conditions in 14 types of combinations of the source materials and the catalyst activating materials providing high aligned CNT aggregate. It can be seen from the data in the table that aligned CNT aggregate of G/D ratio within a range from 1 to 9.5 can be produced by appropriately combining the source material and the catalyst activating material. Further, it can be seen that water, acetone, and ethanol are suitable for producing an aligned CNT aggregate of high G/D ratio and benzaldehyde and methyl benzoate are suitable for producing an aligned CNT aggregate of low G/D ratio.

TABLE 5

| | |
|---|---|
| CATALYST | G/D RATIO |

| ACTIVATING | ETHYLENE | ACETYLENE |
|---|---|---|
| WATER | 8.5 | 9.5 |
| CARBON DIOXIDE | 6.5 | 5.9 |
| ACETONE | 6.4 | 7.4 |
| TETAHYDROFURAN | 7.3 | 6 |
| ETHANOL | 6.5 | 7.9 |
| BENZALDEHYDE | 1.7 | 1.5 |
| METHYL BENZOATE | 0.8 | 1 |

Table 6 shows the weight density of aligned CNT aggregates produced under the optimal growing conditions in 14 types of combinations of the source materials and the catalyst activating materials. It can be seen from the data in the table that by properly combining the source material and the catalyst activating material, aligned CNT aggregates having a weight density within a range from 0.02 g/cm³ to 0.068 g/cm³ can be produced. Further, it can be seen that water and methyl benzoate are suitable for producing an aligned CNT aggregate at low density, and tetrahydrofuran and ethanol are suitable for producing an aligned CNT aggregate at high density.

TABLE 6

| | |
|---|---|
| CATALYST | DENSITY (g/cm³) |

| ACTIVATING | ETHYLENE | ACETYLENE |
|---|---|---|
| WATER | 0.028 | 0.04 |
| CARBON DIOXIDE | 0.042 | 0.034 |
| ACETONE | 0.033 | 0.043 |
| TETAHYDROFURAN | 0.048 | 0.068 |
| ETHANOL | 0.048 | 0.05 |
| BENZALDEHYDE | 0.058 | 0.021 |
| METHYL BENZOATE | 0.05 | 0.062 |

Table 7 shows the initial growth rate of aligned CNT aggregates produced under the optimal growing condition in 14 types of combinations of the source materials and the catalyst activating materials. It can be seen from the data in the table that by properly combining the source material and the catalyst activating material, aligned CNT aggregates having an initial growth rate within a range from 88 μm/min to 960 μm/min can be produced. Further, it can be seen that methyl benzoate, ethanol, and acetone are suitable for synthesizing an aligned CNT aggregate at high initial growth rate, and carbon dioxide, water, and benzaldehyde are suitable for synthesizing an aligned CNT aggregate at low initial growth rate.

TABLE 7

| | |
|---|---|
| | INITIAL |
| | GROWING RATE |
| CATALYST | (μm/min) |

| ACTIVATING | ETHYLENE | ACETYLENE |
|---|---|---|
| WATER | 118 | 327 |
| CARBON DIOXIDE | 111 | 306 |
| ACETONE | 560 | 280 |
| TETAHYDROFURAN | 290 | 320 |
| ETHANOL | 580 | 590 |
| BENZALDEHYDE | 104 | 960 |
| METHYL BENZOATE | 88 | 356 |

Table 8 shows the growing continuation time of aligned CNT aggregates produced under the optimal growing conditions in 14 types of combinations of the source materials and the catalyst activating materials. It can be seen from the data in the table that by properly combining the source material and the catalyst activating material, aligned CNT aggregates having an initial growth rate within a range from 0.44 minutes to 11 minutes can be produced.

TABLE 8

| | |
|---|---|
| CATALYST | LIFE (min) |

| ACTIVATING | ETHYLENE | ACETYLENE |
|---|---|---|
| WATER | 6.80 | 1.9 |
| CARBON DIOXIDE | 11.06 | 4.6 |
| ACETONE | 1.81 | 5.6 |
| TETAHYDROFURAN | 3.10 | 1.9 |
| ETHANOL | 1.70 | 1.4 |
| BENZALDEHYDE | 8.1 | 0.44 |
| METHYL BENZOATE | 10.8 | 3.0 |

Table 9 shows the Hermann's orientation factor of aligned CNT aggregates produced under the optimal growing conditions in 14 types of combinations of the source materials and the catalyst activating materials. It can be seen from the data in the table that by properly combining the source material and the catalyst activating material, aligned CNT aggregates having a Hermann's orientation factor within a range from 0.45 to 0.8 can be produced.

TABLE 9

| | |
|---|---|
| | HERMANN'S |
| CATALYST | ORINTATION FACTOR |

| ACTIVATING | ETHYLENE | ACETYLENE |
|---|---|---|
| WATER | 0.60 | 0.55 |
| CARBON DIOXIDE | 0.62 | 0.65 |
| ACETONE | 0.62 | 0.45 |
| TETAHYDROFURAN | 0.57 | 0.7 |
| ETHANOL | 0.51 | 0.52 |
| BENZALDEHYDE | 0.63 | 0.8 |
| METHYL BENZOATE | 0.60 | 0.75 |

Table 10 shows the specific surface area of aligned CNT aggregates produced under the optimal growing conditions in 10 types of combinations of the source materials and the catalyst activating materials capable of producing aligned CNT aggregates having a large height. It can be seen from the data in the table that by properly combining the source material and the catalyst activating material, aligned CNT aggregates of a specific surface area within a range from 630 m²/g to 1443 m²/g can be produced. Particularly, water, carbon dioxide, tetrahydrofuran, and ethanol are suitable for producing an aligned CNT aggregate of a high specific surface area.

TABLE 10

| | |
|---|---|
| | BET-SPECIFIC SURFACE |
| CATALYST | AREA (m²/g) |

| ACTIVATING | ETHYLENE | ACETYLENE |
|---|---|---|
| WATER | 1350 | 1300 |
| CARBON DIOXIDE | 1443 | 1249 |
| ACETONE | 630 | 1285 |
| TETAHYDROFURAN | 1097 | 1348 |
| ETHANOL | 1044 | 1408 |

When the contents of single-layered CNT in the aligned CNT aggregates produced under the optimal growing conditions in 10 types of combinations of the source materials and the catalyst activating materials are determined based on the images of a transmission type electron microscope (hereinafter also referred to as TEM), it is 95% or higher in each of the cases.

TABLE 11

| | |
|---|---|
| | AVERAGE OUTER |
| CATALYST | DIAMETER (nm) |

| ACTIVATING | ETHYLENE | ACETYLENE |
|---|---|---|
| WATER | 2.5 | 2.63 |
| CARBON DIOXIDE | 2.3 | 2.81 |
| ACETONE | 2.5 | 2.38 |
| TETAHYDROFURAN | 2.25 | 2.55 |
| ETHANOL | 2.6 | 2.6 |

Table 11 shows the average outer diameter of aligned CNT aggregates produced under the optimal growing conditions in ten types of combinations of the source materials and the catalyst activating materials. From the data in the table, it can be seen that aligned CNT aggregates of an average outer diameter within a range from 2.2 nm to 2.8 nm can be produced by properly combining the source material and the catalyst activating material. Further, it can be seen that acetone and tetrahydrofuran are suitable for producing an aligned CNT aggregate of a small average outer diameter, while carbon dioxide is suitable for producing an aligned CNT aggregate of a large average outer diameter. In each of the cases, the range for the outer diameter distribution (full-width at half maximum) is 1 nm or more and 2 nm or less.

1. An aligned single-walled carbon nanotube (CNT) aggregate comprising a base material, catalyst particles with a density of 1×10¹⁰ to 5×10¹³N/cm² disposed on the base material, and a plurality of single-walled carbon nanotubes (SWNTs) grown from the catalyst particles, in which the plurality of single-walled CNTs have a specific surface area of 600 m²/g to 2600 m²/g, and a weight density from 0.002 g/cm³ to 0.2 g/cm³, and the alignment degree is defined by at least one of the following conditions:
(1) in a case where X-rays are incident from a first direction parallel to the longitudinal direction of CNT and a second direction perpendicular to the first direction to measure the X-ray diffraction intensity (θ-2θ method), a θ angle and a reflection direction where the reflection intensity from the second direction is larger than the reflection intensity from the first direction are present, and a θ angle and a reflection direction where the reflection intensity from the first direction is larger than the reflection intensity from the second direction are present,
(2) in a case where the X-ray refraction intensity is measured (Laue method) by 2-dimensional diffraction pattern images obtained by incidence of X-rays in the direction perpendicular to the longitudinal direction of CNT, a diffraction peak pattern showing the presence of the anisotropy appears, or
(3) Herman's orientation factor is greater than 0 and smaller than 1.

2. An aligned single-walled CNT aggregate according to claim 1, in which the base material is powdered base material or linear base material.

3. An aligned single-walled CNT aggregate according to claim 2, in which the average diameter of the powdered shaped base material or the linear shaped base material is 10 μm or more and 1 cm or less.

4. An aligned single-walled CNT aggregate having a specific surface area from 600 m²/g to 2600 m²/g and a weight density from 0.002 g/cm³ to 0.2 g/cm³, in which the alignment degree is defined by at least one of the following conditions.
(1) in a case where X-rays are incident from a first direction parallel to the longitudinal direction of CNT and a second direction perpendicular to the first direction to measure the X-ray diffraction intensity (θ-2θ method), a θ angle and a reflection direction where the reflection intensity from the second direction is larger than the reflection intensity from the first direction are present, and a θ angle and a reflection direction where the reflection intensity from the first direction is larger than the reflection intensity from the second direction are present,
(2) in a case where the X-ray refraction intensity is measured (Laue method) by 2-dimensional diffraction pattern images obtained by incidence of X-rays in the direction perpendicular to the longitudinal direction of CNT, a diffraction peak pattern showing the presence of the anisotropy appears, or
(3) in a case where the Herman's orientation factor is greater than 0 and smaller than 1.

5. An aligned single-walled CNT aggregate in claim 1, in which in a case where X-rays are incident from a first direction parallel to the longitudinal direction of CNT and a second direction perpendicular to the first direction to measure the X-ray diffraction intensity, the diffraction intensities for the (CP) and (002) diffraction peaks attributable to the packing between single-walled CNTs and the diffraction intensities for the (100) and (110) diffraction peaks attributable to the hexagonal carbon ring structure of the single-walled CNT are different from each other for the first parallel and the second perpendicular incident directions.

6. A powdered aligned single-walled CNT aggregate having a specific surface area from 600 m²/g to 2600 m²/g, and a weight density from 0.0005 g/cm³ to 0.16 g/cm³, in which the alignment degree is defined by a value of Herman's orientation factor that is greater than 0 and smaller than 1 when calculated based on the intensity profile from fast fourier transformation of scanning electron microscopic images or atomic force microscopic images.

7. A method for producing an aligned single-walled carbon nanotube aggregate of growing an aligned single-walled carbon nanotube aggregate on a base material having catalyst particle on the surface of the base material, the method including;
a formation step of bringing a reducing gas into contact with the fine catalyst particles and heating at least one of the catalyst particles and the reducing gas, and
a growth step of bringing a source gas containing carbon and not containing oxygen and a catalyst activating material containing oxygen into contact with the catalyst particles, and heating at least one of the catalyst particles, the source gas, or the catalyst activating material, thereby growing the aligned single-walled carbon nanotube aggregate.

8. An aligned single-walled CNT aggregate in claim 4, in which in a case where X-rays are incident from a first direction parallel to the longitudinal direction of CNT and a second direction perpendicular to the first direction to measure the X-ray diffraction intensity, the diffraction intensities for the (CP) and (002) diffraction peaks attributable to the packing between single-walled CNTs and the diffraction intensities for the (100) and (110) diffraction peaks attributable to the hexagonal carbon ring structure of the single-walled CNT are different from each other for the first parallel and the second perpendicular incident directions.
